(19) United States
(12) Patent Application Publication
(10) Pub. No.: US 2024/0411439 A1
(43) Pub. Date: Dec. 12, 2024

(54) USER INTERFACES FOR MANAGING MEDIA STYLES

(71) Applicant: Apple Inc., Cupertino, CA (US)

(72) Inventors: Johnnie B. MANZARI, San Francisco, CA (US); Graham R. CLARKE, Scotts Valley, CA (US); William A. SORRENTINO, III, Mill Valley, CA (US); Andre SOUZA DOS SANTOS, San Jose, CA (US)

(21) Appl. No.: 18/813,864

(22) Filed: Aug. 23, 2024

Related U.S. Application Data
(63) Continuation of application No. 17/721,039, filed on Apr. 14, 2022, now Pat. No. 12,112,024.
(60) Provisional application No. 63/243,633, filed on Sep. 13, 2021.
(60) Provisional application No. 63/195,679, filed on Jun. 1, 2021.

(51) Int. Cl. G06F 3/04845; G06F 3/0482

(52) U.S. Cl. CPC G06F 3/04845; G06F 3/0482

(57) ABSTRACT

The present disclosure generally relates to user interfaces for media-processing styles. In some embodiments, the present disclosure relates to user interfaces for editing media-processing styles.

### CROSS-REFERENCE TO RELATED APPLICATIONS

This application is a continuation of U.S. patent application Ser. No. 17/721,039, entitled “USER INTERFACES FOR MANAGING MEDIA STYLES,” filed on Apr. 14, 2022, which claims priority to U.S. Provisional Patent Application Ser. No. 63/243,633, entitled “USER INTERFACES FOR MANAGING MEDIA STYLES,” filed on Sep. 13, 2021, and U.S. Provisional Patent Application Ser. No. 63/195,679, entitled “USER INTERFACES FOR MANAGING MEDIA STYLES,” filed on Jun. 1, 2021. The contents of which are hereby incorporated by reference in their entireties.

### FIELD

The present disclosure relates generally to computer user interfaces and, more specifically, to techniques for managing media styles that are applied to the visual content of media.

### BACKGROUND

Users of smartphones and other personal electronic devices are more frequently capturing, storing, and editing media for safekeeping memories and sharing with friends. Some existing techniques allowed users to capture images or videos. Users can manage such media by, for example, capturing, storing, and editing the media.

### BRIEF SUMMARY

Some techniques for managing media styles that are applied to the visual content of media using electronic devices (e.g., including, computer systems), however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing media styles that are applied to the visual content of media. Such methods and interfaces optionally complement or replace other methods for managing media styles that are applied to the visual content of media. Such methods and interfaces reduce the cognitive burden on a user and produce a more efficient human-machine interface. For battery-operated computing devices, such methods and interfaces conserve power and increase the time between battery charges and reduced number of unnecessary, extraneous, and/or repetitive received inputs.

In accordance with some embodiments, a method performed at a computer system that is in communication with a display generation component and one or more input devices is described. The method comprises: displaying, via the display generation component, a style-selection user interface that includes a representation of media, wherein a first portion of the representation and a second portion of the representation are displayed using a first media-processing style that is applied to visual content of the media; while the first portion of the representation and the second portion of the representation are displayed using the first media-processing style, detecting, via the one or more input devices, an input directed to the representation; and in response to detecting the input directed to the representation and in accordance with a determination that the input is in a first direction, displaying, via the display generation component, the first portion of the representation using a second media-processing style while continuing to display the second portion of the representation using the first media-processing style, including: in response to detecting a first portion of the input directed to the representation, wherein the first portion of the input has a first input magnitude, displaying the first portion of the representation using the second media-processing style while the second portion of the representation and a third portion of the representation that is between the first portion of the representation and the second portion of the representation are displayed using the first media-processing style; and after displaying the first portion of the representation using the second media-processing style while the second portion of the representation and the third portion of the representation are displayed using the first media-processing style and in response to detecting a second portion of the input directed to the representation, wherein the second portion of the input has a second input magnitude that is greater than the first input magnitude, displaying the first portion of the representation and the third portion of the representation using the second media-processing style while the second portion of the representation is displayed using the first media-processing style.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a style-selection user interface that includes a representation of media, wherein a first portion of the representation and a second portion of the representation are displayed using a first media-processing style that is applied to visual content of the media; while the first portion of the representation and the second portion of the representation are displayed using the first media-processing style, detecting, via the one or more input devices, an input directed to the representation; and in response to detecting the input directed to the representation and in accordance with a determination that the input is in a first direction, displaying, via the display generation component, the first portion of the representation using a second media-processing style while continuing to display the second portion of the representation using the first media-processing style, including: in response to detecting a first portion of the input directed to the representation, wherein the first portion of the input has a first input magnitude, displaying the first portion of the representation using the second media-processing style while the second portion of the representation and a third portion of the representation that is between the first portion of the representation and the second portion of the representation are displayed using the first media-processing style; and after displaying the first portion of the representation using the second media-processing style while the second portion of the representation and the third portion of the representation are displayed using the first media-processing style and in response to detecting a second portion of the input directed to the representation, wherein the second portion of the input has a second input magnitude that is greater than the first input magnitude, displaying the first portion of the representation and the third portion of the representation using the second media-processing style while the second portion of the representation is displayed using the first media-processing style.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: displaying, via the display generation component, a style-selection user interface that includes a representation of media, wherein a first portion of the representation and a second portion of the representation are displayed using a first media-processing style that is applied to visual content of the media; while the first portion of the representation and the second portion of the representation are displayed using the first media-processing style, detecting, via the one or more input devices, an input directed to the representation; and in response to detecting the input directed to the representation and in accordance with a determination that the input is in a first direction, displaying, via the display generation component, the first portion of the representation using a second media-processing style while continuing to display the second portion of the representation using the first media-processing style, including: in response to detecting a first portion of the input directed to the representation, wherein the first portion of the input has a first input magnitude, displaying the first portion of the representation using the second media-processing style while the second portion of the representation and a third portion of the representation that is between the first portion of the representation and the second portion of the representation are displayed using the first media-processing style; and after displaying the first portion of the representation using the second media-processing style while the second portion of the representation and the third portion of the representation are displayed using the first media-processing style and in response to detecting a second portion of the input directed to the representation, wherein the second portion of the input has a second input magnitude that is greater than the first input magnitude, displaying the first portion of the representation and the third portion of the representation using the second media-processing style while the second portion of the representation is displayed using the first media-processing style.

In accordance with some embodiments, a computer system that is configured to communicate with a display generation component one or more input devices is described. The computer system comprises: one or more processors; and memory storing one or more programs configured to be executed by the one or more processors, the one or more programs including instructions for: displaying, via the display generation component, a style-selection user interface that includes a representation of media, wherein a first portion of the representation and a second portion of the representation are displayed using a first media-processing style that is applied to visual content of the media; while the first portion of the representation and the second portion of the representation are displayed using the first media-processing style, detecting, via the one or more input devices, an input directed to the representation; and in response to detecting the input directed to the representation and in accordance with a determination that the input is in a first direction, displaying, via the display generation component, the first portion of the representation using a second media-processing style while continuing to display the second portion of the representation using the first media-processing style, including: in response to detecting a first portion of the input directed to the representation, wherein the first portion of the input has a first input magnitude, displaying the first portion of the representation using the second media-processing style while the second portion of the representation and a third portion of the representation that is between the first portion of the representation and the second portion of the representation are displayed using the first media-processing style; and after displaying the first portion of the representation using the second media-processing style while the second portion of the representation and the third portion of the representation are displayed using the first media-processing style and in response to detecting a second portion of the input directed to the representation, wherein the second portion of the input has a second input magnitude that is greater than the first input magnitude, displaying the first portion of the representation and the third portion of the representation using the second media-processing style while the second portion of the representation is displayed using the first media-processing style.

In accordance with some embodiments, a computer system that is configured to communicate with a display generation component and one or more input devices is described. The computer system comprises: means for displaying, via the display generation component, a style-selection user interface that includes a representation of media, wherein a first portion of the representation and a second portion of the representation are displayed using a first media-processing style that is applied to visual content of the media; means, while the first portion of the representation and the second portion of the representation are displayed using the first media-processing style, for detecting, via the one or more input devices, an input directed to the representation; and means, responsive to detecting the input directed to the representation and in accordance with a determination that the input is in a first direction, for displaying, via the display generation component, the first portion of the representation using a second media-processing style while continuing to display the second portion of the representation using the first media-processing style, including: means, responsive to detecting a first portion of the input directed to the representation, wherein the first portion of the input has a first input magnitude, for displaying the first portion of the representation using the second media-processing style while the second portion of the representation and a third portion of the representation that is between the first portion of the representation and the second portion of the representation are displayed using the first media-processing style; and means, after displaying the first portion of the representation using the second media-processing style while the second portion of the representation and the third portion of the representation are displayed using the first media-processing style and in response to detecting a second portion of the input directed to the representation, wherein the second portion of the input has a second input magnitude that is greater than the first input magnitude, for displaying the first portion of the representation and the third portion of the representation using the second media-processing style while the second portion of the representation is displayed using the first media-processing style.

In accordance with some embodiments, a computer program product is described. The computer program product comprises one or more programs configured to be executed by one or more processors of a computer system that is in communication with a display generation component and one or more input devices. The one or more programs include instructions for: displaying, via the display generation component, a style-selection user interface that includes a representation of media, wherein a first portion of the representation and a second portion of the representation are displayed using a first media-processing style that is applied to visual content of the media; while the first portion of the representation and the second portion of the representation are displayed using the first media-processing style, detecting, via the one or more input devices, an input directed to the representation; and in response to detecting the input directed to the representation and in accordance with a determination that the input is in a first direction, displaying, via the display generation component, the first portion of the representation using a second media-processing style while continuing to display the second portion of the representation using the first media-processing style, including: in response to detecting a first portion of the input directed to the representation, wherein the first portion of the input has a first input magnitude, displaying the first portion of the representation using the second media-processing style while the second portion of the representation and a third portion of the representation that is between the first portion of the representation and the second portion of the representation are displayed using the first media-processing style; and after displaying the first portion of the representation using the second media-processing style while the second portion of the representation and the third portion of the representation are displayed using the first media-processing style and in response to detecting a second portion of the input directed to the representation, wherein the second portion of the input has a second input magnitude that is greater than the first input magnitude, displaying the first portion of the representation and the third portion of the representation using the second media-processing style while the second portion of the representation is displayed using the first media-processing style.

In accordance with some embodiments, a method performed at a computer system that is in communication with a display generation component and one or more input devices is described. The method comprises: displaying, via the display generation component, a user interface that includes a representation of media, wherein the representation of the media is displayed using a first media-processing style that is applied to visual content of the media; while displaying the representation of the media using the first media-processing style, concurrently displaying, via the display generation component, a plurality of selectable user interface objects for the first media-processing style, including: a first selectable user interface object for editing a first parameter of the first media-processing style that is displayed with a representation of a current value for the first parameter of the first media-processing style; and a second electable user interface object for editing a second parameter of the first media-processing style that is displayed with a representation of a current value for the second parameter of the first media-processing style, wherein the first parameter is different from the second parameter; while displaying the plurality of selectable user interface objects for the first media-processing style, detecting, via the one or more input devices, an input directed to the plurality of selectable user interface objects for the first media-processing style; and in response to detecting the input directed to the plurality of selectable user interface objects for the first media-processing style: in accordance with a determination that the input is directed to the first selectable user interface object for editing the first parameter of the first media-processing style, displaying, via the display generation component, a first control for adjusting the current value for the first parameter; and in accordance with a determination that the input is directed to the second user interface object for editing the second parameter of the first media-processing style, displaying, via the display generation component, a second control for adjusting the current value for the second parameter.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a user interface that includes a representation of media, wherein the representation of the media is displayed using a first media-processing style that is applied to visual content of the media; while displaying the representation of the media using the first media-processing style, concurrently displaying, via the display generation component, a plurality of selectable user interface objects for the first media-processing style, including: a first selectable user interface object for editing a first parameter of the first media-processing style that is displayed with a representation of a current value for the first parameter of the first media-processing style; and a second electable user interface object for editing a second parameter of the first media-processing style that is displayed with a representation of a current value for the second parameter of the first media-processing style, wherein the first parameter is different from the second parameter; while displaying the plurality of selectable user interface objects for the first media-processing style, detecting, via the one or more input devices, an input directed to the plurality of selectable user interface objects for the first media-processing style; and in response to detecting the input directed to the plurality of selectable user interface objects for the first media-processing style: in accordance with a determination that the input is directed to the first selectable user interface object for editing the first parameter of the first media-processing style, displaying, via the display generation component, a first control for adjusting the current value for the first parameter; and in accordance with a determination that the input is directed to the second user interface object for editing the second parameter of the first media-processing style, displaying, via the display generation component, a second control for adjusting the current value for the second parameter.

In accordance with some embodiments, a transitory computer-readable storage medium is described. The transitory computer-readable storage medium stores one or more programs configured to be executed by one or more processors of a computer system that is in communication with a display generation component and one or more input devices, the one or more programs including instructions for: displaying, via the display generation component, a user interface that includes a representation of media, wherein the representation of the media is displayed using a first media-processing style that is applied to visual content of the media; while displaying the representation of the media using the first media-processing style, concurrently displaying, via the display generation component, a plurality of selectable user interface objects for the first media-processing style, including: a first selectable user interface object for editing a first parameter of the first media-processing style that is displayed with a representation of a current value for the first parameter of the first media-processing style; and a second electable user interface object for editing a second parameter of the first media-processing style that is displayed with a representation of a current value for the second parameter of the first media-processing style, wherein the first parameter is different from the second parameter; while displaying the plurality of selectable user interface objects for the first media-processing style, detecting, via the one or more input devices, an input directed to the plurality of selectable user interface objects for the first media-processing style; and in response to detecting the input directed to the plurality of selectable user interface objects for the first media-processing style: in accordance with a determination that the input is directed to the first selectable user interface object for editing the first parameter of the first media-processing style, displaying, via the display generation component, a first control for adjusting the current value for the first parameter; and in accordance with a determination that the input is directed to the second user interface object for editing the second parameter of the first media-processing style, displaying, via the display generation component, a second control for adjusting the current value for the second parameter.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: displaying, via the display generation component, a user interface that includes a representation of media, wherein the representation of the media is displayed using a first media-processing style that is applied to visual content of the media; while displaying the representation of the media using the first media-processing style, concurrently displaying, via the display generation component, a plurality of selectable user interface objects for the first media-processing style, including: a first selectable user interface object for editing a first parameter of the first media-processing style that is displayed with a representation of a current value for the first parameter of the first media-processing style; and a second electable user interface object for editing a second parameter of the first media-processing style that is displayed with a representation of a current value for the second parameter of the first media-processing style, wherein the first parameter is different from the second parameter; while displaying the plurality of selectable user interface objects for the first media-processing style, detecting, via the one or more input devices, an input directed to the plurality of selectable user interface objects for the first media-processing style; and in response to detecting the input directed to the plurality of selectable user interface objects for the first media-processing style: in accordance with a determination that the input is directed to the first selectable user interface object for editing the first parameter of the first media-processing style, displaying, via the display generation component, a first control for adjusting the current value for the first parameter; and in accordance with a determination that the input is directed to the second user interface object for editing the second parameter of the first media-processing style, displaying, via the display generation component, a second control for adjusting the current value for the second parameter.

In accordance with some embodiments, a computer system that is configured to communicate with a display generation component and one or more input devices is described. The computer system comprises: means for displaying, via the display generation component, a user interface that includes a representation of media, wherein the representation of the media is displayed using a first media-processing style that is applied to visual content of the media; means, while displaying the representation of the media using the first media-processing style, for concurrently displaying, via the display generation component, a plurality of selectable user interface objects for the first media-processing style, including: a first selectable user interface object for editing a first parameter of the first media-processing style that is displayed with a representation of a current value for the first parameter of the first media-processing style; and a second electable user interface object for editing a second parameter of the first media-processing style that is displayed with a representation of a current value for the second parameter of the first media-processing style, wherein the first parameter is different from the second parameter; means, while displaying the plurality of selectable user interface objects for the first media-processing style, for detecting, via the one or more input devices, an input directed to the plurality of selectable user interface objects for the first media-processing style; and means, responsive to detecting the input directed to the plurality of selectable user interface objects for the first media-processing style, for: in accordance with a determination that the input is directed to the first selectable user interface object for editing the first parameter of the first media-processing style, displaying, via the display generation component, a first control for adjusting the current value for the first parameter; and in accordance with a determination that the input is directed to the second user interface object for editing the second parameter of the first media-processing style, displaying, via the display generation component, a second control for adjusting the current value for the second parameter.

In accordance with some embodiments, a computer program product is described. The computer program product comprises one or more programs configured to be executed by one or more processors of a computer system that is that is in communication with a display generation component and one or more input devices. The one or more programs include instructions for: displaying, via the display generation component, a user interface that includes a representation of media, wherein the representation of the media is displayed using a first media-processing style that is applied to visual content of the media; while displaying the representation of the media using the first media-processing style, concurrently displaying, via the display generation component, a plurality of selectable user interface objects for the first media-processing style, including: a first selectable user interface object for editing a first parameter of the first media-processing style that is displayed with a representation of a current value for the first parameter of the first media-processing style; and a second electable user interface object for editing a second parameter of the first media-processing style that is displayed with a representation of a current value for the second parameter of the first media-processing style, wherein the first parameter is different from the second parameter; while displaying the plurality of selectable user interface objects for the first media-processing style, detecting, via the one or more input devices, an input directed to the plurality of selectable user interface objects for the first media-processing style; and in response to detecting the input directed to the plurality of selectable user interface objects for the first media-processing style: in accordance with a determination that the input is directed to the first selectable user interface object for editing the first parameter of the first media-processing style, displaying, via the display generation component, a first control for adjusting the current value for the first parameter; and in accordance with a determination that the input is directed to the second user interface object for editing the second parameter of the first media-processing style, displaying, via the display generation component, a second control for adjusting the current value for the second parameter. Executable instructions for performing these functions are, optionally, included in a non-transitory computer-readable storage medium or other computer program product configured for execution by one or more processors.

Executable instructions for performing these functions are, optionally, included in a transitory computer-readable storage medium or other computer program product configured for execution by one or more processors.

Thus, devices are provided with faster, more efficient methods and interfaces for managing media styles that are applied to the visual content of media, thereby increasing the effectiveness, efficiency, and user satisfaction with such devices. Such methods and interfaces may complement or replace other methods for managing media styles that are applied to the visual content of media.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6Y illustrate exemplary user interfaces for selecting media-processing styles using a computer system in accordance with some embodiments.

FIGS. 7A-7X illustrate exemplary user interfaces for editing media-processing styles using a computer system in accordance with some embodiments.

FIGS. 8A-8C illustrate exemplary user interfaces for selecting media-processing styles using a computer system in accordance with some embodiments.

FIG. 9 is a flow diagram illustrating methods for selecting media-processing styles using a computer system in accordance with some embodiments.

FIGS. 10A-10B are a flow diagram illustrating methods for editing media-processing styles using a computer system in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing media styles that are applied to the visual content of media, such as the methods described herein to select media-processing styles and edit media-processing styles. Such techniques can reduce the cognitive burden on a user who desires to edit media, thereby enhancing productivity. Further, such techniques can reduce processor and battery power otherwise wasted on redundant user inputs.

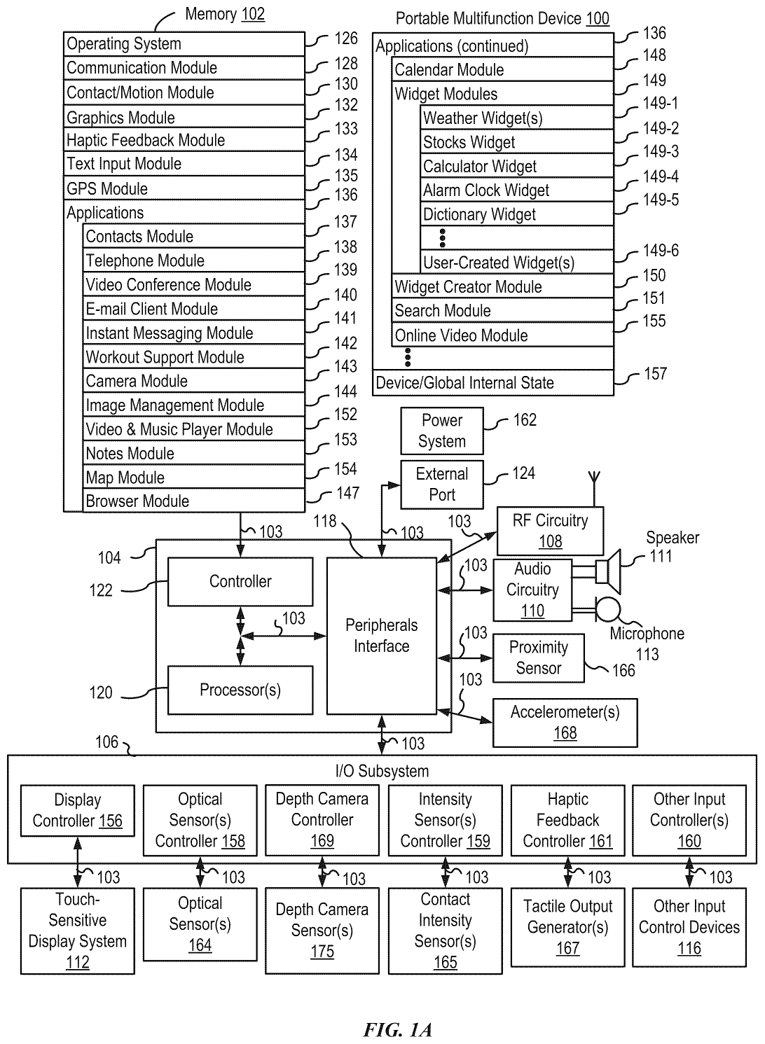

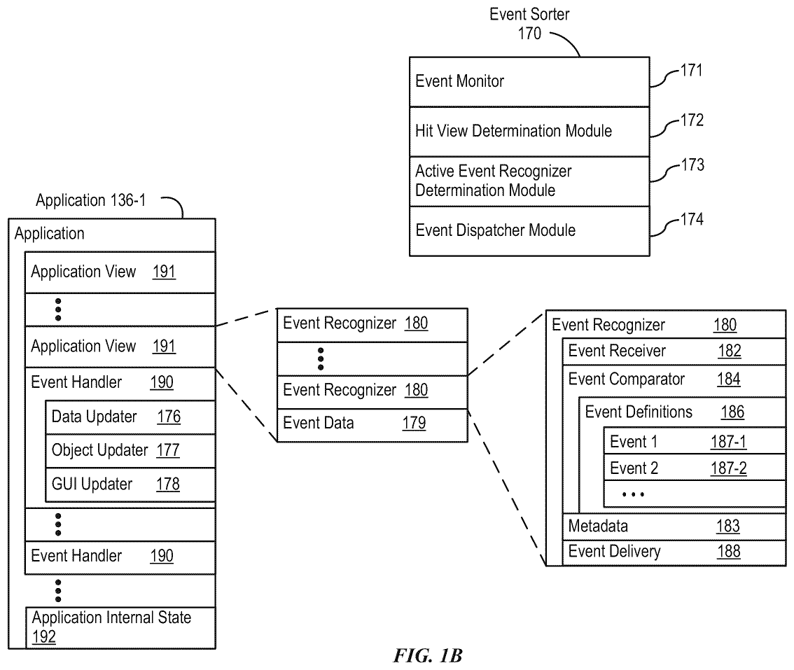

Below, FIGS. 1A-1B, 2, 3, 4A-4B, and 5A-5B provide a description of exemplary devices for performing the techniques for managing media-processing styles.

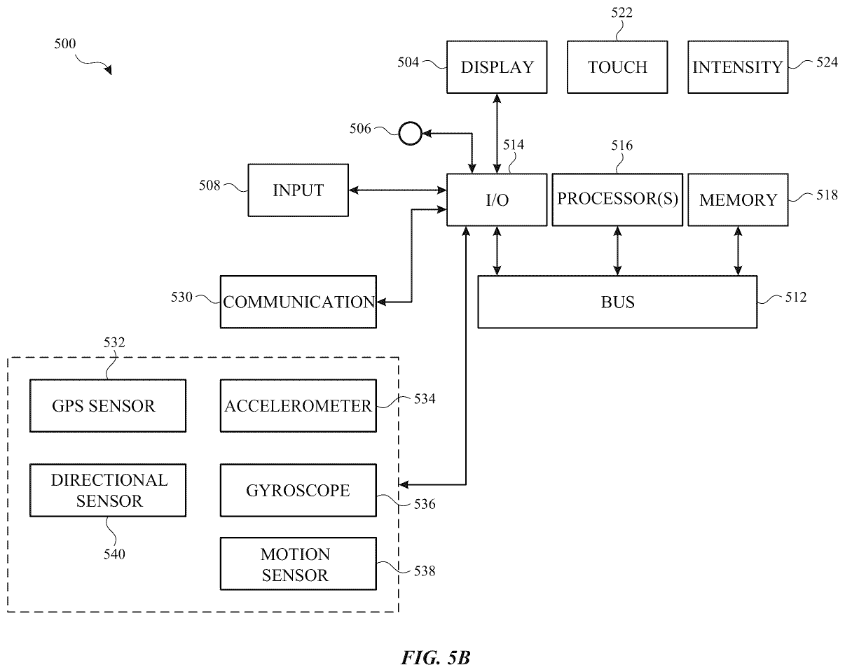

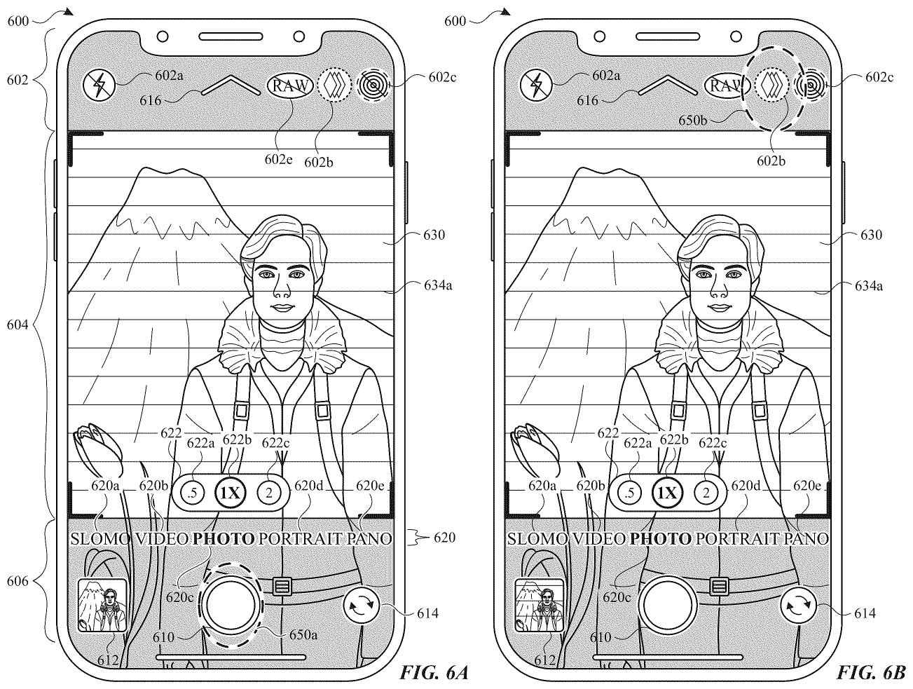

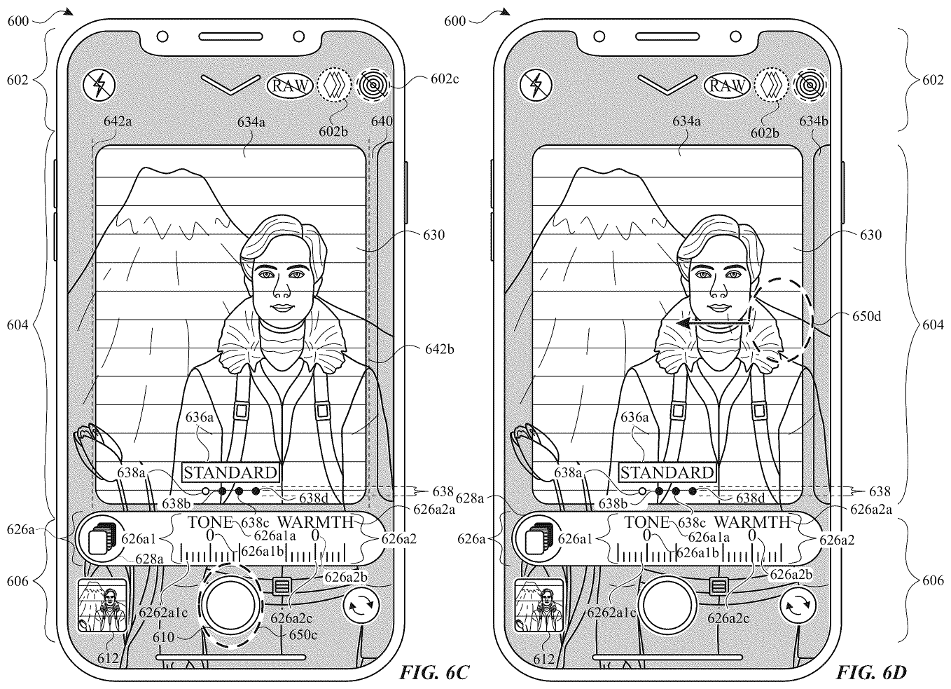

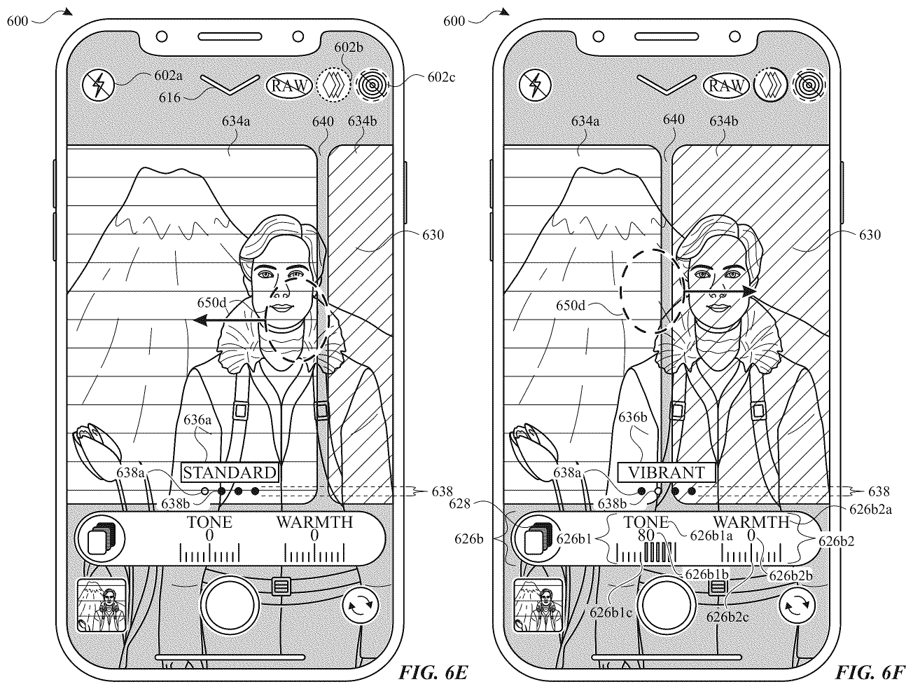

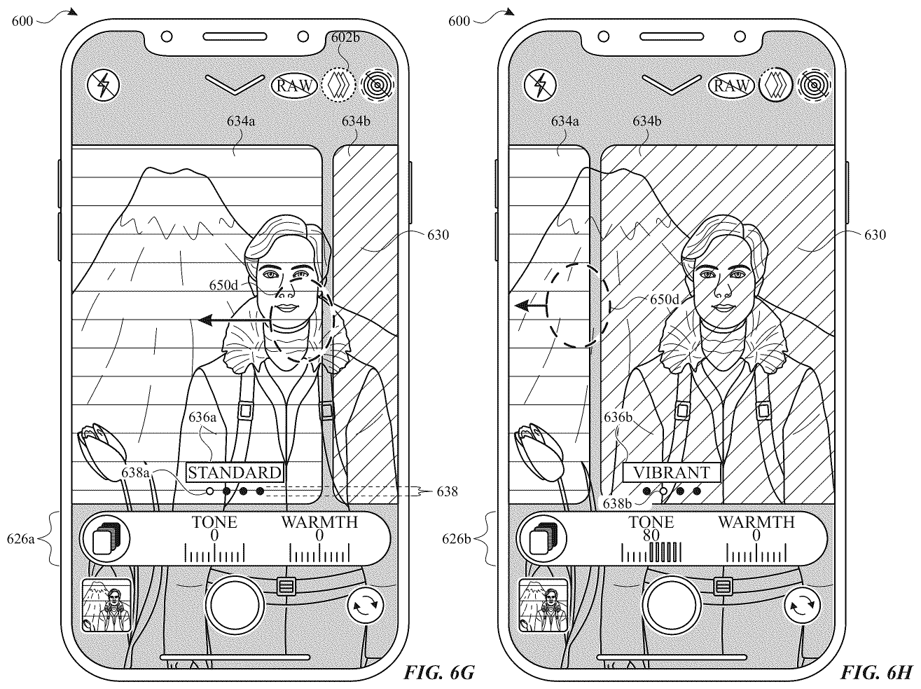

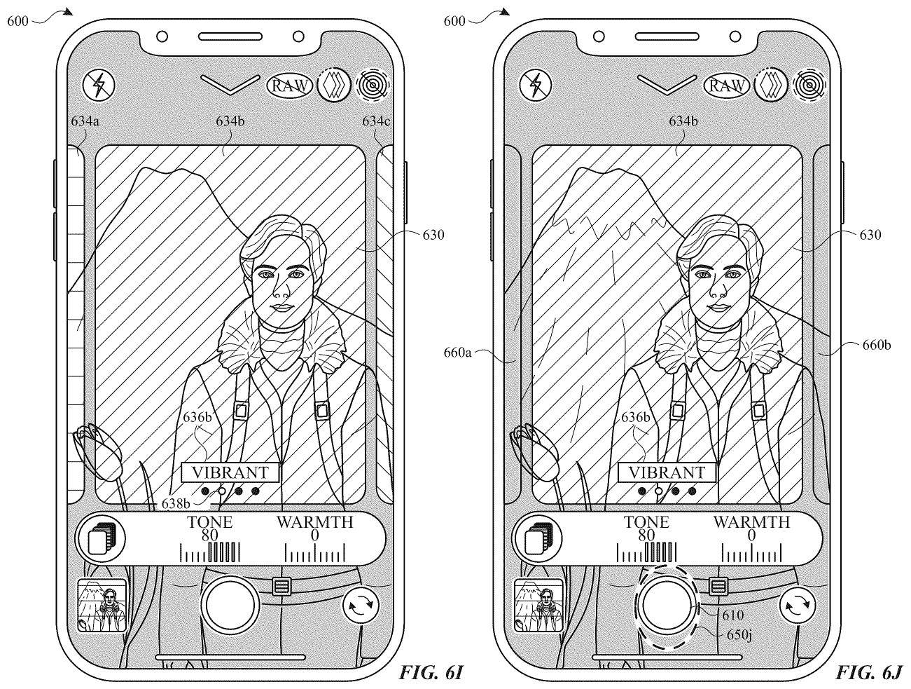

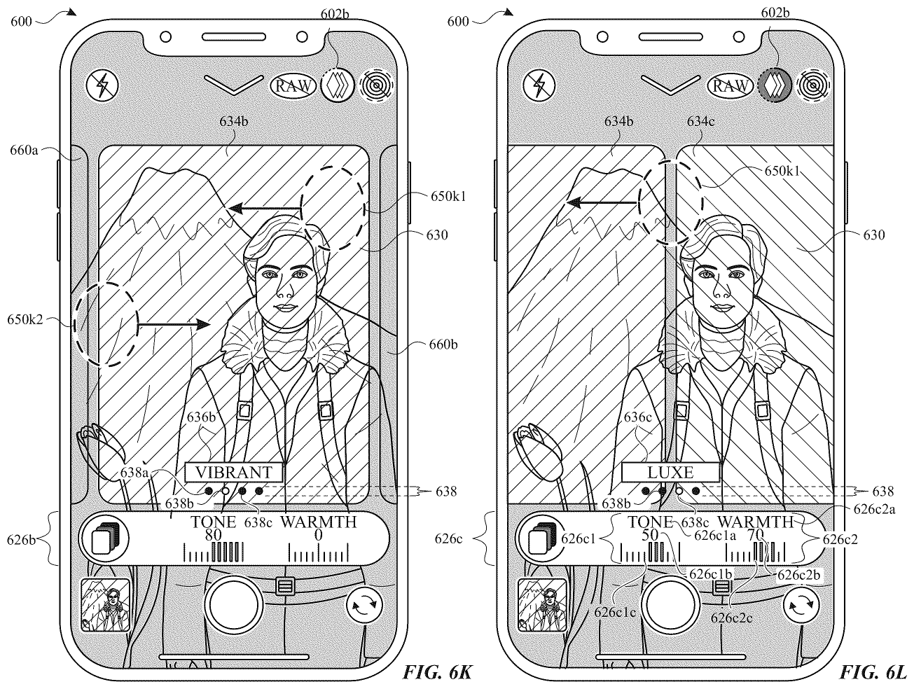

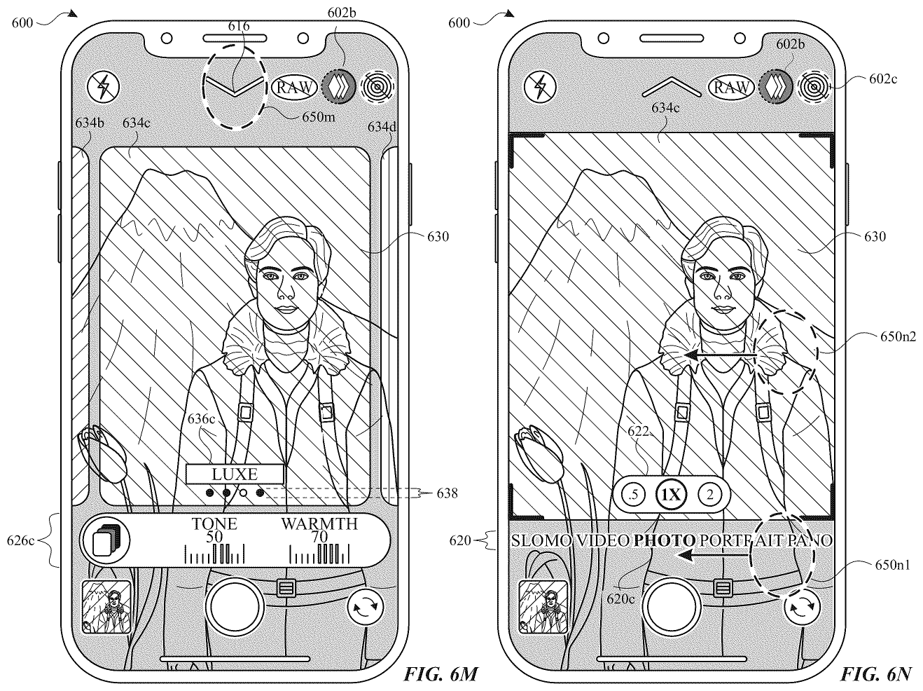

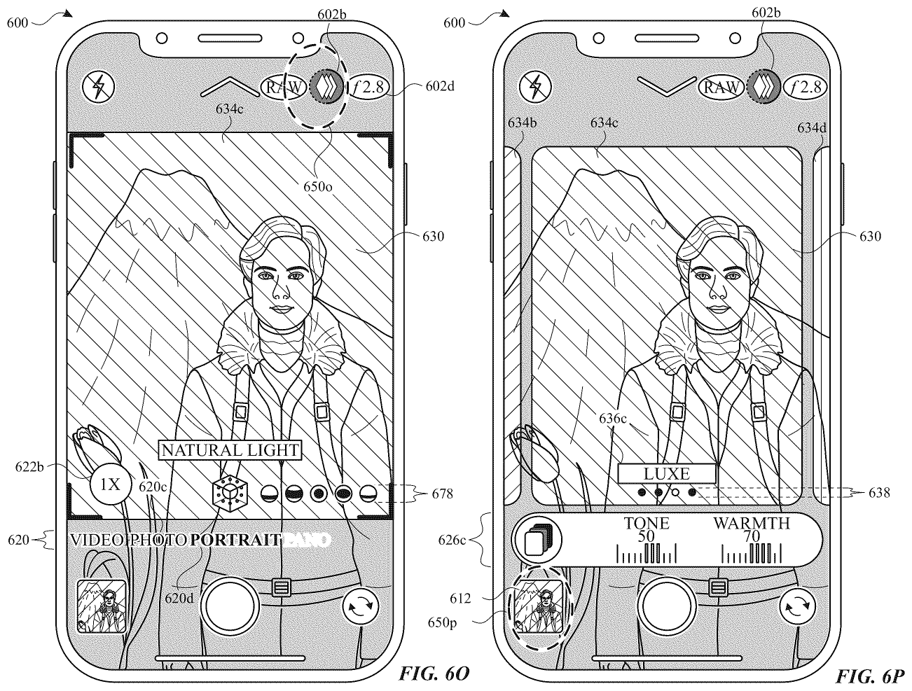

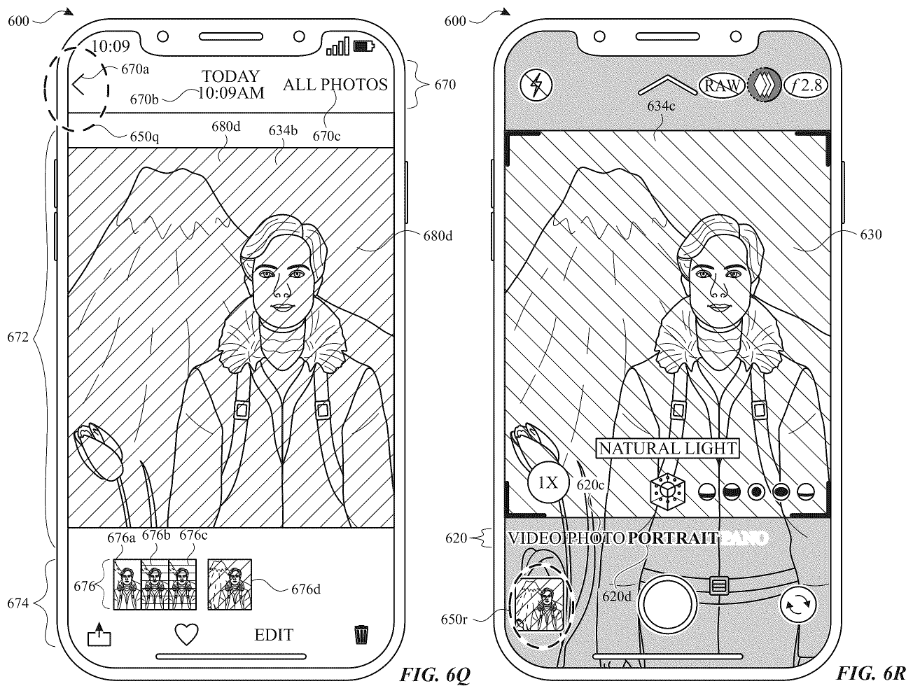

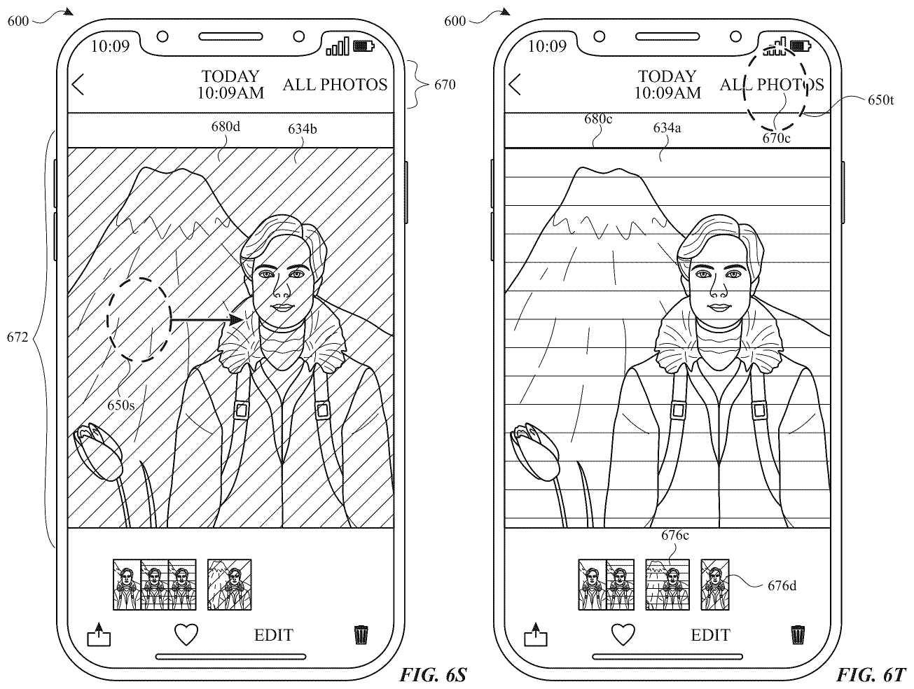

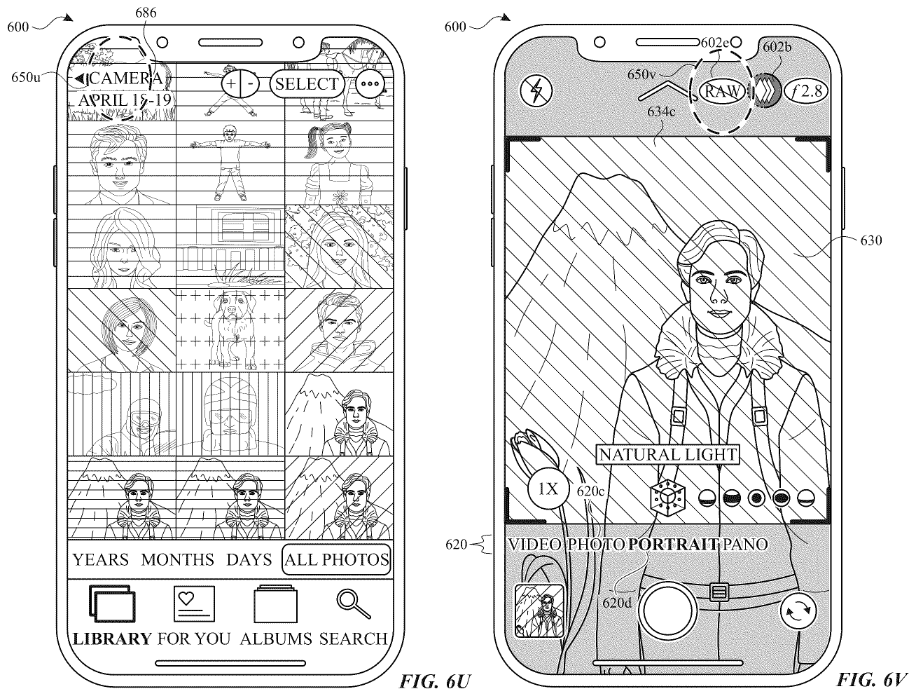

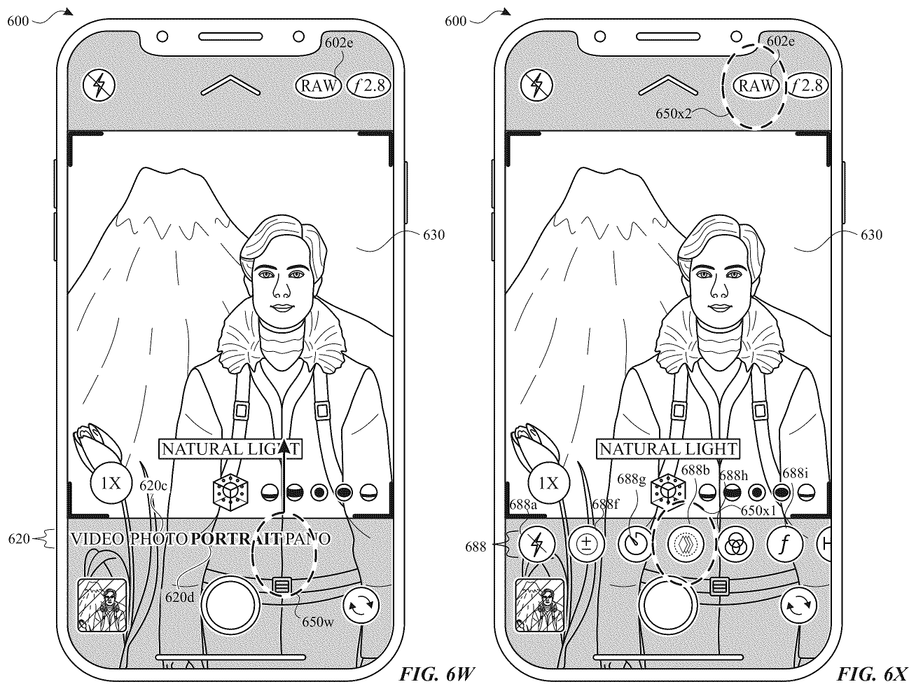

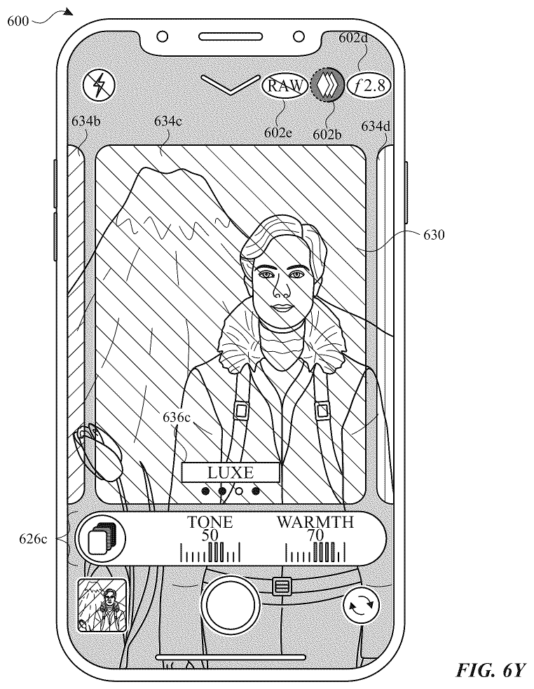

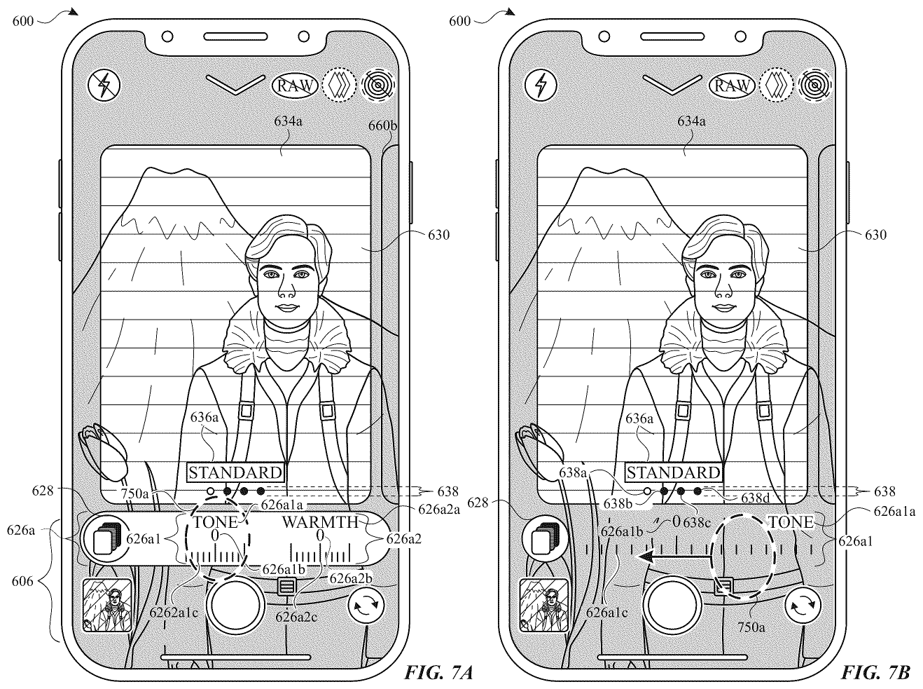

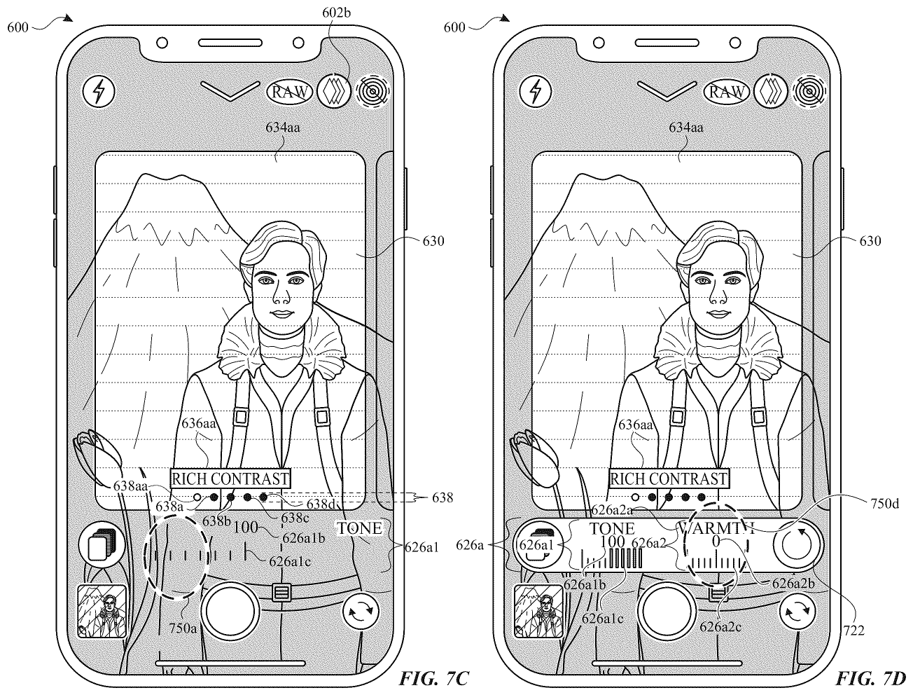

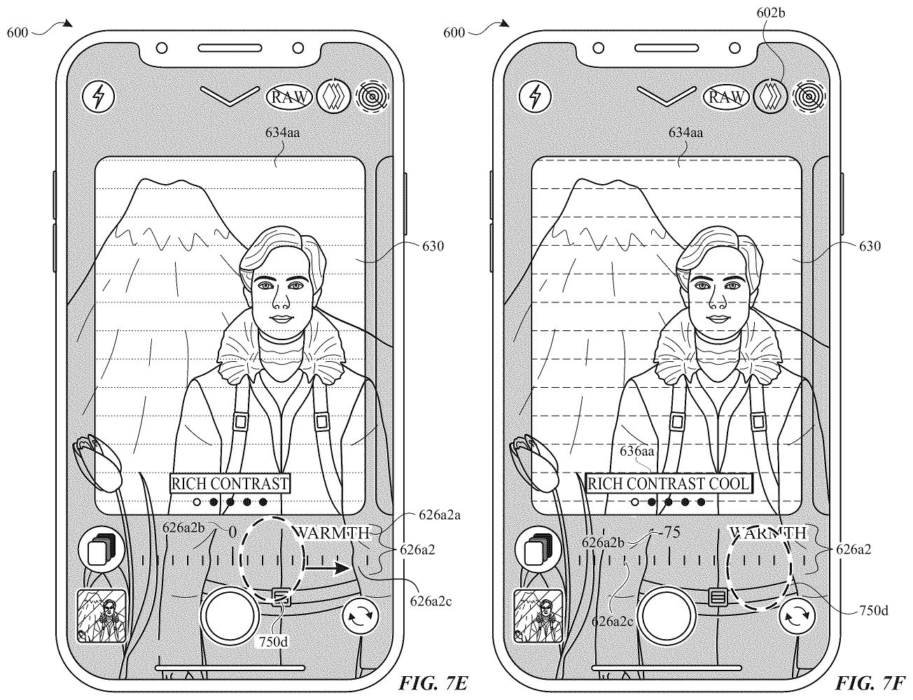

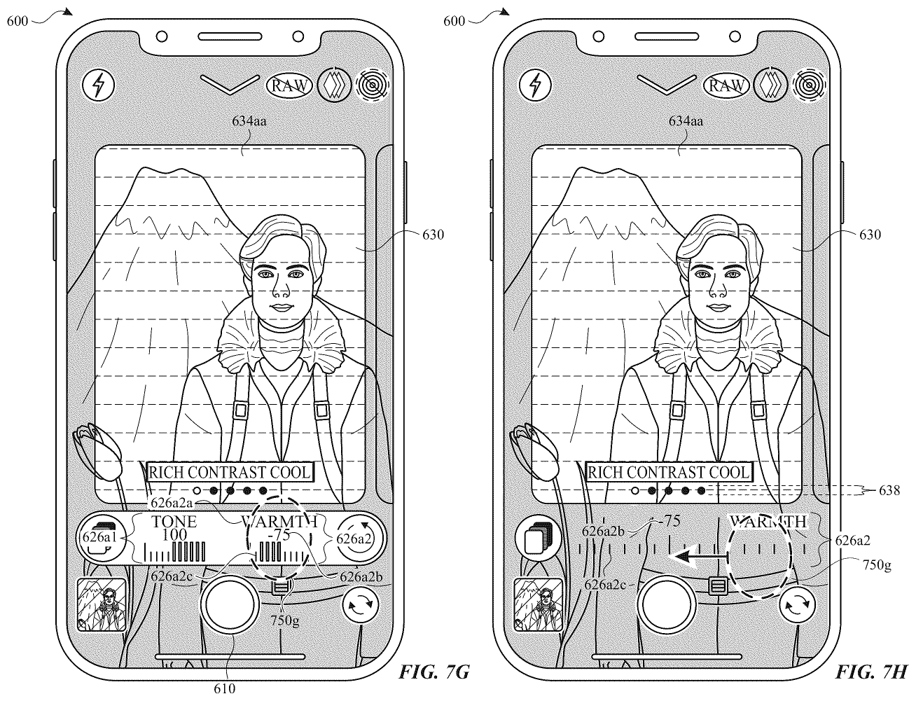

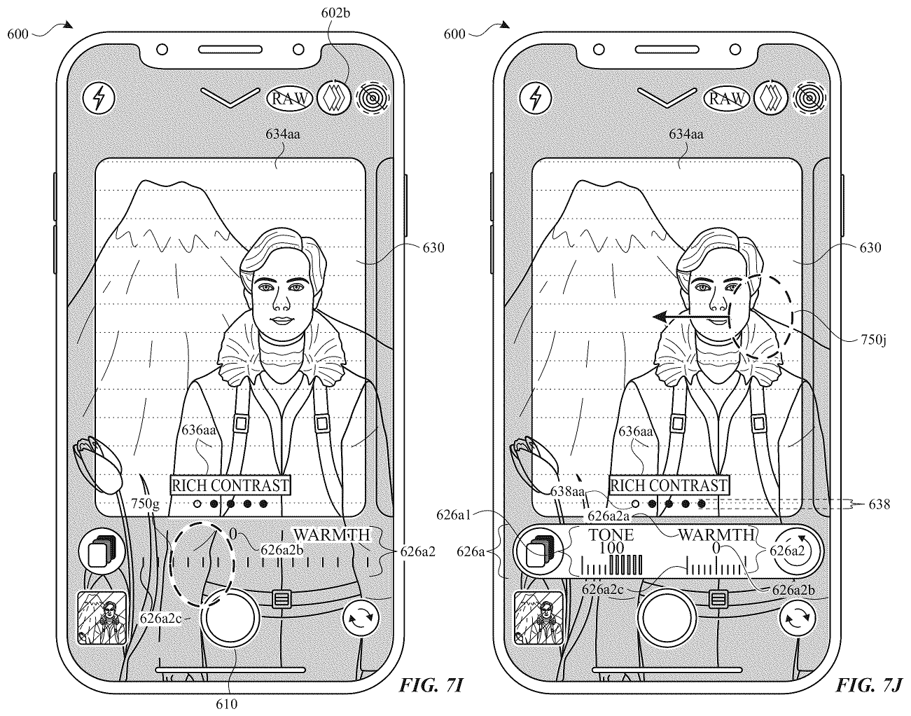

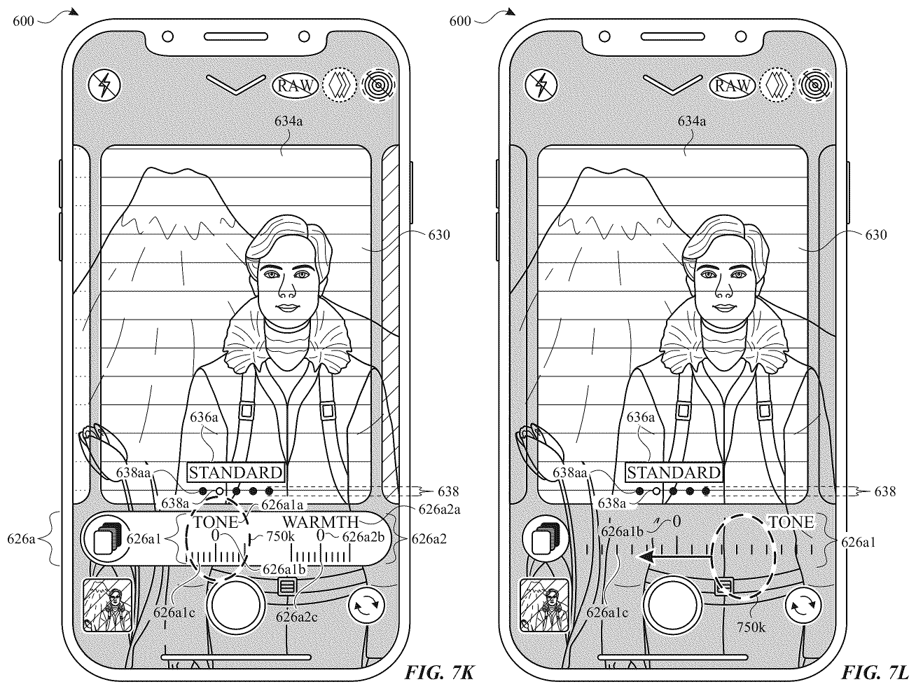

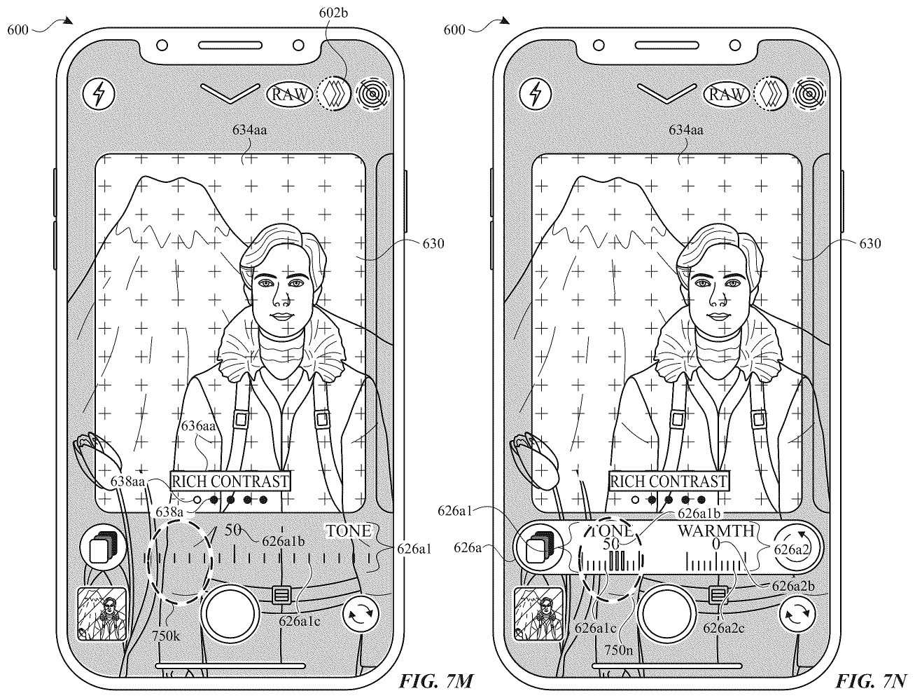

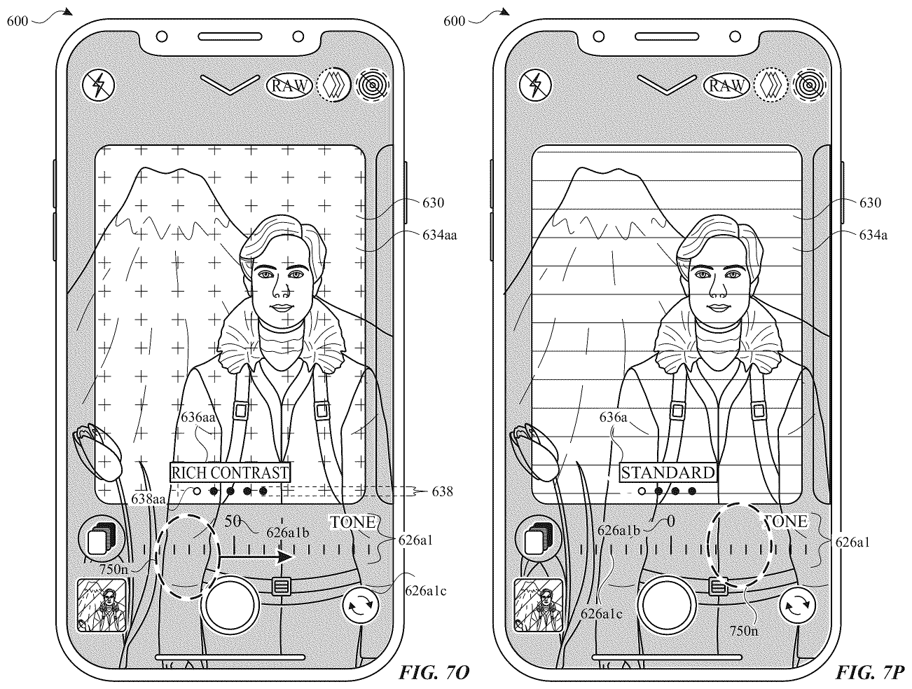

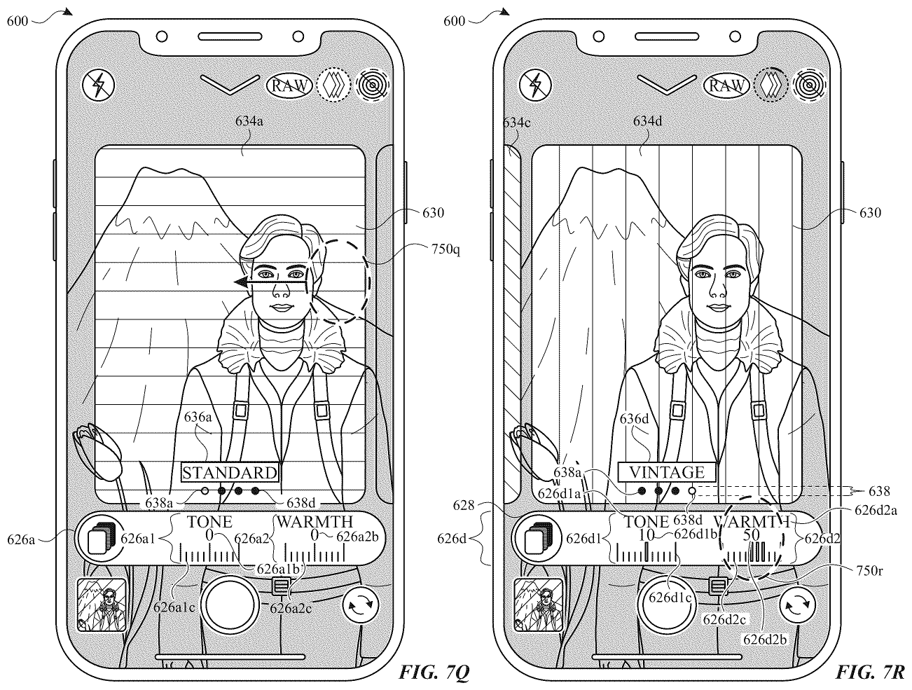

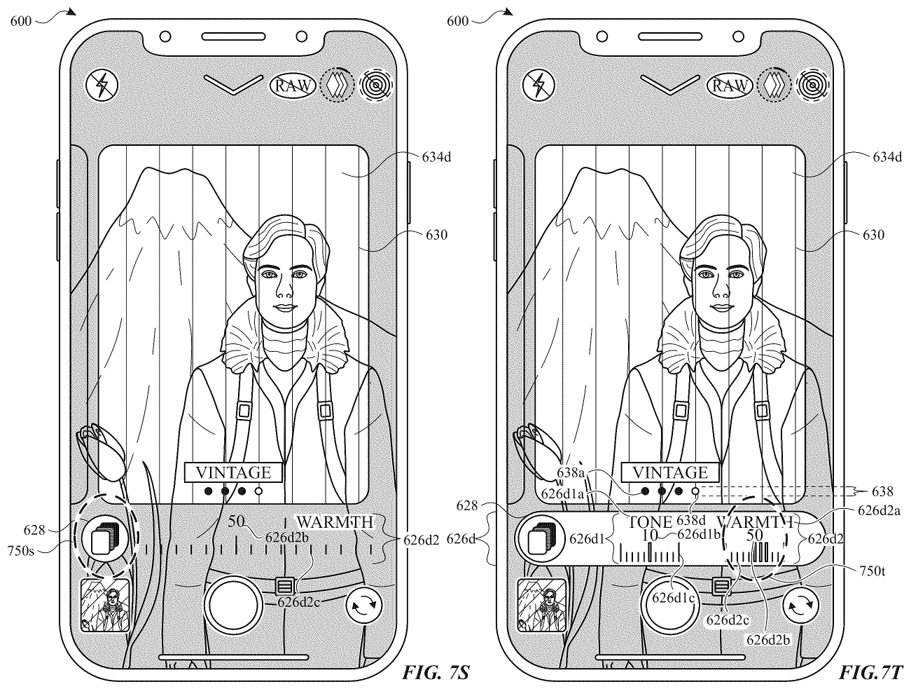

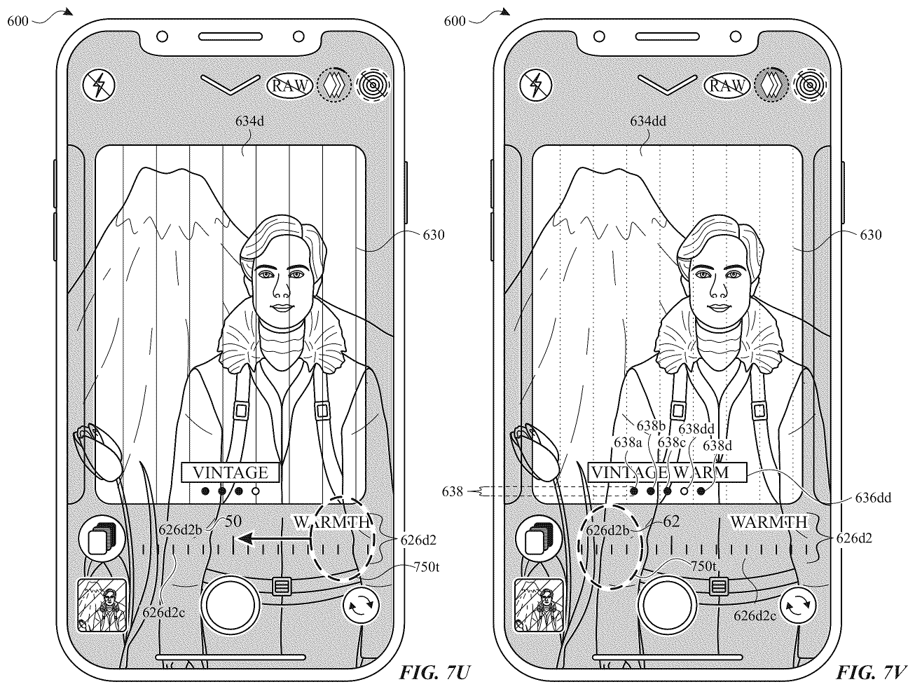

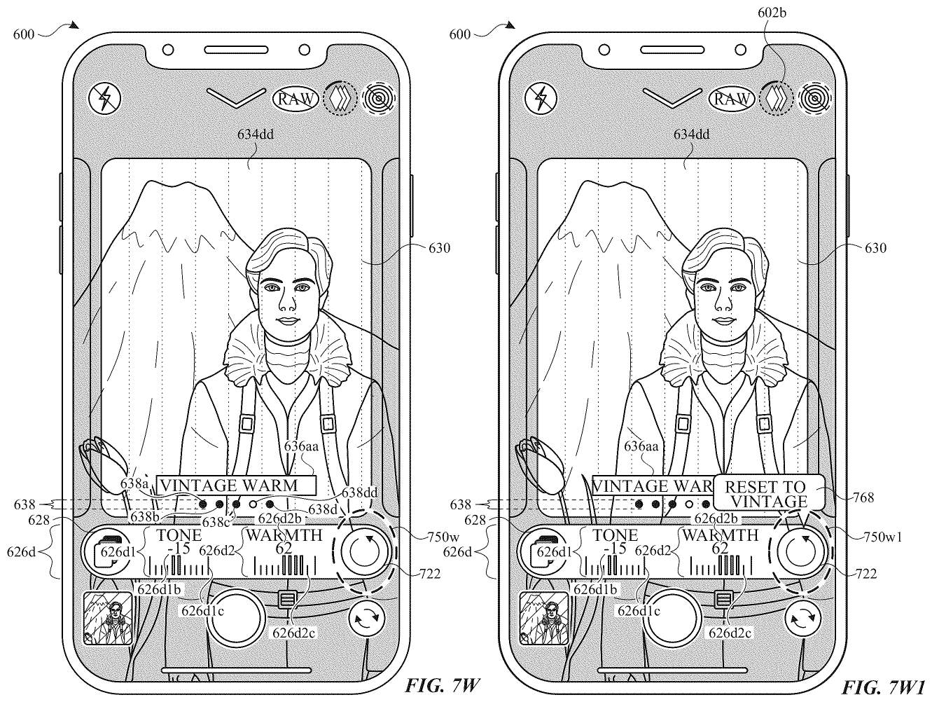

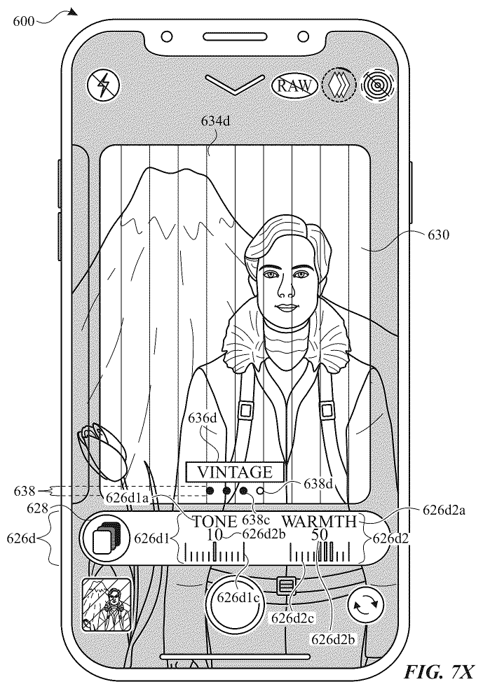

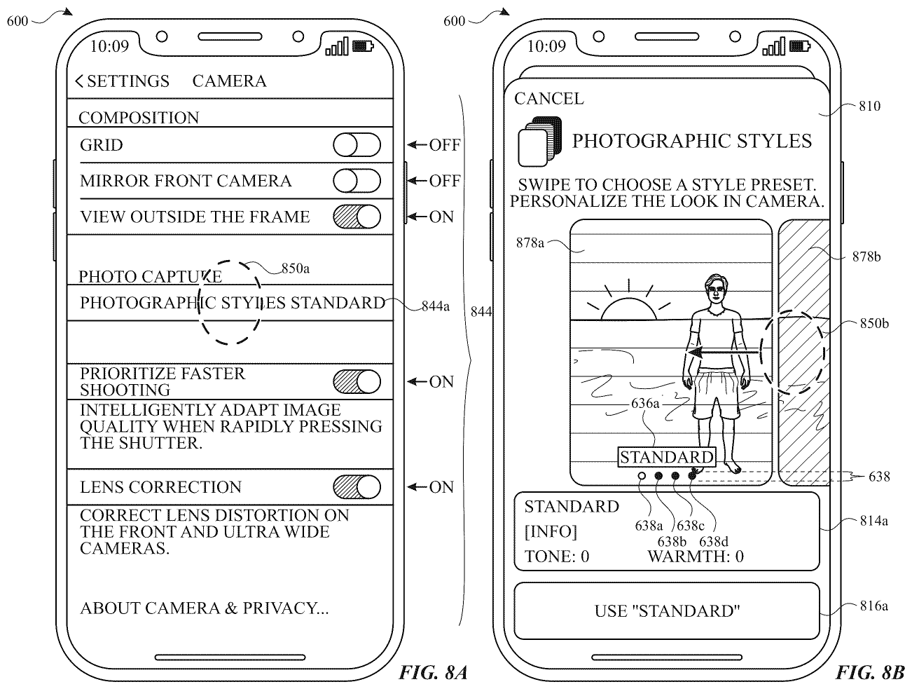

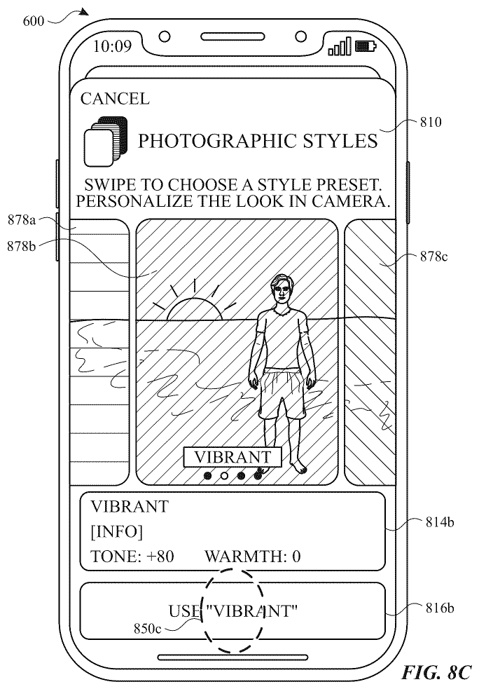

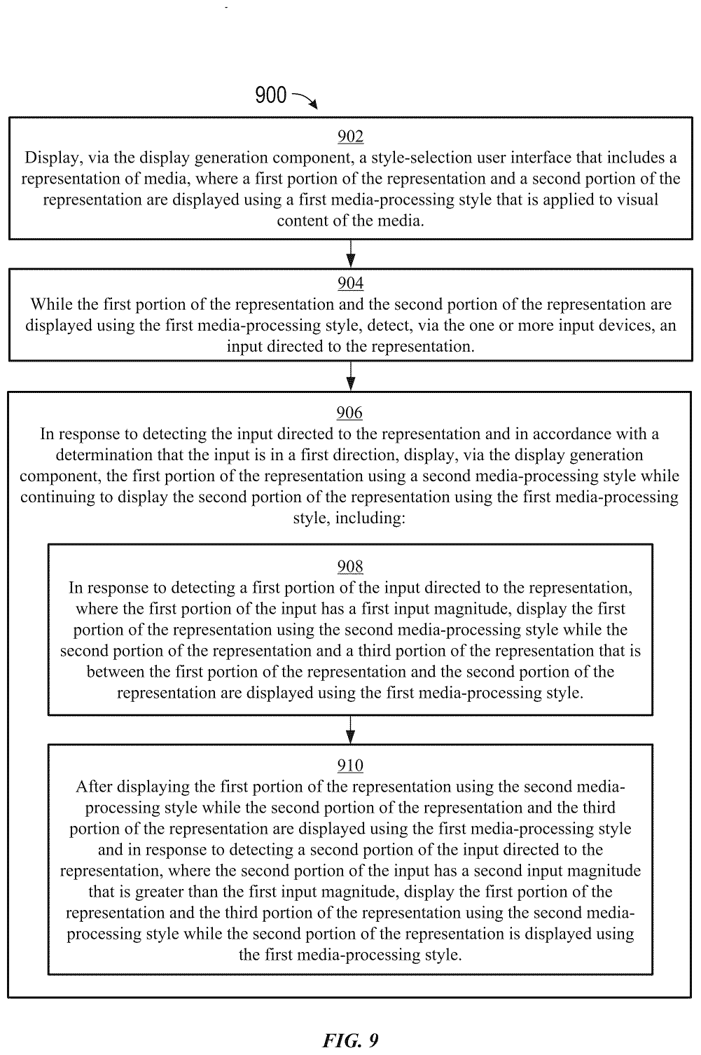

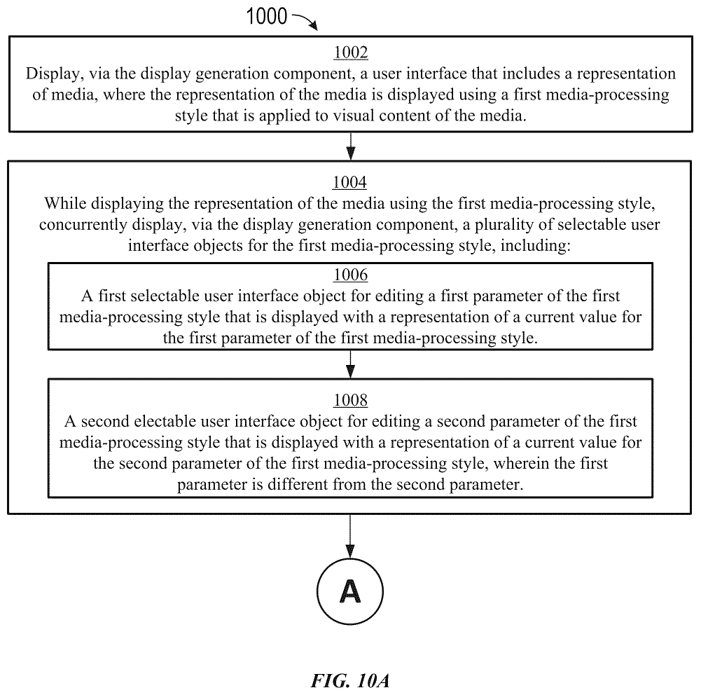

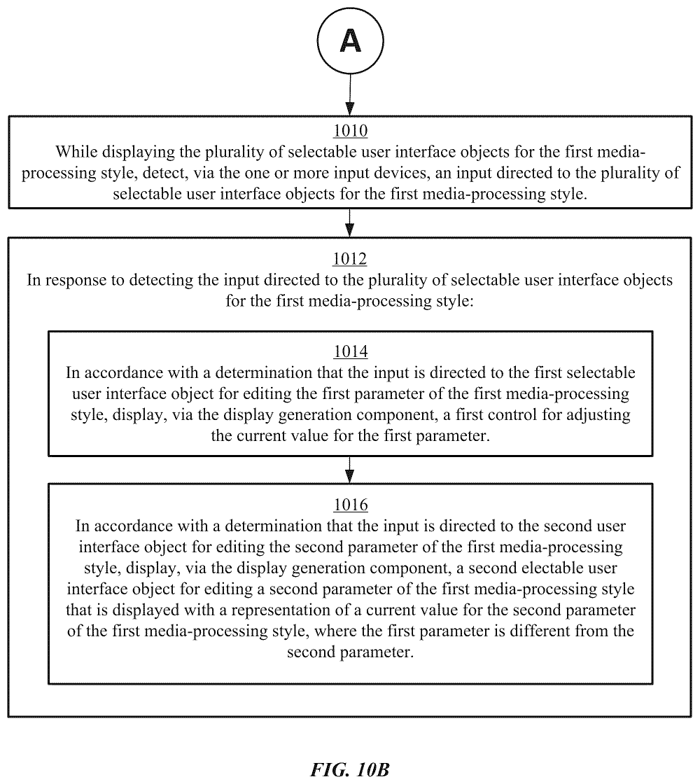

FIGS. 6A-6Y illustrate exemplary user interfaces for selecting media-processing styles using a computer system in accordance with some embodiments. FIGS. 7A-7X illustrate exemplary user interfaces for editing media-processing styles using a computer system in accordance with some embodiments. FIGS. 8A-8C illustrate exemplary user interfaces for selecting media-processing styles using a computer system in accordance with some embodiments. FIG. 9 is a flow diagram illustrating methods for selecting media-processing styles using a computer system in accordance with some embodiments. FIGS. 10A-10B are a flow diagram illustrating methods for editing media-processing styles using a computer system in accordance with some embodiments. The user interfaces in FIGS. 6A-6Y, 7A-7X, and 8A-8C are used to illustrate the processes described below, including the processes in FIGS. 9 and 10A-10B.

The processes described below enhance the operability of the devices and make the user-device interfaces more efficient (e.g., by helping the user to provide proper inputs and reducing user mistakes when operating/interacting with the devices) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional technical techniques. These techniques also reduce power usage and improve battery life of the devices by enabling the user to use the devices more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

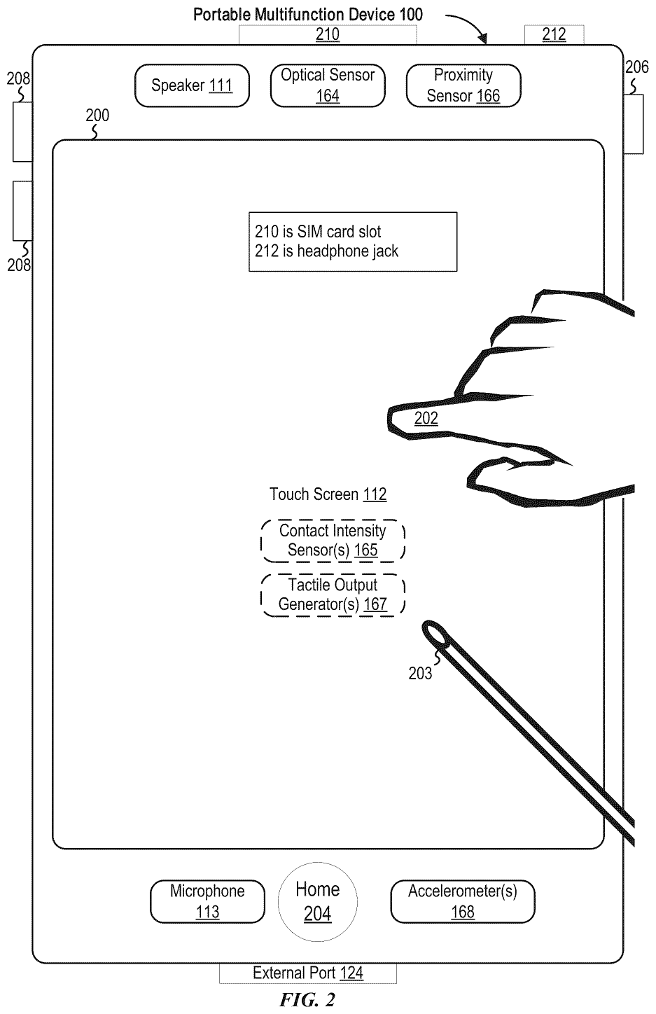

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures) as input. In some embodiments, the one or more input devices are integrated with the computer system. In some embodiments, the one or more input devices are separate from the computer system.

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. Nos. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. Patent Application No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

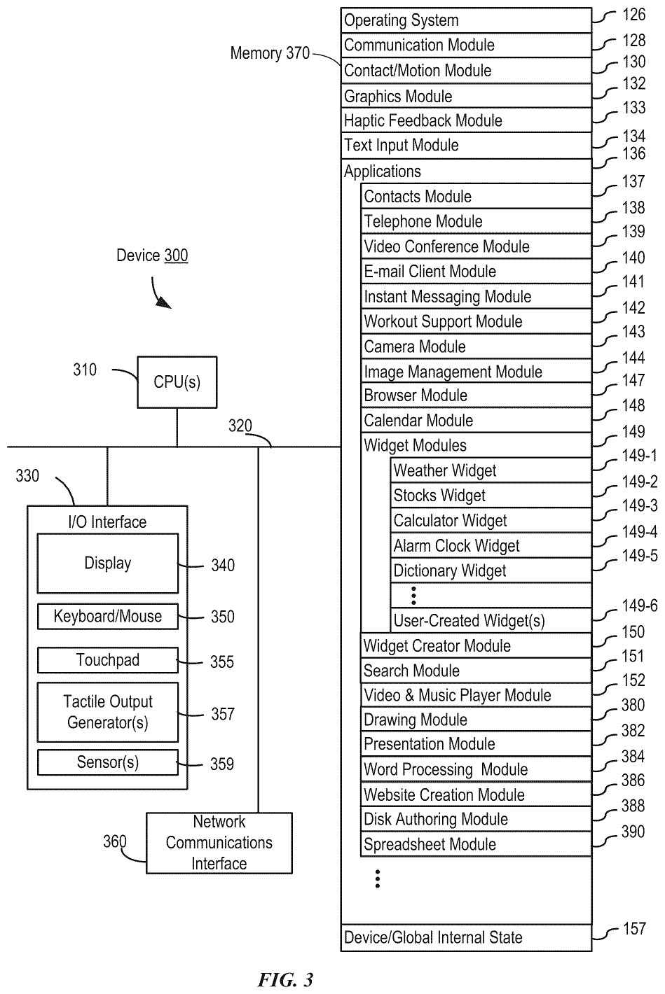

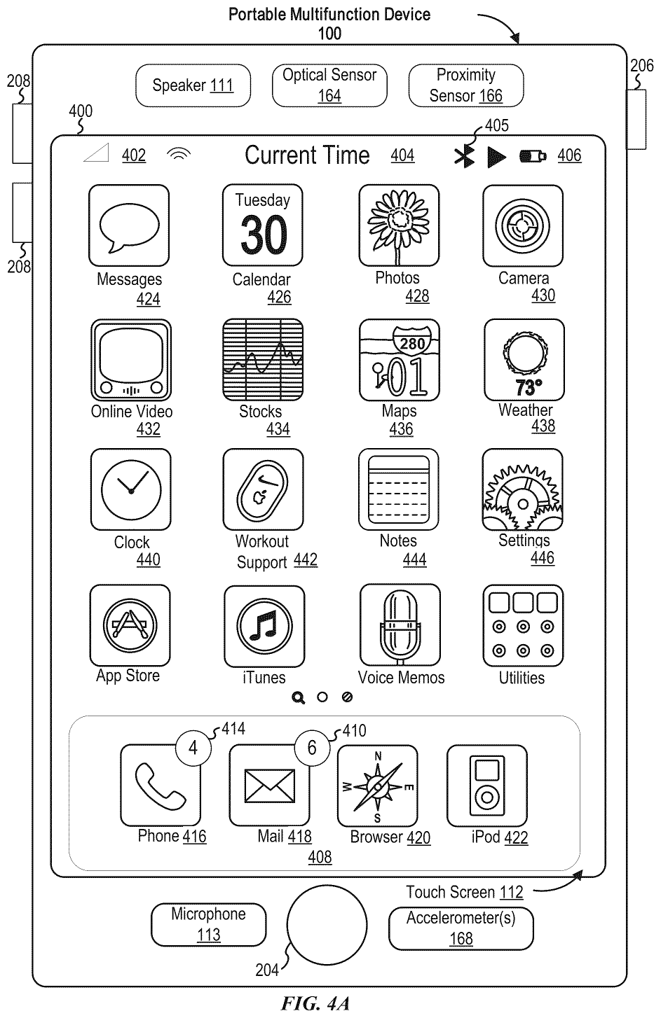

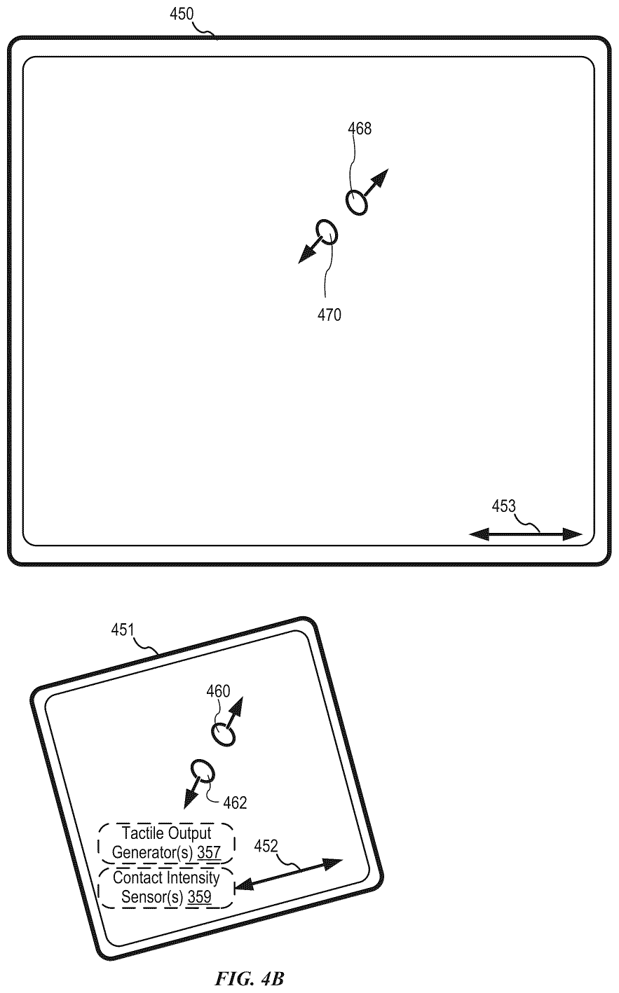

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

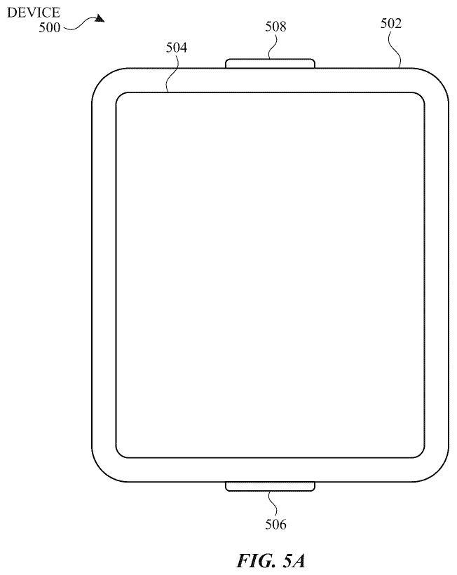

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 900 and 1000 (FIGS. 9 and 10A-10B). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6Y illustrate exemplary user interfaces for accessing media-processing styles using a computer system in accordance with some embodiments. The user interfaces in these figures are used to illustrate the processes described below, including the processes in FIGS. 9 and 10A-10B.

FIG. 6A illustrates computer system 600 displaying a camera user interface, which includes live preview 630 that extends from the top of the display to the bottom of the display. In some embodiments, live preview 630 extends into only a portion of the display, such as the portion of the display with camera display region 604. In some embodiments, computer system 600 includes one or more features of device 100, device 300, and/or device 500.

Live preview 630 shows a particular scene (e.g., person standing in front of a mountain and next to a flower in FIG. 6A) that is in the field-of-view of one or more cameras of computer system 600. Live preview 630 is a representation of a (e.g., partial) field-of-view of at least a first camera of one or more cameras of computer system 600 (“the FOV”). Live preview 630 is based on images detected in the FOV. In some embodiments, computer system 600 captures images using a plurality of camera sensors and combines them to display live preview 630. In some embodiments, computer system 600 captures images using a single camera sensor to display live preview 630.

The camera user interface of FIG. 6A includes indicator region 602 and control region 606. Indicator region 602 and control region 606 are overlaid on live preview 630 such that indicators and controls can be displayed concurrently with live preview 630. Camera display region 604 is positioned between indicator region 602 and control region 606 and is substantially not overlaid with indicators or controls (e.g., affordances).

As illustrated in FIG. 6A, indicator region 602 includes indicators, such as flash indicator 602a, media-processing styles indicator 602b, animated image indicator 602c, and raw indicator 602e. Flash indicator 602a indicates whether the flash is on, off, or in another mode (e.g., automatic mode). In FIG. 6A, flash indicator 602a indicates that the flash is off. Media-processing styles indicator 602b indicates whether computer system 600 is displaying a media-processing styles user interface and/or selectable user interface objects for controlling media-processing styles that are applied to visual content (e.g., data) captured by one or more cameras of computer system 600. At FIG. 6A, media-processing styles indicator 602b is being displayed in an inactive state, which indicates that the plurality of selectable user interface objects for controlling media-processing styles is not being displayed. In some embodiments, a media-processing style has (e.g., defines and/or is defined by) a set of media processing parameters. In some embodiments, one or more of the parameters represent visual characteristics (e.g., color characteristics (e.g., warmth, tone, hue, brightness, saturation, shade, tint, colorfulness, coldness, and/or harmony) and/or depth parameters) that computer system 600 can use to alter the visual content captured by one or more cameras of computer system 600. In some embodiments, each parameter is associated with (or has) a value that impacts how computer system 600 alters the visual content when a particular media-processing style with the respective parameter is applied to the visual content of the media. In some embodiments, one or more of the media-processing styles are predefined and are not created by the user of computer system 600 (e.g., are pre-installed on the computer system without a user of computer system 600 defining the media-processing style). In some embodiments, one or more of the media-processing styles are customized, modified, and/or created by the user of computer system 600. In some embodiments, each media-processing style has the same type of parameters (e.g., parameters corresponding to the same type of visual characteristic). In some embodiments, one or more of the media-processing styles have the same type of parameters but have different values of one or more of the type of parameters corresponding to the one or more media-processing styles.

Animated image indicator 602c indicates whether the camera is configured to capture a single image or a plurality of images (e.g., in response to detecting a request to capture media). In some embodiments, indicator region 602 is overlaid onto live preview 630 and optionally includes a colored (e.g., gray and/or translucent) overlay. Raw capture indicator 602e indicates whether computer system 600 is configured to store and/or capture media in a raw media format. At FIG. 6A, raw capture indicator 602e is displayed in an inactive state, which indicates that computer system 600 is configured to store and capture media in a non-raw format (e.g., joint photographic experts group (JPEG) format and/or high efficiency image coding (HEIC) format). In some embodiments, the file size for media stored in the raw format is bigger than the file size for the same media that is stored in the non-raw format. In some embodiments, media stored in the raw format includes more information than the same media that is stored in the non-raw format. In some embodiments, this more information enables media stored in the raw format to be edited after capture in more ways than media stored in non-raw format. In some embodiments (as discussed further discussed below in relation to FIGS. 6V-6Y), computer system 600 ceases to display media-processing styles indicator 602b when raw capture indicator 602e is displayed in an active state (e.g., as shown in FIG. 6X) and/or when computer system 600 is configured to store and capture media in the raw format. In some embodiments, computer system 600 displays media-processing styles indicator 602b in an inactive state when raw capture indicator 602e is displayed in an active state.

As illustrated in FIG. 6A, camera display region 604 includes live preview 630 and zoom controls 622. Zoom controls 622 include 0.5× zoom control 622a, 1× zoom control 622b, and 2× zoom control 622c. In FIG. 6A, 1× zoom control 622b is selected, which indicates that live preview 630 is being displayed at a 1× zoom level.

As illustrated in FIG. 6A, control region 606 includes shutter control 610, camera switcher control 614, a representation of media collection 612, and camera mode controls 620. Shutter control 610, when activated, causes computer system 600 to capture media (e.g., a photo), using the one or more camera sensors, based on the current state of live preview 630 and the current state of the camera application. The captured media is stored locally at computer system 600 and/or transmitted to a remote server for storage. Camera switcher control 614, when activated, causes computer system 600 to switch to showing the field-of-view of a different camera in live preview 630, such as by switching between a rear-facing camera sensor and a front-facing camera sensor. The representation of media collection 612 illustrated in FIG. 6A is a representation of media (an image, a video) that was most recently captured by computer system 600. In some embodiments, in response to detecting an input on the media collection 612, computer system 600 displays a similar user interface to the user interface illustrated in FIGS. 6S-6U (discussed below).

As illustrated in FIG. 6A, camera mode controls 620 includes slow-motion mode control 620a, video mode control 620b, photo mode control 620c, portrait mode control 620d, and panoramic mode control 620e. As illustrated in FIG. 6A, photo mode control 620c is selected, which is indicated by photo mode control 620c being bolded. When photo mode control 620c is selected, computer system 600 is operating in a photo capture mode and initiates capture of (e.g., and/or captures) photo media (e.g., a still photo) in response to computer system 600 detecting an input directed to shutter control 610. The photo media that is captured by computer system 600 is representative of live preview 630 that is displayed when (or after) the input is directed to shutter control 610 is detected. In some embodiments, in response to detecting an input directed to slow-motion mode control 620a, computer system 600 operates in a slow-motion media capture mode and initiates capture of media (e.g., a video with a slow-motion effect applied, a slow-motion video) that is played back at a slower speed than the speed at which the media was captured. In some embodiments, in response to detecting an input directed to video mode control 620b, computer system 600 operates in a video capture mode and initiates capture of video media (e.g., a video). In some embodiments, in response to detecting an input directed to portrait mode control 620d, computer system 600 operates in a portrait mode and initiates capture of portrait media (e.g., a still photo, a still photo having a simulated bokeh or simulated depth of field effect applied). In some embodiments, in response to detecting an input directed to panoramic mode control 620e, computer system 600 operates in a panoramic mode and initiates capture of panoramic media (e.g., a panoramic photo). In some embodiments, the indicators and/or controls displayed on the camera user interface are based on the mode that is selected (e.g., and/or the mode that computer system 600 is configured to operate in based on the selected camera mode).

At FIG. 6A, computer system 600 is displaying live preview 630 using standard style 634a, which is indicated by live preview 630 being overlaid with a pattern of horizontal lines. It should be understood that computer system 600 does not necessarily display the patterns (e.g., a set of lines in a particular direction (e.g., horizontal, vertical, oblique)) illustrated in the figures across the respective portions of a representation of media (e.g., live preview 630 and/or previously captured representations of media, such as in FIGS. 6S-6U). For example, at FIG. 6A, computer system 600 does not necessarily display the set of horizontal lines when displaying live preview 630. However, the patterns illustrated in the figures are symbolic of a particular portion of a representation of media being displayed using a particular media-processing style (e.g., standard style 634a in FIG. 6A). As discussed above, when a particular media-processing style is applied to visual content of media, visual characteristics (e.g., color characteristics (e.g., warmth, tone, hue, brightness, saturation, shade, tint, colorfulness, coldness, and/or harmony) and/or depth parameters) of the representation of media that is displayed using the media-processing style appear different from the visual characteristics of a representation of media that is not displayed using the media-processing style.

At FIG. 6A, computer system 600 displays live preview 630 using standard style 634a because standard style 634a is the currently selected media-processing style (e.g., as discussed further in relation to FIGS. 6B and 6I-6J), and computer system 600 is configured to operate in a media-processing style application mode (e.g., as discussed further in relation to FIGS. 8A-8C). In some embodiments, when another media-processing style is the currently selected media-processing style, computer system 600 displays live preview 630 using the other media-processing style at FIG. 6A. In some embodiments, when computer system 600 is not configured to operate in the media-processing style application mode, computer system 600 does not display media-processing styles indicator 602b and/or does not apply a media-processing style to a representation of media (e.g., live preview 630 and/or previously captured media) (e.g., as described further in relation to FIGS. 8A-8C). At FIG. 6A, computer system 600 detects tap input 650a on (e.g., directed to and/or at a location that corresponds to) shutter control 610.

At FIG. 6B, in response to detecting tap input 650a, computer system 600 initiates capture of media represented of the FOV and updates media collection 612 to include a representation of the captured media (e.g., live preview 630 of FIG. 6A). Notably, the representation in media collection 612 of FIG. 6B (“representation of FIG. 6B”) looks different than the representation in media collection 612 of FIG. 6A (e.g., “representation of FIG. 6A”). The representation of FIG. 6B has standard style 634a (e.g., horizontal lines) applied and the representation of FIG. 6A does not have the standard style 634a applied. The representation in media collection 612 of FIG. 6B has standard style 634a applied because computer system 600 was displaying live preview 630 using standard style 634a and/or standard style 634a was the currently selected media-processing style to be applied to captured media when tap input 650a was detected. On the other hand, the representation in media collection 612 of FIG. 6A does not have the standard style 634a applied. In some embodiments, this is because the media represented by the representation in media collection 612 of FIG. 6A was not captured while live preview 630 was displayed using standard style 634a and/or while standard style 634a was the currently selected media-processing style when a request to capture the media that corresponds to the representation of FIG. 6A was captured. In some embodiments, to display the representation of FIG. 6B, computer system 600 alters visual characteristics (e.g., besides for the normal and/or a default (e.g., non-user modified) altering of the visual characteristics of capture media that may occur when computer system 600 is not operating in the media-processing style application mode) of the media that corresponds to the representation of FIG. 6B. In some embodiments, the representation of FIG. 6A is not displayed by altering visual characteristics (e.g., besides for the normal and/or default altering of the visual characteristics of captured media that can occur when computer system 600 is not operating in the media-processing style application mode and/or that can occur based on one or more elements (e.g., lighting, shadows) in the FOV) of the media represented by the representation of FIG. 6A. At FIG. 6B, computer system 600 detects tap input 650b on media-processing styles indicator 602b.

As illustrated FIG. 6C, in response to detecting tap input 650b, computer system 600 displays the media-processing styles user interface and/or selectable user interface objects for controlling media-processing styles. In particular, computer system 600 displays different portions of live preview 630 using different media-processing styles. As illustrated in FIG. 6C, in response to detecting tap input 650b, computer system 600 continues to display a portion in the center of live preview 630 (“middle section”) using standard style 634a and ceases to display a portion of live preview 630 that is to the left of the middle section (“left section”) and a portion of live preview 630 that is to the right of the middle section (“right section”) using standard style 634a. For illustrative purpose only, FIG. 6C shows left boundary 642a and right boundary 642b (e.g., which are optionally displayed by computer system 600 at FIG. 6C). As used herein and for case of explanation, the left section can be the portion of live preview 630 to the left of left boundary 642a, the middle section can be the portion of live preview 630 between left boundary 642a and right boundary 642b, and the right section can be the portion of live preview 630 to the right of right boundary 642b. However, these respective sections are referred to for ease of discussion, and computer system 600 can apply one or more media-processing styles to any number of portions/sections of the representation of media and to many different sized, shaped, and/or configured portions/sections of the representation of the media.

As illustrated in FIG. 6C, in response to detecting tap input 650b, the left section and right section is displayed without using any media-processing style (e.g., without any pattern) and/or without using any different media-processing style that was not displayed before tap input 650b was detected (e.g., left section of FIG. 6C is illustrated the same as left section of FIG. 6B). In response to detecting tap input 650b, computer system reduced the visual prominence of the right section and left section by displaying a gray overlay over these sections. Thus, as illustrated in FIG. 6C, the right section and left section have visually merged into indicator region 602 and control region 606, which are also displayed with the gray overlay. As illustrated in FIG. 6C, the right section includes visual element 660b, which is a portion of a border/frame of an object. Visual element 660b indicates that another media-processing style can be applied to live preview 630 that is different from standard style 634a. Here, visual element 660b is displayed in the right section because computer system 600 has determined that one or more other media-processing styles can be selected in response to detecting an input in a particular direction (e.g., the direction of movement input (e.g., a swipe input, a drag input) 650d of FIG. 6D described below) (e.g., indicated by paging dots 638 and described below). Additionally, a visual element is not displayed in the left section because computer system 600 has determined that one or more other media-processing styles cannot be selected in response to detecting an input in another direction (e.g., a direction that is opposite of movement input 650d of FIG. 6D described below) (e.g., indicated by paging dots 638 and described below). As illustrated in FIG. 6C, computer system 600 also displayed divider 640 between the middle section and right section. Divider 640 is displayed without a media-processing style applied and/or without a visual element that reduces/increases the visual prominence of divider 640. In some embodiments, divider 640 is displayed between portions that have different media-processing styles applied and/or visual elements included. In some embodiments, divider 640 is used to delineate and/or define a respective portion of live preview 630 with a media-processing style applied with another portion of live preview 630 that does not have the media-processing style applied. In some embodiments, divider 640 is only displayed between applications of two adjacent and/or different media-processing styles to a representation of media, such as live preview 630.

As illustrated in FIG. 6C, in response to detecting tap input 650b, computer system 600 also displays standard style identifier 636a (e.g., “STANDARD”), which indicates that standard style 634a is the currently selected media-processing style. As illustrated in FIG. 6C, the majority of live preview 630 in camera display region 604 is displayed using the currently selected media-processing style (e.g., standard style 634a). In some embodiments, the majority of live preview 630 in camera display region 604 is not displayed using the currently selected media-processing style.

As illustrated in FIG. 6C, in response to detecting tap input 650b, computer system 600 also displays paging dots 638 that include standard paging dot 638a, vibrant paging dot 638b, luxe paging dot 638c, and vintage paging dot 638d. Here, standard paging dot 638a is displayed as being selected (e.g., represented by the open paging dot) because the middle section of the representation of media is displayed using the standard media-processing style. In some embodiments, standard paging dot 638a is displayed as being selected because a greater portion of the representation of media (e.g., live preview 630) is displayed using standard style 634a rather than any other media-processing style.

Moreover, as illustrated in FIG. 6C, each paging dot (e.g., paging dots 638) corresponds to a media-processing style in a set of available media-processing styles. The set of available media-processing styles are media-processing styles that computer system 600 can use to display a portion of a representation of media. Thus, in FIG. 6C, computer system 600 can display a portion of the representation of media using at least four available media-processing styles. In some embodiments, when a paging dot is added to paging dots 638, computer system 600 adds a media-processing style that corresponds to (e.g., that is represented by) the added paging dot to the set of available media-processing styles. In some embodiments, when a paging dot is removed from paging dots 638, computer system 600 removes a media-processing style from the set of available media-processing styles that corresponds to (e.g., that is represented by) the removed media-processing style. In some embodiments, computer system 600 displays one or more other indications (e.g., besides paging dots) to represent a number of media-processing styles that can be used to display a representation of media and/or the current media-processing style that can be used to display the representation of media.

As illustrated in FIG. 6C, in response to detecting tap input 650b, computer system 600 ceases to display zoom controls 622 and displays standard style control 626a at the location in which zoom controls 622 were previously displayed in FIG. 6B. Standard style control 626a includes control 628 (e.g., discussed below in relation to FIG. 7S in response to tap input 750s being detected), tone parameter control 626a1 and warmth parameter control 626a2. In some embodiments, the warmth parameter controls a color temperature bias of the media item (e.g., whether colors in the media item are shifted toward cool colors, such as blues, greens, and/or purples and/or toward warm colors, such as reds, yellows, and/or oranges). In some embodiments, the tone parameter controls saturation of the media item. In some embodiments, the tone parameter controls a difference between light and dark areas of the image (e.g., luminosity, contrast, brightness, and/or shadows) of the media item. In some embodiments, the tone parameter controls saturation of the media item. In some embodiments the tone parameter controls saturation and a difference between light and dark areas of the image (e.g., increasing the saturation and the difference between light and dark areas in one direction and decreasing the saturation and the difference between light and dark areas in the other direction). In some embodiments, computer system 600 is aware of elements in the scene (e.g., people, animals, pets, trees, flowers, birds, buildings, sky, landscape, mountains, clothes, skin, sunsets and/or water) and adjustments to the tone parameter have different effects on different elements of the scene so that an adjustment of the tone parameter caused different degrees of adjustment between the light and dark areas of the image and/or the saturation differently for different elements in the scene (e.g., increasing the saturation of the sky or mountains or landscapes more than increasing the saturation of a person or pet). For example, when the tone parameter is increased, the amount of saturation applied to the skin of a person is less than the amount of saturation applied to the clothes of the person (optionally, the amount of saturation increase applied to the skin of the person is zero or close to zero) and/or the amount of saturation applied to the clothes of a person is less than the amount of saturation applied to a landscape or sunset behind the person.

Tone parameter control 626a1 includes tone parameter identifier 626a1a, current tone value 626a1b, and tone value range indicator 626a1c. Tone parameter identifier 626a1a denotes the type of parameter (e.g., tone parameter) controlled by tone parameter control 626a1a. Current tone value 626a1b indicates the current value of the tone parameter for standard style 634a. Tone value range indicator 626a1c is a portion of a range of values that includes the current value of the tone parameter. Similarly, warmth parameter control 626a2 includes warmth parameter identifier 626a2a, current warmth value 626a2b, and warmth value range indicator 626a2c. Warmth parameter identifier 626a2a denotes the type of parameter (e.g., warmth parameter) controlled by warmth parameter control 626a2a. Warmth tone value 626a2b is the current value of the warmth parameter for standard style 634a. Warmth value range indicator 626a2c is a portion of a range of values that includes the warmth value of the warmth parameter. Notably, current tone value 626a1b and current warmth value 626a2b are the default values (e.g., “0”) for, respectively, the tone parameter for standard style 634a and the warmth parameter for the standard style 634a. In some embodiments, the default value of a respective parameter for a media-processing style is a value that is predefined and is set without user input.

As illustrated in FIG. 6C, in response to detecting tap input 650b, computer system 600 updates the visual appearance of media-processing styles indicator 602b. In particular, computer system 600 updates the media-processing styles indicator 602b to the active state, which indicates that the media-processing styles user interface and/or selectable user interface objects for controlling media-processing styles are displayed. In some embodiments, computer system 600 updates media-processing styles indicator 602b in other ways to indicate that media-processing styles application mode is in an active state, such as changing the color, removing a slash from (e.g., slash on flash indicator 602a), highlighting, and/or decreasing/increase the size of media-processing styles indicator 602b. In some embodiments, computer system 600 updates media-processing styles indicator 602b to indicate the currently selected media-processing style. Thus, in some embodiments, computer system 600 updates the appearance of media-processing styles indicator 602b when a new media-processing style becomes the currently media-processing style. In some embodiments, in response to detecting a tap input on media-processing styles indicator 602b at FIG. 6C, computer system re-displays the user interface of FIG. 6A. In some embodiments, in response to detecting tap input on animated image indicator 602c, computer system 600 re-displays the user interface of FIG. 6A. At FIG. 6C, computer system 600 detects tap input 650c on shutter control 610.

As illustrated in FIG. 6D, in response to detecting tap input 650c, computer system 600 initiates capture of media represented of the FOV and updates media collection 612 to include a representation of the captured media (e.g., live preview 630 of FIG. 6C) (“representation of FIG. 6D”). The representation of captured media of FIG. 6D has standard style 634a applied (e.g., includes set of horizontal lines) and is the same as the representation of FIG. 6B that had standard style 634a applied (e.g., no set of horizontal lines). The representation of FIG. 6B and the representation of FIG. 6D are the same, although the representation of FIG. 6B was captured while the entirety of live preview 630 was displayed using standard style 634a and representation of FIG. 6D was captured when only the middle section was displayed using has standard style 634a. At FIG. 6D, standard style 634a has been applied to the right, middle, and left sections of representation of FIG. 6D, although the right and left sections of live preview 630 were not displayed using standard style 634a (e.g., in response to tap input 650c being detected). At FIG. 6D, standard style 634a is applied to a greater portion (and/or all of the) visual content of the captured media than what was applied to the visual content in the FOV that was used to display live preview 630 of FIG. 6C. At FIG. 6D, computer system 600 detects a first portion of movement input 650d on live preview 630 in the leftward direction. It should be understood that movement input 650d (e.g., any portion of movement input 650d) can be detected on any location of live preview 630. In some embodiments, no portion of movement input 650d is detected on the left section, visual element 660b, and/or a particular media-processing style (e.g., including standard style 634a, vibrant style 634b, and/or visual element 660b, as discussed below in relation to FIG. 6E).

As illustrated in FIG. 6E, in response to detecting the first portion of movement input 650d (e.g., and while continuing to detect movement input 650d) in the leftward direction, computer system 600 displays a portion (e.g., that includes a left portion of the middle section and the left section) of live preview 630 using standard style 634a and a portion (e.g., that includes a right portion of the middle section and the right section) of live preview 630 using vibrant style 634b. At FIG. 6E, vibrant style 634b is indicated by the set of upward slanting lines (e.g., lines moving in the northeast direction). Looking back at FIG. 6D, computer system 600 did not display a portion of live preview 630 using vibrant style 634b in FIG. 6D. As illustrated in FIG. 6E, standard style 634a is indicated by a different set of lines than vibrant style 634b to indicate that these media-processing styles impact how live preview 630 is displayed in different ways. The sizes of the portion of live preview 630 that is displayed using standard style 634a and the portion of live preview 630 that is displayed using vibrant style 634b is based on the magnitude of a movement characteristic (e.g., including speed, direction, acceleration, and/or time) of the first portion of movement input 650d. In some embodiments, in response to detecting a portion of movement input 650d that has a higher magnitude than the portion of movement input 650d of FIG. 6D, computer system 600 displays a portion of live preview 630 using standard style 634a, which is less than the portion of live preview 630 of FIG. 6E that is displayed using standard style 634a and displays a portion of live preview 630 using vibrant style 634b that is greater than the portion of live preview 630 of FIG. 6E that is displayed using vibrant style 634b. In some embodiments, in response to detecting a portion of movement input 650d that has a lower magnitude than the portion of movement input 650d of FIG. 6D, computer system 600 displays a portion of live preview 630 using standard style 634a, which is more than the portion of live preview 630 of FIG. 6E that is displayed using standard style 634a and displays a portion of live preview 630 using vibrant style 634b that is less than the portion of live preview 630 of FIG. 6E that is displayed using vibrant style 634b. Thus, in some embodiments, the amount of live preview 630 that is displayed using a respective media-processing style is based on the magnitude of a movement input. In some embodiments, computer system 600 moves the application of standard style 634a and vibrant style 634b with movement input 650d. In some embodiments, as a part of displaying the portion of live preview 630 using vibrant style 634b in FIG. 6E, computer system 600 ceases to display visual element 660b. In some embodiments, as a part of ceasing to display visual element 660b, computer system 600 displays an animation (e.g., a fading animation, a dissolving animation) of visual element 660b transitioning into at least a subset of the portion of live preview 630 using vibrant style 634b in FIG. 6E. In some embodiments, in response to detecting movement input 650d (e.g., before any movement of the input is detected), computer system 600 displays the animation of visual element 660b transitioning into at least a subset of the portion of live preview 630 using vibrant style 634b in FIG. 6E. In some embodiments, while detecting movement input 650d, computer system 600 detects a tap input on shutter control 610 and, in response to detecting the tap input on shutter control 610, capture media that has the standard style 634a applied (e.g., because standard style 634a is currently selected in FIG. 6E). At FIG. 6E, computer system 600 detects a second portion of movement input 650d on live preview 630 in the leftward direction.

As illustrated in FIG. 6F, in response to detecting the second portion of movement input 650d in the leftward direction (e.g., and while continuing to detect movement input 650d), computer system 600 moves the application of standard style 634a and vibrant style 634b to the left (e.g., in the direction of the second portion of movement input 650d). As illustrated in FIG. 6F, in response to detecting the second portion of input 650d in the leftward direction, computer system 600 displays a portion (e.g., that includes a reduced portion of the middle section as compared to FIG. 6E and the left section) of live preview 630 using standard style 634a and a portion (e.g., that includes an increased portion of the middle section as compared to FIG. 6E and the right section) of live preview 630 using vibrant style 634b. Accordingly, based on the second portion of movement input 650d, the size of the portion of live preview 630 that is displayed using standard style 634a of FIG. 6F is less than the size of the portion of live preview 630 that is displayed using standard style 634a of FIG. 6E. Additionally, based on the second portion of movement input 650d, the size of the portion of live preview 630 that is displayed using vibrant style 634b of FIG. 6F is more than the size of the portion of live preview 630 that is displayed using vibrant style 634b of FIG. 6E. As computer system 600 moves the application of standard style 634a and vibrant style 634b to the left, computer system 600 moves divider 640 while maintaining divider 640 between the portion of live preview 630 that is displayed using standard style 634a and the portion of live preview 630 that is displayed using vibrant style 634b (e.g., based on and/or consistent with the movement of input 650d).

At FIG. 6F, in response to detecting the second portion of movement input 650d, computer system 600 ceases to display standard style identifier 636a and displays vibrant style identifier 636b (e.g., “Vibrant”) (e.g., at the location at which standard style identifier 636a was previously displayed). In addition, computer system 600 also updates paging dots 638 to indicate that vibrant paging dot 638b (e.g., hallow/open paging dot) is selected and that standard paging dot 638a is not selected (e.g., solid/closed paging dot). Here, computer system 600 displays vibrant style identifier 636b and displays vibrant paging dot 638b as being selected because a determination has been made that a greater portion (or an equal portion) of live preview 630 is displayed using vibrant style 634b than the portion of live preview 630 that is displayed using standard style 634a. Because of this determination, computer system 600 sets vibrant style 634b as the currently selected media-processing style and replaces standard style control 626a with vibrant style control 626b. As illustrated in FIG. 6F, vibrant style control 626b includes control 628, tone parameter control 626b1 (e.g., for controlling a tone parameter for vibrant style 634b) and warmth parameter control 626b2 (e.g., for controlling a warmth parameter for vibrant style 634b), which are displayed using similar techniques as those described above (e.g., in relation to control 628, tone parameter control 626a1 and warmth parameter control 626a2 of FIG. 6C, respectively). Current tone value 626b1b is the default value (e.g., “80”) for the tone parameter for vibrant style 634b, and current warmth value 626b2b is the default value (e.g., “0”) for the warmth parameter for vibrant style 634b. Notably, the default value for the tone parameter for standard style 634a is different from the default value for the tone parameter for vibrant style 634b. Likewise, tone value range indicator 626a1c is different from tone value range indicator 626b1c because current tone value 626a1b and current tone value 626b1b are different (e.g., because each respective current value is positioned in a different range of a scale for the tone parameter). In some embodiments, a difference in default values for a particular type of parameter of respective media-processing styles leads to the defining of different media-processing styles.

Looking back at FIG. 6E, computer system 600 continued to display standard style control 626a and standard style identifier 636a and to display standard paging dot 638a as selected because a determination was not made that a greater portion (or an equal portion) of live preview 630 is displayed using vibrant style 634b than the portion of live preview 630 that is displayed using standard style 634a (e.g., and/or a determination was made that a greater portion (or an equal portion) of live preview 630 is displayed using standard style 634a than the portion of live preview 630 that is displayed using vibrant style 634b) in FIG. 6E. Turning back to FIG. 6F, in some embodiments, computer system 600 displays vibrant style control 626b and vibrant style identifier 636b and displays vibrant paging dot 638b as being selected because vibrant style 634b is displayed using a particular portion of live preview 630 (e.g., a portion at/near the center of live preview 630 and/or the display of computer system 600) and/or vibrant style 634b is currently being displayed at a boundary location of live preview 630 (e.g., in/near the center of live preview 630 and/or the display of computer system 600). At FIG. 6F, computer system 600 detects a third portion of movement input 650d on live preview 630 in a rightward direction. The third portion of movement input 650d is detected as moving in the opposite direction of the first portion and the second portion of movement input 650d.

As illustrated in FIG. 6F, in response to detecting the second portion of movement input 650d, computer system 600 changes the appearance of media-processing styles indicator 602b. At FIG. 6F, the appearance of media-processing styles indicator 602b is changed because the currently selected media-processing style has changed from the standard style 634a (e.g., FIG. 6E) to vibrant style 634b (e.g., in FIG. 6F) and the vibrant style 634b has a value for a parameter that is different (e.g., tone parameter) from a value of the parameter for standard style 634a. As illustrated in FIG. 6F, computer system 600 displays a line that travels around the perimeter of media-processing styles indicator 602b in a clockwise direction (e.g., with a starting point that is near the middle of the top portion of the perimeter (and/or border) of media-processing styles indicator 602b). The line is displayed to represent the current value (e.g., “80” in FIG. 6F) of the tone parameter. As illustrated in FIG. 6F, the line travels around the perimeter of media-processing styles indicator 602b based on a relationship between the current value of the tone parameter and a minimum value (e.g., “−100”) and/or a maximum value (e.g., 100) to which the tone parameter can be set. Thus, as shown in FIG. 6F, the line travels around roughly eighty percent of the perimeter of media-processing style because the current value (e.g., “80”) is eighty percent of the exemplary maximum value (e.g., “100”). Looking back at FIG. 6E, media-processing styles indicator 602b does not include a line that travels around the perimeter of media-processing styles indicator 602b because the current value (e.g., “0”) of the tone parameter in FIG. 6E was zero percent of the minimum/maximum value to which the tone parameter could be set. In some embodiments, when the current value is a different value, the line travels around the perimeter and/or occupies a different amount (e.g., more or less) of the perimeter of media-processing styles indicator 602b.

As illustrated in FIG. 6F, the line travels around the perimeter of media-processing styles indicator 602b in the clockwise direction because the current value of the tone parameter is positive and/or above a median value (e.g., “0”). In some embodiments, when the current value of the tone parameter is negative or below a media value (e.g., “0”), the live travels around the perimeter of media-processing styles indicator 602b in a counter-clockwise direction. Thus, in some embodiments, the direction at which the line travels around the perimeter of media-processing styles indicator 602b indicates whether the value of the tone parameter is positive (or above a median value) or negative (or below a median value). In some embodiments, computer system 600 changes one or more other visual aspects (e.g., other than a line around the perimeter) of media-processing styles indicator 602b when the current value of the tone parameter (or another parameter) changes, such as changing a color of a portion of media-processing styles indicator 602b and/or a size of a portion of media-processing styles indicator 602b. In some embodiments, a gradual animation of the visual aspect changing is displayed by computer system 600. In some embodiments, the animation includes the line around the perimeter of media-processing styles indicator 602b moving in a clockwise or counter-clockwise direction from a position that corresponds to the previous value of a respective parameter to a position that corresponds to the current value of the respective parameter.

As illustrated in FIG. 6G, in response to detecting the third portion of movement input 650d (e.g., and while continuing to detect movement input 650d), computer system 600 moves the portions of live preview that are displayed using (e.g., individually using) standard style 634a and vibrant style 634b to the right based on the magnitude of the third portion of movement input 650d. As illustrated in FIG. 6G, in response to detecting the third portion of movement input 650d, computer system 600 displays the various portions of live preview 630 using a respective media-processing style and/or one or more user interface objects (e.g., standard style identifier 636a, standard paging dot 638a as selected, standard style control 626a) using one or more techniques as those described above in relation to FIGS. 6C-6E. At FIG. 6G, computer system 600 detects a fourth portion of movement input 650d on live preview 630 in a leftward direction. As illustrated in FIG. 6G, in response to detecting the third portion of movement input 650d, computer system 600 changes the appearance of media-processing styles indicator 602b by removing the line around the perimeter of media-processing styles indicator 602b. The line around the perimeter of media-processing styles indicator 602b is removed because the current value of the tone perimeter at FIG. 6G is zero and/or the current value of the tone perimeter at FIG. 6G is zero percent of the minimum/maximum value to which the tone parameter can be set. In some embodiments, in response to detecting the third portion of movement input 650d, computer system 600 displays an animation of the line around the perimeter of media-processing styles indicator 602b (e.g., at displayed in FIG. 6F) shrinking in a counter-clockwise direction (e.g., towards the top and center position of media-processing styles indicator 602b) until the line is no longer displayed (e.g., as shown in FIG. 6G) around the perimeter of media-processing styles indicator 602b.

As illustrated in FIG. 6H, in response to detecting the fourth portion of movement input 650d (e.g., and while continuing to detect movement input 650d), computer system 600 moves the portions of live preview 630 that are displayed using standard style 634a and vibrant style 634b to the left based on the magnitude of the third portion of movement input 650d. Because the fourth portion of movement input 650d had a greater magnitude than the third portion of movement input 650d, computer system 600 translates the portions of live preview 630 that are displayed using standard style 634a and vibrant style 634b across a greater distance in response to detecting the third portion of movement input 650d (e.g., in FIGS. 6G-6H) than the distance that the applications of standard style 634a and vibrant style 634b were translated in response to detecting the fourth portion of movement input 650d (e.g., in FIGS. 6F-6G). As illustrated in FIG. 6H, in response to detecting the fourth portion of movement input 650d, computer system 600 displays the majority of live preview 630 using vibrant style 634b and displays a lesser portion of live preview 630 using standard style 634a. As illustrated in FIG. 6H, in response to detecting the fourth portion of movement input 650d, computer system 600 also displays one or more user interface objects (e.g., vibrant style identifier 636b, vibrant paging dot 638b as selected, vibrant style control 626b) using one or more techniques as those described above in relation to FIG. 6F. At FIG. 6H, computer system 600 detects an end (e.g., liftoff) of movement input 650d (e.g., at the position that movement input 650d is shown in FIG. 6H).

As illustrated in FIG. 6I, in response to detecting the end of movement input 650d, computer system 600 displays the middle section using vibrant style 634b. Here, computer system 600 displays the middle section using vibrant style 634b because a determination was made that a greater portion of live preview 630 was displayed using the vibrant style 634b than the portions that were displayed using another media-processing style (e.g., standard style 634a) when (and/or before (e.g., immediately before) and/or after (e.g., immediately after)) the end of the movement input 650d was detected. Thus, at FIG. 6I, computer system 600 has made vibrant style 634b the currently selected media-processing style based on this determination. In some embodiments, computer system 600 displays the middle section using standard style 634a when a determination is made that a greater portion of live preview 630 was displayed using the standard style 634a than the portions that were displayed using another media-processing style (e.g., vibrant style 634b) when the end of the movement input 650d was detected. In some embodiments, computer system 600 displays the animation (e.g., a snapping animation) of the applications of standard style 634a and vibrant style 634b being translated (e.g., rapidly snapping) across the display from the position that each of standard style 634a and vibrant style 634b are displayed in FIG. 6H to the position that each of standard style 634a and vibrant style 634b are displayed in FIG. 6I.

As illustrated in FIG. 6I, in response to detecting the end of movement input 650d (e.g., and because a determination was made that a greater portion of live preview 630 was displayed using the vibrant style 634b than the portions that were displayed using another media-processing style when the end of the movement input 650d was detected), computer system 600 moves the application of standard style 634a to the left to display the left section using standard style 634a. In addition, computer system 600 also displays the right section using luxe style 634c. At FIG. 6I, luxe style 634c is indicated by the set of downward slanting lines (e.g., lines moving in the southeast direction when scanning from left to right). In some embodiments, computer system 600 displays the right section using luxe style 634c because a determination is made that luxe style 634c can be selected via a movement input (e.g., a movement input, such as movement input 650kl as described below in relation to FIGS. 6K-6L).

As illustrated in FIG. 6J, some after detecting the end of movement input 650d, computer system 600 displays visual element 660a over the left section and visual element 660b over the right section and reduces the visual prominence of the left and the right section. In some embodiment, as a part of displaying visual element 660a over the left section and visual element 660b over the right section, computer system 600 displays an animation of standard style 634a and luxe style 634c fading out (e.g., and/or dissolving into visual element 660a and/or visual element 660b). At FIG. 6J, computer system 600 detects tap input 650j on shutter control 610.

As illustrated in FIG. 6K, in response to detecting tap input 650j, computer system 600 initiates capture of media represented by the FOV and updates media collection 612 to include a representation of the captured media (e.g., live preview 630 of FIG. 6J). The representation of captured media of FIG. 6K (“representation of FIG. 6K”) has vibrant style 634b applied (e.g., includes set of upward slanting lines when scanning from left to right), which is different from the representation of FIG. 6B and the representation of FIG. 6D. Moreover, vibrant style 634b has been applied to the right, middle, and left sections of the representation of captured media, although the right and left sections of live preview 630 were not displayed using vibrant style 634b (e.g., when/while tap input 650j was detected). At FIG. 6K, vibrant style 634b is applied to a greater portion (and/or all of the) visual content of the captured media than what was applied to the visual content in the FOV that was used to display live preview 630. In some embodiments, in response to detecting the tap input on shutter control 610 and detecting movement input 650d, computer system 600 captures media, where a displayed representation of the captured media has the media-processing style that was applied to the greatest portion of live preview 630 when the tap input on shutter control 610 was detected (e.g., irrespective of whether another media-processing style was applied to a smaller portion of live preview 630 when tap input on shutter control was detected) (e.g., and without having any other media-processing styles being applied to the representation of the media, irrespective other whether another media-processing style was applied to a smaller portion of live preview 630 when tap input on shutter control was detected). At FIG. 6K, computer system 600 detects movement input 650kl in the leftward direction (e.g., the same direction as the first portion of movement input 650d in FIG. 6D) or movement input 650k2 in a rightward direction (e.g., the opposite direction of movement input 650d in FIG. 6D).

As illustrated in FIG. 6L, in response to detecting movement input 650kl (e.g., while continuing to detect movement input 650k1), computer system 600 displays a portion (e.g., including a left portion of the middle section) of live preview 630 using vibrant style 634b and a portion (e.g., including a right portion of middle section that was displayed using vibrant style 634b in FIG. 6K and right section) of live preview 630 using luxe style 634c (e.g., using one or more techniques as discussed above in relation to FIGS. 6C-6F). At FIG. 6L, in response to detecting the movement input 650k1, computer system 600 ceases to display vibrant style identifier 636b (e.g., “VIBRANT”) and displays luxe style identifier 636c (e.g., “LUXE”) (e.g., at the location at which vibrant style identifier 636b was previously displayed). In addition, computer system 600 also updates paging dots 638 to indicate that luxe paging dot 638c (e.g., hallow/open paging dot) is selected and that vibrant paging dot 638b is not selected (e.g., solid/closed paging dot). Here, computer system 600 displays luxe style identifier 636c and displays luxe paging dot 638c as being selected because a determination has been made that a greater portion (or an equal portion) of live preview 630 is displayed using luxe style 634c than the portion of live preview 630 that is displayed using vibrant style 634b and/or that luxe style 634c should be set as the currently selected media-processing style (e.g., using one or more techniques as described above in relation to detecting the movement input 650d in FIGS. 6H-6I). Because of this determination, computer system 600 also replaces vibrant style control 626b with luxe style control 626c, as illustrated in FIG. 6L. Luxe style control 626c includes control 628, tone parameter control 626c1 (e.g., for controlling a tone parameter for luxe style 634c), and warmth parameter control 626c2 (e.g., for controlling a warmth parameter for luxe style 634c), which are displayed using similar techniques as those described above (e.g., in relation to control 628, tone parameter control 626a1 and warmth parameter control 626a2 of FIG. 6C, respectively). Current tone value 626c1b is the default value (e.g., “50”) for the tone parameter for luxe style 634c, and current warmth value 626c2b is the default value (e.g., “70”) for the warmth parameter for luxe style 634c. Notably, the default values for the tone parameter and warmth parameter for luxe style 634c is different from the default values for the tone and warmth for standard style 634a (e.g., tone: 0, warmth: 0, as shown in FIG. 6C) and vibrant style 634b (e.g., tone: 80, warmth: 0, as shown in FIG. 6F). This denotes that the predefined luxe style 634c is different from the predefined standard style 634a and vibrant style 634b. In some embodiments, in response to movement input 650k2 in the rightward direction at FIG. 6K, computer system 600 displays one of the user interfaces in FIGS. 6D-6H (e.g., where the user interface that is displayed depends on the magnitude of movement input 650k2). At FIG. 6L, computer system 600 detects an end (e.g., liftoff) of movement input 650kl (e.g., at the position that movement input 650kl is shown in FIG. 6K).

As illustrated in FIG. 6L, in response to detecting movement input 650k1, computer system 600 changes the appearance of media-processing styles indicator 602b. In particular, computer system 600 changes two visual aspects of media-processing styles indicator 602b. At FIG. 6L, computer system 600 changes two visual aspects of media-processing styles indicator 602b, such that a change to a respective visual aspect represents a change (or the current value) of a respective parameter. While FIG. 6L illustrates computer system 600 changing the line around the perimeter of media-processing styles indicator 602b based on a change to the current value of the tone parameter and changing the color of media-processing styles indicator 602b based on a change to the current value of the warmth parameter, the way that media-processing styles indicator 602b is changed in FIG. 6L is merely exemplary. In some embodiments, computer system 600 changes a different visual aspect of media-processing styles indicator 602b based on the current value of the warmth parameter, the tone parameter, and/or a different parameter. In some embodiments, computer system 600 changes the line around the perimeter of media-processing styles indicator 602b based on a change to the current value of the warmth parameter and/or changes the color of media-processing styles indicator 602b based on the current value of the tone parameter.

As illustrated in FIG. 6L, because the current value (e.g., “50”) of the tone parameter in FIG. 6L is less than the previous value (e.g., “80”) of the tone parameter in FIG. 6K, computer system 600 updates the line (e.g., a first visual aspect) around the perimeter of media-processing styles indicator 602b (e.g., using one or more techniques as discussed above in relation to FIGS. 6F-6G) to occupy less of the perimeter of media-processing styles indicator 602b (e.g., shrinks the line in the counter-clockwise direction). However, because the current value (e.g., 50) of the tone parameter in FIG. 6L is positive like the previous value (e.g., “80”) of the tone parameter in FIG. 6K, computer system 600 continues to display line around the media-processing styles indicator 602b as traveling (e.g., oriented in such a way that the line appears to travel) in the clockwise direction. As illustrated in FIG. 6L, computer system 600 changes the color (e.g., a second visual aspect) of media-processing styles indicator 602b. Here, computer system 600 changes the color of media-processing styles indicator 602b to represent the current value (e.g., “70”) of the warmth parameter, which is different from the previous value (e.g., “0”) of the warmth parameter. As illustrated in FIG. 6L, the color of media-processing styles indicator 602b of FIG. 6L is a darker gray than the color of media-processing styles indicator 602b of FIG. 6K. As the current value of the warmth parameter increases, computer system 600 adds more dark grey to the color of media-processing styles indicator 602b, where the amount of dark gray is roughly equal to percentage of the current value (e.g., “70”) of the warmth parameter and the maximum (e.g., “100”) and/or minimum value of the warmth parameter. Thus, as illustrated in FIG. 6L, computer system 600 displays media-processing styles indicator 602b as having seventy percent of the maximum amount of dark grey. In some embodiments, computer system 600 darkens the color of media-processing styles indicator 602b as the value of the warmth parameter increases and/or decreases. In some embodiments, computer system 600 increases the amount of a first color (e.g., red) that makes up the color of media-processing styles indicator 602b as the current value increases above a median value (e.g., “0”). In some embodiments, computer system 600 decreases the amount of the first color (e.g., red) that makes up the color of media-processing styles indicator 602b as the value decreases towards a median value (e.g., “0”) (e.g., between the maximum value and the median value). In some embodiments, computer system 600 increases the amount of a second color (e.g., blue) that makes up the color of media-processing styles indicator 602b as the current value decreases below a median value (e.g., “0”). In some embodiments, computer system 600 decreases the amount of the first color (e.g., red) that makes up the color of media-processing styles indicator 602b as the value increases towards a median value (e.g., “0”) (e.g., between minimum value and the median value). In some embodiments, computer system 600 changes the color of the line around the perimeter of media-processing styles indicator 602b based on a change in the current value of the warmth parameter.

As illustrated in FIG. 6M, in response to detecting the end of movement input 650kl, computer system 600 displays the middle section using luxe style 634c, the left section using vibrant style 634b, and the right section using vintage style 634d. Computer system 600 displays the middle section using luxe style 634c, the left section using vibrant style 634b, and the right section using vintage style 634d because a determination was made that luxe style 634c should be set as the currently selected media-processing style (e.g., using one or more techniques as described above in relation to detecting the end of movement input 650d in FIGS. 6H-6I). At FIG. 6M, computer system 600 detects tap input 650m on mode-and-settings toggle 616.

As illustrated in FIG. 6N, in response to detecting tap input 650m, computer system 600 ceases display of luxe style identifier 636c and paging dots 638 and displays zoom controls 622 (e.g., at the location in which one or more of luxe style identifier 636c and paging dots 638 were previously displayed). As illustrated in FIG. 6N, in response to detecting tap input 650m, computer system ceases display of luxe style control 626c and displays camera mode controls 620 (e.g., at the location in which luxe style control 626c was previously displayed in FIG. 6M). In response to detecting tap input 650m, computer system 600 updates the display of media-processing styles indicator 602b to the inactive state. Thus, in response to detecting tap input 650m, computer system 600 continues to display a portion of the representation using the luxe style 634c (e.g., that was selected in FIG. 6M when the style was displayed in the middle section of computer system 600 while an input was not detected). However, computer system 600 ceases to display the right section and the left section using a different media-processing style than luxe style 634c and/or with a visual element in response to detecting tap input 650m. In some embodiments, computer system 600 ceases to display the right section and the left section using a different media-processing style than luxe style 634c and/or with a visual element because a movement input on live preview 630 would not cause portions of live preview 630 to be displayed using a different media-processing style (e.g., would not cause a change in which media-processing styles are used) in FIG. 6N. At FIG. 6N, computer system detects movement input 650n1 on camera mode controls 620 in a leftward direction or movement input 650n2 on live preview 630 in a leftward direction.

At FIG. 6O, in response to detecting movement input 650n1 or 650n2, computer system 600 is transitioned from operating in the photo capture mode to operating in the portrait capture mode. As illustrated in FIG. 6O, in response to detecting movement input 650n1 or 650n2, computer system 600 moves camera mode controls 620 to the left and displays portrait mode control 620d as being selected (e.g., bold portrait mode control 620d). While operating in the portrait mode, computer system 600 maintains display of at least a portion of live preview 630 using luxe style 634d (e.g., which was selected in 6M). Thus, media-processing styles can be applied to representations of media (e.g., live preview 630) while computer system 600 is configured to captured other types of media (e.g., photo media, video media, and/or portrait media, panoramic media). In some embodiments, in response to detecting movement input 650n2 while media-processing styles indicator 602b is displayed in an active state (and/or while the styles user interface objects are displayed), computer system 600 is not transitioned to operate in a different capture mode (e.g., computer system 600 continues to operate in the same capture mode in which computer system 600 operated before movement input 650n2 was detected). In some embodiments, in response to detecting movement input 650n2 while media-processing styles indicator 602b is in an inactive state, computer system 600 is transitioned to operate in a different capture mode (e.g., as shown in FIGS. 6N-60). In some embodiments, computer system 600 would transition to operating in the portrait capture mode in response to input 650n1 being detected, irrespective of whether or not media-processing styles indicator 602b is in the active state or inactive state. Thus, in some embodiments, computer system 600 can respond to a movement input differently based on the location of the movement input and whether the computer system is currently displaying a set of styles user interface objects. As illustrated in FIG. 6O, in response to detecting movement input 650n1 or 650n2, computer system 600 also displays indicators for the portrait capture mode (e.g., f-stop indicator 602d) in indicator region 602 and controls for the portrait mode in control region 606 (e.g., lighting effect controls 678, zoom control 622b) that were not displayed while computer system 600 was operating in photo capture mode in FIG. 6N. Moreover, in response to detecting movement input 650n1 and 650n2, computer system 600 ceases display of indicators for the photo capture mode (e.g., animated image indicator 602c) in indicator region 602 and controls for the photo mode in control region 606 (e.g., zoom control 622a and zoom control 622c) that were displayed when computer system 600 was operating in portrait mode in FIG. 6N. In some embodiments, in response to detecting a movement input at FIG. 6N on live preview 630, computer system 600 is transitioned from operating in the portrait capture mode to operating in a different capture mode (e.g., using similar techniques as those described above in relation to movement input 650n1 or 650n2) because computer system is not displaying the styles user interface and/or the plurality of selectable user interface objects for controlling media-processing styles. In some embodiments, in response to detecting a movement input (e.g., at a similar location of movement input 650n1 or movement input 650n2), computer system 600 is transitioned from operating in the portrait capture mode to operating in a different capture mode and maintains (or while maintaining) display of at least a portion of live preview 630 using the currently selected style (e.g., luxe style 634d selected in 6M)). In some embodiments, in response to detecting that movement input 650n1 or movement input 650n2 had a particular magnitude (e.g., a greater magnitude) and/or a was in a different than movement input 650n1 or movement input 650n2, computer system 600 is transitioned from operating in the photo mode to operate in a mode that is different from the portrait mode (e.g., panoramic mode and/or video mode) and maintains (or while maintaining) display of at least a portion of live preview 630 using the currently selected style (e.g., luxe style 634c selected in 6M)). In some embodiments, in response to detecting a request to capture media, computer system 600 capture portrait media and applies the currently selected media-processing style (e.g., luxe style 634c) to the captured portrait media. Thus, in some embodiments, computer system 600 can apply the currently selected media-processing style to different types of media (e.g., portrait media at FIG. 6O and photo media at FIG. 6C). At FIG. 60, computer system detects tap input 6500 on media-processing styles indicator 602b.

As illustrated in FIG. 6P, in response to detecting tap input 6500, computer system 600 re-displays one or more styles user interface objects, including luxe style identifier 636c, paging dots 638, luxe style control 626c, and visual elements 660a and 660b (e.g., using one or more techniques as described above in relation to FIG. 6M) while continuing to operate in the portrait mode. In some embodiments, in response to detecting a movement input on live preview 630, computer system 600 displays different portions of live preview 630 using different media-processing styles (e.g., using one or more techniques described above in relation to FIGS. 6C-6P) while continuing to operate in the portrait mode. Thus, in some embodiments, different media-processing styles can be selected while computer system 600 is operating in different capture modes. In some embodiments, in response to detecting a tap input on shutter control 610, computer system 600 captures portrait media, where a representation of the portrait media is displayed as luxe style 634c (e.g., because style 634c is selected in FIG. 6P). In some embodiments, in response to detecting an input on f-stop indicator 602d, computer system 600 re-displays the user interface of FIG. 6O (e.g., ceases to display the styles user interface and/or the plurality of selectable user interface objects for controlling media-processing styles). At FIG. 6P, computer system 600 detects tap input 650p on media collection 612.

As illustrated in FIG. 6Q, in response to detecting tap input 650p, computer system 600 displays a media viewer user interface that includes control region 670, media viewer region 672, and control region 674. Control region 670 includes back control 670a, current time 670b, and media gallery control 670c. Control region 674 includes multiple controls and thumbnail representations of media 676, including thumbnail representations 676a-676d. Thumbnail representations 676a-676d were previously displayed as a part of media collection 612 in FIGS. 6A-6Q. Media viewer region 672 includes media representation 680d. As illustrated in FIG. 6Q, media representation 680d is a representation of the media that was captured in response to detecting input 650j. As illustrated in FIG. 6Q, media representation 680d is displayed using vibrant style 634b, which was the currently selected media-processing style when the media that corresponds to media representation 680d was captured. At FIG. 6Q, computer system 600 detects tap input 650q on back control 670a.

As illustrated in FIG. 6R, in response to detecting tap input 650q, computer system 600 re-displays the user interface of FIG. 6O, where live preview 630 at FIG. 6R is displayed using luxe style 634c. At FIG. 6R, live preview 630 is displayed using luxe style 634c because computer system 600 has maintained luxe style 634c as the currently selected media-processing style even though computer system 600 has navigated away from the camera application to the media viewer application. Thus, in some embodiments, computer system 600 maintains the currently selected media-processing style between sessions of using the camera application. In some embodiments, computer system 600 maintains luxe style 634c as the currently selected media-processing style until a new media-processing style is selected and/or vibrant style 634b is modified (e.g., as discussed below in FIGS. 7A-7X). In some embodiments, in response to detecting tap input 650q, computer system 600 re-displays the user interface of FIG. 6Q instead of FIG. 6O, showing the styles user interface and/or selectable user interface objects for controlling media-processing styles. At FIG. 6R, computer system 600 detects tap input 650r on media collection 612.

As illustrated in FIG. 6S, in response to detecting tap input 650r, computer system 600 re-displays the user interface of FIG. 6Q, which includes media representation 680d. As illustrated in FIG. 6S, computer system 600 detects movement input 650s on media representation 680d. As illustrated in FIG. 6T, in response to detecting movement input 650s, computer system 600 replaces media representation 680d with media representation 680c. Media representation 680c is displayed using standard style 634a because it is a representation of the media that was captured in response to detecting input 650c when standard style 634a was the currently selected media-processing style in FIG. 6C. In some embodiments, the media viewer user interface includes one or more options to change the media-processing style that is applied to media that has already been captured, such as the media represented by media representation 680c and media representation 680d. Thus, in some embodiments, the computer system applies a different media processing style to previously captured media that was not originally captured when the different media processing style was the currently selected processing style. At FIG. 6T, computer system 600 detects tap input 650t on media gallery control 670c.

As illustrated in FIG. 6U, in response to detecting tap input 650t, computer system 600 displays a media gallery user interface. The gallery user interface includes back control 686 and representations of media that have been captured using a media-processing style (e.g., standard style 634a (e.g., represented by the pattern that includes horizontal lines), vibrant style 634b (e.g., represented by the pattern that includes upward slanting lines), luxe style 634c (e.g., represented by the pattern that includes downward slanting lines), and vintage style 634d (e.g., represented by the pattern that includes vertical lines). In some embodiments, media represented by the representations of media included in the media gallery user interface are different types of media (e.g., still photo media, portrait media, video media, panoramic media, slow-motion media, etc.). In some embodiments, the media represented by the representations of media included in the media gallery user interface were captured while the different media-processing style was selected and/or while computer system 600 was configured to operate in different capture modes. At FIG. 6U, computer system 600 detects tap input 650u on back control 686.

As illustrated in FIG. 6V, in response to detecting tap input 650u, computer system 600 ceases to display the media gallery user interface (e.g., of FIG. 6U) and re-displays the camera user interface of FIG. 6R, where live preview 630 at FIG. 6R is displayed using luxe style 634c. At FIG. 6V, computer system 600 detects tap input 650v on raw capture indicator 602c. As illustrated in FIG. 6W, in response to detecting tap input 650v, computer system 600 ceases to display media-processing styles indicator 602b and ceases to apply a media-processing style to a portion of live preview 630. As illustrated in FIG. 6W, in response to detecting tap input 650v, computer system 600 slides raw capture indicator 602e over to the left to the location in which media-processing styles indicator 602b was previously displayed. At FIG. 6W, in response to detecting tap input 650v, computer system 600 is transitioned from being configured to store and/or capture media in a non-raw media format to a raw format and displays raw capture control 602e as being active. In some embodiments (as discussed above), computer system 600 does not apply a selected media-processing style to media that is stored in the raw format. Thus, in some embodiments, computer system 600 is not able to be configured to store and/or capture media in the raw format while also being configured to apply a media-processing style to captured media. At FIG. 6W, computer system 600 detects upward swipe input 650w at a location on the camera user interface (e.g., on and/or below one or more camera mode affordances 620).

As illustrated in FIG. 6X, in response to detecting upward swipe input 650w, computer system 600 replaces camera mode controls 620 of FIG. 6W with camera setting controls 688. Camera setting controls 688 includes flash setting control 668a that, when selected, causes computer system 600 to display one or more options for adjusting a flash mode (e.g., turning flash mode on and/or off), media-processing style control 688b, exposure compensation control 688f that, when selected, computer system 600 to display one or more options (e.g., a slider) adjusting an exposure compensation value, timer control 688g that, when selected, causes computer system 600 to display one or more options for adjusting a duration of a timer, filter control 688h that, when selected, causes computer system 600 to display one or more options for adjusting a filter that is applied to media, and f-stop control 688i that, when selected, causes computer system 600 to display one or more options for adjusting an f-stop value. In particular, the camera setting controls displayed in FIG. 6X reflect some of the camera settings that are available while computer system 600 is operating in the portrait mode (e.g., as shown in FIG. 6W by “PORTRAIT” being bolded). In some embodiments, one or more other camera setting controls are displayed and/or one or more of the same camera setting controls in response to detecting upward swipe input 650w while computer system 600 is operating in a different camera mode. At FIG. 6X, computer system 600 detects tap input 650x1 on media-processing style control 688b.

As illustrated in FIG. 6Y, in response to detecting tap input 650x1, computer system 600 displays raw capture control 602e as being inactive (and/or the computer system is configured to capture non-raw media and not configured to capture raw media) and re-applies re-displays the camera user interface of FIG. 6L, where a portion of live preview 630 at FIG. 6R is displayed using luxe style 634c (e.g., along with one or more other portions of live preview 630 being displayed with other media-processing style) and luxe style control 626c is displayed. In some embodiments, in response to detecting tap input 650x1, computer system 600 re-displays the camera user interface of FIG. 6R, where live preview 630 at FIG. 6R is displayed using luxe style 634c. In some embodiments in response to detecting tap input 650x2 on raw capture control 602e in FIG. 6X, computer system 600 re-displays the camera user interface of FIG. 6L or re-displays the camera user interface of FIG. 6R. In some embodiments, in response to detecting tap input 650x2 on raw capture control 602e in FIG. 6X, computer system 600 displays raw capture control 602e as being inactive (and/or the computer system is configured to capture non-raw media and not configured to capture raw media) while not applying a media-processing style to a portion of live preview 630 (e.g., continuing to display of live preview 630 of FIG. 6X without a media-processing style applied).

FIGS. 7A-7X illustrate exemplary user interfaces for editing media-processing styles using a computer system in accordance with some embodiments. The user interfaces in these figures are used to illustrate the processes described below, including the processes in FIGS. 9 and 10A-10B.

FIG. 7A illustrates computer system 600 displaying a camera user interface (e.g., using one or more techniques as described above in relation to FIG. 6C). In particular, computer system 600 is displaying media-processing styles indicator 602b in an active state, the middle section using standard style 634a, and the right section and the left section without using the media-processing style (e.g., using one or more techniques as described above in relation to FIG. 6C). Moreover, computer system 600 is displaying the right section with visual element 660b, paging dots 638 with standard paging dot 638a being selected, and standard style control 626a that includes control 628, tone parameter control 626a1, and warmth parameter control 626a2 (e.g., using one or more techniques as described above in relation to FIG. 6C). As illustrated in FIG. 7A, computer system 600 also is displaying tone parameter control 626a1 includes tone parameter identifier 626a1a, current tone value 626a1b, and tone value range indicator 626a1c, and warmth parameter control 626a2 includes warmth parameter identifier 626a2a, current warmth value 626a2b, and warmth value range indicator 626a2c (e.g., using one or more techniques as described above in relation to FIG. 6C). At FIG. 7A, computer system 600 detects a portion of movement input 750a on tone parameter control 626a1.

As illustrated in FIG. 7B, in response to detecting the portion of movement input 750a at FIG. 7A (e.g., and while continuing to detect movement input 750d), computer system 600 expands tone parameter control 626a1 and ceases to display warmth parameter control 626a2. In particular at FIG. 7B, computer system 600 expands tone parameter control 626a1 and/or tone value range indicator 626a1c in-line (e.g., across a position and/or along a line in which tone parameter control 626a1 was displayed in FIG. 7B). When expanding tone parameter control 626a1, computer system 600 increases the size of tone value range indicator 626a1c, such that the tick marks of tone value range indicator 626a1c of FIG. 7B are larger and further apart than the tick marks of tone value range indicator 626a1c of FIG. 7A. Moreover, the tick marks of tone value range indicator 626a1c of FIG. 7B represents more values than the tick marks of tone value range indicator 626a1c of FIG. 7A (e.g., tone value range indicator 626a1c of FIG. 7B has more tick marks than tone value range indicator 626a1c of FIG. 7A). In other words, in response to detecting the portion of movement input 750a at FIG. 7A, computer system 600 zooms into tone parameter control 626a1 and/or tone value range indicator 626a1c (which, in some embodiments, makes it easier for a user to change a value of tone parameter control 626a1). As illustrated in FIG. 7B, in response to detecting the portion of movement input 750a at FIG. 7A, computer system 600 displays current tone value 626a1b (e.g., “0”) of FIG. 7B at a different position on the display than current tone value 626a1b of FIG. 7A was displayed. Although computer system 600 has moved current tone value 626a1b of FIG. 7B, computer system 600 continues to display current tone value 626a1b of FIG. 7B in a central position of tone value range indicator 626a1c (e.g., as current tone value 626a1b of FIG. 7A was displayed). Moreover, in response to detecting the portion of movement input 750a at FIG. 7A, computer system 600 moves tone parameter identifier 626a1a to the right side of control region 606. At FIG. 7B, computer system 600 detects another portion of movement input 750a on tone value range indicator 626a1c (e.g., while continuing to detect movement 750a). Computer system 600 detects the portion of movement input 750 in a leftward direction. In some embodiments, the portion of movement input 750a detected at FIG. 7A is a tap input, and the portion of movement input 750a detected at FIG. 7B is a movement input (e.g., in some embodiments, a user can tap to expand the control and, then, provide an input to adjust the current value for the parameter of the control). In some embodiments, the portion of movement input 750a detected at FIG. 7A and the portion of movement input 750a detected at FIG. 7B are separate inputs that are independently detected. In some embodiments, in response to the portion of movement input 750a (e.g., tap input) detected at FIG. 7A being received, computer system 600 expands tone parameter control 626a1, irrespective of whether the portion of movement input 750a detected at FIG. 7A continues to be detected. In some embodiments, in response to detecting the portion of movement input 750a that is a tap input, computer system 600 expands tone parameter control 626a1, and if no additional inputs are detected on the expanded tone parameter control 626a1 and/or on the camera user interface within a threshold period of time (e.g., 5, 20, 30, 40, 75 seconds) re-displays warmth parameter control 626b1.

As illustrated in FIG. 7C, in response to detecting the portion of movement input 750a at FIG. 7B (e.g., that is moving in the leftward direction), computer system 600 moves the tick marks of tone value range indicator 626a1c to the left (e.g., based on the magnitude of movement input 750a detected at FIG. 7B) and updates current tone value 626a1b from “0” (e.g., in FIG. 7B) to “100” (e.g., in FIG. 7C). While updating current tone value 626a1b from “0” (e.g., in FIG. 7B) to “100” (e.g., in FIG. 7C) based on a movement characteristic (e.g., speed, acceleration, and/or velocity) of the portion of movement input 750a detected at FIG. 7B (e.g., that is moving in the leftward direction), computer system 600 updates the appearance of media-processing styles indicator 602b. At FIG. 7C, computer system 600 updates the appearance of media-processing styles indicator 602b by increasing the size of a line in a clockwise direction around the perimeter of media-processing styles indicator 602b based on a movement characteristic of the portion of movement input 750a detected at FIG. 7B. Notably, although the current value (e.g., “100”) is the maximum value at which the tone parameter can be set, computer system 600 the line does not completely surround the perimeter of media-processing styles indicator 602b. The line does not completely surround the perimeter of media-processing styles indicator 602b (e.g., is displayed with a gap near the top portion of the perimeter of media processing styles indicator 602b) to show that the line has traveled around media-processing styles indicator 602b in the clockwise direction (e.g., to denote a positive value) while the tone parameter is set to the maximum value. In some embodiments, when the current value of the tone parameter is set to the minimum value of the tone parameter (e.g., “−100”), computer system 600 displays a gap on the other side of the top portion of media processing styles indicator 602b (e.g., vertical line showing start of line would be connected to the left portion of the line in FIG. 7C and a gap would be between the vertical line and the right portion of the line in FIG. 7C) to show that the line has traveled around media-processing styles indicator 602b in the counter-clockwise direction (e.g., to denote a negative value value) while the current value of the tone parameter is set to the minimum value of the tone parameter.

In addition to updating current tone value 626a1b and media processing styles indicator 602b, computer system 600 replaces standard style identifier 636a with custom standard style identifier 636aa and adds custom standard paging dot 638aa to the left of standard paging dot 638a in paging dots 638. In other words, at FIG. 7C, computer system 600 adds a custom version of standard style 634a to the set of available styles in response to updating current tone value 626a1b from the default value (“0”) to the modified value (“100”). As illustrated in FIG. 7C, standard style identifier 636aa includes the words “RICH CONTRAST” because current tone value 626a1b at FIG. 7C is greater than the default tone value (“0” in FIG. 7B) of standard style 634a. Thus, computer system 600 can determine a name of a custom media-processing style based on how a parameter for a custom media-processing style differs from a default parameter of a media-processing style. Accordingly, at FIG. 7C, computer system 600 does not update the default value of the tone parameter of standard style 634a (e.g., as shown in FIG. 7C) but, instead, creates a modified version of standard style 634a with the updated value. Thus, in some embodiments, a user can access the modified version of standard style 634a (e.g., custom standard style 634aa) at a later time.

As illustrated in FIG. 7C, in response to detecting the portion of movement input 750a at FIG. 7B, computer system 600 updates the middle section of live preview 630, such that the middle section is displayed using custom standard style 634aa in FIG. 7C instead of using standard style 634a in FIG. 7B. It should be understood that computer system 600 displays custom standard style 634aa in FIG. 7C with an increased amount of tone (e.g., “100”) than the tone of standard style 634a (e.g., “0”) to reflect the change in the value of the tone parameter for the standard media-processing style. For illustrative purposes only, custom standard style 634aa (e.g., in FIG. 7C) is shown with the same pattern (e.g., horizontal lines) as standard style 634a (e.g., in FIG. 7B) to indicate that custom standard style 634aa is a modified version of standard style 634a. However, the lines of custom standard style 634aa are dotted instead of solid like the lines of standard style 634a of FIG. 7B to illustrate that custom standard style 634aa is different from standard style 634a. At FIG. 7C, computer system 600 continues to display the expanded version of tone parameter control 626a1 because computer system 600 is still detecting movement input 750a at FIG. 7C. In some embodiments, computer system 600 continues to display the expanded version of tone parameter control 626a1, irrespective of whether computer system 600 continues to detect movement input 750a at FIG. 7B. At FIG. 7C, computer system 600 detects an end (e.g., liftoff) of movement input 750a.

As illustrated in FIG. 7D, in response to detecting the end of movement input 750a, computer system 600 shrinks (e.g., reduces the size of) tone parameter control 626a1 and re-displays warmth parameter control 626a2. As illustrated in FIG. 7D, tone parameter control 626a1 and warmth parameter control 626a2 are displayed at the same position and at the same size as they were displayed in FIG. 7B. At FIG. 7D, computer system 600 displays the same version of warmth parameter control 626a2 that was displayed before movement input 750a was detected (e.g., warmth parameter control 626a2 of FIG. 7B). Thus, the display of warmth parameter identifier 626a2a, current warmth value 626a2b, and warmth value range indicator 626a2c has not changed (e.g., when comparing FIG. 7B and FIG. 7D). However, because tone parameter control 626a1 was updated in response to detecting movement input 750a, computer system 600 displays an updated version of tone parameter control 626a1, where current tone value 626a1b of FIG. 7D is different from current tone value 626a1b of FIG. 7B and tone value range indicator 626a1c of FIG. 7D is different from tone value range indicator 626a1c of FIG. 7B. Notably, at FIG. 7D, tone value range indicator 626a1c includes a set of enlarge tick marks (e.g., 5) that are representative of the current tone value 626a1b (e.g., “100”) as it relates to the scale of tone value range indicator 626a1c (e.g., all tick marks to the right of the center tick marks are enlarged and completely filled in to denote that “100” is a value that occupies 100% of a range (e.g., 0-100) above zero on the scale of tone value range indication 626a1c). Looking back at FIG. 7B, tone value range indicator 626a1c did not include any enlarged and/or filled-in tick marks because current tone value 626a1b of FIG. 7B was “0” and was not a value that occupied any range below or above zero on the scale of tone value range indication 626a1c. Turning back to FIG. 7D, it should be understood that tone parameter control 626a1 and warmth parameter control 626a2 are representative of the current values (e.g., 626a1b, 626a2b) for each respective parameter for custom standard style 634aa (e.g., as indicated by custom standard style identifier 636aa remaining displayed). Thus, one or more controls for a media-processing style can also be used to adjust one or more parameters for modified versions of the media-processing style.

As illustrated in FIG. 7D, in response to detecting the end of movement input 750a, computer system 600 displays reset control 722. Here, computer system displays reset control 722 because a value of a parameter of a media-processing style is not the default value of the media-processing style (e.g., because current tone value 626a1b has been changed from the default value of “0” for standard style 634a to “100”). At FIG. 7D, computer system 600 detects a portion of movement input 750d on warmth parameter control 626a2.

As illustrated in FIG. 7E, in response to detecting the portion of movement input 750d at FIG. 7D, computer system 600 ceases to display tone parameter control 626a1 and expands warmth parameter control 626a2 (e.g., using one or more techniques as described above in relation to expanding tone parameter control 626a1 in FIGS. 7B-7C). In particular at FIG. 7E, computer system 600 expands warmth parameter control 626a2 and/or warmth value range indicator 626a2c in-line. When expanding warmth parameter control 626a2, computer system 600 increases the size of warmth value range indicator 626a2c, such that the tick marks of warmth value range indicator 626a2c of FIG. 7E are larger and further apart than the tick marks of warmth value range indicator 626a2c of FIG. 7A. Moreover, the tick marks of warmth value range indicator 626a2c of FIG. 7E represents more values than the tick marks of warmth value range indicator 626a2c of FIG. 7A (e.g., warmth value range indicator 626a2c of FIG. 7E has more tick marks than warmth value range indicator 626a2c of FIG. 7A). In other words, in response to detecting the portion of movement input 750d at FIG. 7D, computer system 600 zooms into warmth parameter control 626a2 and/or warmth value range indicator 626a2c (which, in some embodiments, makes it easier for a user to change a value of warmth parameter control 626a2). As illustrated in FIG. 7E, in response to detecting movement input 750d at FIG. 7D, computer system 600 displays current warmth value 626a2b (e.g., “0”) of FIG. 7E at a different position on the display than current warmth value 626a2b of FIG. 7A was displayed. Although computer system 600 has moved current warmth value 626a2b of FIG. 7E, computer system 600 continues to display current warmth value 626a2b of FIG. 7E in a central position of warmth value range indicator 626a2c (e.g., as current warmth value 626a2b of FIG. 7A was displayed). Moreover, in response to detecting movement input 750d, computer system 600 moves warmth parameter identifier 626a2a to the right side of computer system 600. At FIG. 7E, computer system 600 detects another portion of movement input 750d on warmth value range indicator 626a2c in a rightward direction (e.g., while continuing to detect movement 750d).

As illustrated in FIG. 7F, in response to detecting the portion of movement input 750d at FIG. 7E (e.g., that is moving in the rightward direction), computer system 600 moves the tick marks of warmth value range indicator 626a2c to the right (e.g., based on the magnitude of movement input 750d detected at FIG. 7E) and updates current warmth value 626a2b from “0” (e.g., in FIG. 7E) to “−75” (e.g., in FIG. 7F). As illustrated in FIG. 7F, in response to detecting the portion of movement input 750d at FIG. 7E, computer system 600 updates the appearance of media-processing styles indicator 602b by changing the color of media-processing styles indicator 602b (e.g., using one or more techniques as discussed above in relation to FIG. 6L). At FIG. 7F, computer system 600 increases the amount of light grey in the color of media-processing styles indicator 602b based on the movement of the portion of movement input 750d at FIG. 7E. Here, computer system 600 increases the amount of light grey (e.g., as opposed to increasing the amount of dark gray as discussed above in relation to FIG. 6L) because the current value of the warmth control has been decreased. As illustrated in FIG. 7F, computer system 600 continues to display custom standard style identifier 636aa and the middle section that is displayed using custom standard style 634aa. At FIG. 7F, computer system 600 continues to display custom standard style identifier 636aa. However, at FIG. 7F, computer system 600 updates custom standard style identifier 636aa to include the words, “RICH CONTRAST COOL” instead of “RICH CONTRAST. Here, “COOL” is added to custom standard style identifier 636aa because the current value of the warmth parameter was decreased in response detecting the portion of movement input 750d at FIG. 7E and/or the current value of the warmth parameter (e.g., “−75”) is less than the default value of the warmth parameter for standard style 634a (e.g., from which custom standard style 634aa was created). At FIG. 7F, computer system 600 continues to display custom standard style identifier 636aa because computer system 600 has edited the parameter of custom standard style identifier 636aa instead of adding a new custom standard media-processing style (e.g., a custom standard media-processing style that is different from custom standard style 634aa shown in FIG. 7E) to the set of available styles. Thus, at FIG. 7F, the number of the set of available styles (e.g., as indicated by paging dots 638) have remained the same, although current warmth value 626a2b has been changed from the default value for standard style 634a (e.g., shown in FIG. 6B). When displaying the middle section using custom standard style 634aa, computer system 600 updates the middle section to reflect the change in warmth and/or the change in the value of the warmth parameter for the custom-standard-media-processing style. For illustrative purposes only, custom standard style 634aa (e.g., in FIG. 7F) is shown with the same pattern (e.g., horizontal lines) as standard style 634a (e.g., in FIG. 7B) to indicate that custom standard style 634aa is a modified version of standard style 634a. However, the lines (e.g., dashed) of custom standard style 634aa of FIG. 7F are different from the lines (e.g., solid) of standard style 634a of FIG. 7B and the lines (e.g., dotted) of custom standard style 634aa of FIG. 7E to illustrate that custom standard style 634aa of FIG. 7F is different from standard style 634a of FIG. 7B and custom standard style 634aa of FIG. 7E. In some embodiments, in response to detecting the portion of movement input 750d at FIG. 7E, computer system 600 does not update custom standard style 634aa of FIG. 7E and adds an additional custom standard media-processing style. In some embodiment, when displaying the additional custom standard media-processing style, computer system 600 displays a paging dot for the additional custom standard media-processing style to the left and/or right of custom standard paging dot 638aa and replaces custom standard style identifier 636aa with a style identifier for the additional custom standard media-processing style. In some embodiments, computer system 600 adds the additional custom standard media-processing style in the set of available styles at a position that is adjacent to one or more of the standard media-processing styles and/or groups the additional custom standard media-processing style together with the other standard media-processing styles. At FIG. 7F, computer system 600 detects an end of movement input 750d on warmth value range indicator 626a2c.

As illustrated in FIG. 7G, in response to detecting the end of movement input 750d, computer system 600 re-displays tone parameter control 626a1 and shrinks warmth parameter control 626a2 (e.g., using one or more techniques discussed above in relation to FIG. 7D). Because warmth parameter control 626a2 was updated in response to detecting movement input 750d, computer system 600 displays an updated version of warmth parameter control 626a2, where current warmth value 626a2b of FIG. 7G is different from current warmth value 626a2b of FIG. 7D and warmth value range indicator 626a2c of FIG. 7G is different from warmth value range indicator 626a2c of FIG. 7D. Notably, at FIG. 7G, warmth value range indicator 626a2c includes a set of enlarge tick marks (e.g., 4) that are representative of the current warmth value 626a2b (e.g., “−75”) as it relates to the scale of warmth value range indicator 626a2c (e.g., 75% of the tick marks to the left (e.g., because current warmth value 626a2b is a negative value) of the center tick marks are enlarged and filled in to denote that “−75” is a value that occupies 75% of a range (e.g., −100-0) below zero on the scale of warmth value range indication 626a2c). In some embodiments, in response to detecting an input (e.g., a tap gesture) on shutter control 610 at FIG. 7G, computer system 600 captures media and applies custom standard style 634aa of FIG. 7G (and not standard style 634a) to the media (e.g., when displaying a representation of media). At FIG. 7G, computer system 600 detects a portion of movement input 750g on warmth parameter control 626a2.

As illustrated in FIG. 7H, in response to detecting the portion of movement input 750g at FIG. 7G, computer system 600 ceases to display tone parameter control 626a1 and expands warmth parameter control 626a2 (e.g., using one or more techniques as described above in relation to expanding tone parameter control 626a1 in FIG. 7D). At FIG. 7H, computer system 600 detects another portion of movement input 750g on warmth parameter control 626a2 in the leftward direction.

As illustrated in FIG. 7I, in response to detecting the portion of movement input 750g at FIG. 7H (e.g., that is moving in the leftward direction), computer system 600 moves the tick marks of warmth value range indicator 626a2c to the left (e.g., based on the magnitude of the portion of movement input 750g detected at FIG. 7H) and updates current warmth value 626a2b from “−75” (e.g., in FIG. 7H) to “0” (e.g., in FIG. 7I). As illustrated in FIG. 7I, computer system 600 displays the middle section using custom standard style 634aa, custom standard style identifier 636aa, and media-processing styles indicator 602b of FIG. 7I (e.g., “dotted lines of FIG. 7I”) in the same way that computer system 600 displays the middle using custom standard style 634aa″), custom standard style identifier 636aa, and media-processing styles indicator 602b of FIG. 7D (e.g., “dotted lines of FIG. 7D”). At FIGS. 7D and 7I, computer system 600 displays the middle section, custom standard style identifier 636aa, and media-processing styles indicator 602b the same way because current warmth value 626a2b of FIG. 7I is the same value of current warmth value 626a2b of FIG. 7D and current tone value 626a2b at FIG. 7I (e.g., as shown in FIG. 7J) is the same as current tone value 626a2b of FIG. 7D. At FIG. 7I, computer system 600 detects an end of movement input 750g on warmth value range indicator 626a2c.

As illustrated in FIG. 7I, in response to detecting the end of movement input 750g, computer system 600 re-displays tone parameter control 626a1 and shrinks warmth parameter control 626a2 (e.g., using one or more techniques discussed above in relation to FIGS. 7D and 7I). In some embodiments, in response to detecting an input (e.g., a tap gesture) on shutter control 610 at FIG. 7I, computer system 600 captures media and applies custom standard style 634aa of FIG. 7I (and not standard style 634a and/or custom standard style 634aa of FIG. 7H) to the media (e.g., when displaying a representation of media). At FIG. 7J, computer system 600 detects movement input 750j on live preview 630 in a leftward direction.

As illustrated in FIG. 7K, in response to detecting movement input 750j, computer system 600 translates the available sets of media-processing styles to the left and displays the middle section using standard style 634a, the right section using custom standard style 634aa, and the left section using vibrant style 634b (e.g., using one or more techniques as described above in relation to detecting movement input 650d in FIGS. 6E-6I). Notably, at FIG. 7K, computer system 600 displays the middle section using standard style 634a because standard style 634a is positioned after custom standard style 634aa in the set of available media-processing styles (e.g., which computer system 600 previously displayed the middle section using in FIG. 7I). Likewise, computer system 600 displays the right section using vibrant style 634b because vibrant style 634b is positioned after standard style 634a in the set of available media-processing styles. Thus, at FIGS. 71 and 7K, an input can be detected on a custom media-processing style to display a portion of live preview 630 using other media-processing styles in the set of available media-processing styles. As illustrated in FIG. 7K, in response to detecting movement input 750j, computer system 600 replaces custom standard style identifier 636aa of FIG. 7J with standard style identifier 636aa. Moreover, in response to detecting movement input 750j, computer system 600 updates standard style control 626a, such that current tone value 626b1b is set to the default value (e.g., “0”) for standard style 634a and current tone warmth 626b2b is set to the default value (e.g., “0”) for standard style 634a (e.g., as ceases to display the respective current values for custom standard style 634aa). At FIG. 7K, computer system 600 also ceases to display reset control 722 because the current values (e.g., current tone value 626b1b and current warmth value 626b2b are “0”) for standard style 634a are displayed (e.g., the default values for standard style 634a are displayed). In some embodiments, in response to detecting a movement input in the rightward direction, computer system 600 re-displays the middle section using custom standard style 634aa. At FIG. 7K, computer system 600 detects a portion of movement input 750k on tone value range indicator 626a1c.

As illustrated in FIG. 7L, in response to detecting the portion of movement input 750k at FIG. 7K (e.g., while standard style 634a is selected and/or the middle section is displayed using standard style 634a), computer system 600 expands tone parameter control 626a1 and ceases to display warmth parameter control 626a2 (e.g., using one or more techniques as described above in relation to FIG. 7B). At FIG. 7L, computer system 600 detects another portion of movement input 750k on tone value range indicator 626a1c in a leftward direction.

As illustrated in FIG. 7M, in response to detecting the portion of movement input 750k at FIG. 7L, computer system 600 moves the tick marks of tone value range indicator 626a1c to the left (e.g., based on the magnitude of movement input 750k detected at FIG. 7L) and updates current tone value 626a1b from “0” (e.g., in FIG. 7L) to “50” (e.g., in FIG. 7M) (e.g., using one or more techniques as described above in relation to FIG. 7C). In addition to updating current tone value 626a1b, computer system 600 replaces standard style identifier 636a with custom standard style identifier 636aa, displays custom standard paging dot 638aa as being selected, and displays standard paging dot 638a as being unselected. Notably, at FIG. 7M, computer system 600 updates the current value for the tone parameter for custom standard style 634aa and does not update the current value for the tone parameter for standard style 634a. Thus, at FIG. 7M, computer system 600 does not change how standard style 634a is defined (and/or changes the current values for standard style 634a). At FIG. 7M, in response to detecting the portion of movement input 750k at FIG. 7L, computer system 600 displays the middle section using custom standard style 634aa. Custom standard style 634aa of FIG. 7C has a decreased amount of tone (e.g., because current tone value 626a1b of FIG. 7M is lower than the previous value of current tone value 626a1b shown in FIG. 7J). For illustrative purposes only, the lines (e.g., crossed) of custom standard style 634aa of FIG. 7M is different from the lines (e.g., dotted) of custom standard style 634aa of FIG. 7J to show that one or more parameters for custom standard style 634aa have changed.

As illustrated in FIG. 7M, in response to detecting the portion of movement input 750k at FIG. 7L, computer system 600 updates the appearance of media-processing styles indicator 602b based on the current value (e.g., “50”) of the tone parameter in FIG. 7M. Thus, using one more techniques as discussed above in relation to FIG. 6L, the line around the perimeter of media-processing styles indicator 602b is updated to be around roughly half of the perimeter of media-processing styles indicator 602b. As illustrated in FIG. 7M, custom standard style identifier 636aa includes the words “RICH CONTRAST” for similar reasons as described above in relation to custom standard style identifier 636aa of FIG. 7D. When comparing FIGS. 7D and 7M, computer system 600 displays custom standard style identifier 636aa with the same words (“RICH CONTRAST’) although the current value of tone parameter of FIG. 7D was higher than the current value of the tone parameter of FIG. 7M. In some embodiments, computer system 600 displays custom standard style identifier 636aa of FIG. 7M that includes the words “RICHER” instead of “RICH” (e.g., because the current value of the current value of tone parameter of FIG. 7D is higher than the current value of the tone parameter of FIG. 7M and/or the current value of the current value of tone parameter of FIG. 7D is higher than a default value of the tone parameter over a certain amount (e.g., “75”)). In some embodiments, computer system 600 displays custom standard style identifier 636aa with the word “SOFT” and/or “SOFTER” when a current value of the tone parameter is less than the default value. At FIG. 7M, computer system 600 detects an end of movement input 750k on tone value range indicator 626a1c.

As illustrated in FIG. 7N, in response to detecting the end of movement input 750k, computer system 600, shrinks tone parameter control 626a1 and re-displays warmth parameter control 626a2. Here, tone parameter control 626a1 and warmth parameter control 626a2 indicate that the current values of the tone parameter and the warmth parameter for custom standard style 634aa (e.g., current tone value 626a1b being “50” and current warmth value 626a2b being “0”) (e.g., because the custom standard style 634aa was selected and/or the middle section was displayed using custom standard style 634aa in response to detecting movement input 750k). At FIG. 7N, computer system 600 detects movement input 750n on tone value range indicator 626a1c.

As illustrated in FIG. 7O, in response to detecting movement input 750n at FIG. 7N (e.g., while custom standard style 634aa is selected and/or the middle section is displayed using custom standard style 634aa), computer system 600 expands tone parameter control 626a1 and ceases to display warmth parameter control 626a2 (e.g., using one or more techniques as described above in relation to FIG. 7B). At FIG. 7O, computer system 600 detects another portion of movement input 750n on tone value range indicator 626a1c in a rightward direction.

As illustrated in FIG. 7P, in response to detecting the portion of movement input 750n at FIG. 7O, computer system 600 moves the tick marks of tone value range indicator 626a1c to the right (e.g., based on the magnitude of movement input 750n detected at FIG. 7O) and updates current tone value 626a1b from “50” (e.g., in FIG. 7O) to “0” (e.g., in FIG. 7P) (e.g., using one or more techniques as described above in relation to FIG. 7C). In addition to updating tone value 626a1b, computer system 600 removes custom standard style 634aa from the set of available media-processing styles. Computer system 600 removes custom standard style 634aa from the set of available media-processing styles because current tone value 626a1b and current warmth value 626a2b were both set to their respective default values for the standard media-processing style. Moreover, computer system 600 replaces custom standard style identifier 636aa with standard style identifier 636a and removes custom standard paging dot 638aa from paging dots 638 because custom standard style 634aa has been removed from the set of available media-processing styles. Accordingly, while displaying standard style identifier 636a, computer system 600 displays the middle section using standard style 634a. Thus, computer system 600 can remove a custom media-processing style when a custom media-processing for a respective media-processing style is reset to the default values for (e.g., and/or no longer different from) one or more of the media-processing style in the available sets of media-processing styles. In some embodiments, in response to detecting the portion of movement input 750n at FIG. 7O, computer system 600 updates the tone parameter for custom standard style 634aa and does not remove custom standard style 634aa from the set of available media-processing styles. At FIG. 7P, computer system 600 detects an end of movement input 750n on tone value range indicator 626a1c.

As illustrated in FIG. 7Q, in response to detecting the end of movement input 750n, computer system 600 shrinks tone parameter control 626a1 and re-displays warmth parameter control 626a2 (e.g., using one or more techniques as discussed above in relation to FIGS. 7A and 7C). At FIG. 7Q, computer system 600 detects movement input 750q on live preview 630.

As illustrated in FIG. 7R, in response to detecting movement input 750q, computer system 600 translates the available sets of media-processing styles to the left and displays the middle section using vintage style 634d and the left section using luxe style 634c (e.g., using one or more techniques as described above in relation to detecting movement input 650d in FIGS. 6E-6I). Computer system 600 displays the right section without using a media-processing style because vintage style 634d is the last media-processing style (e.g., last to the right) in the set of available media-processing styles. As illustrated in FIG. 7R, in response to detecting movement input 750q, computer system 600 replaces standard style identifier 636a of FIG. 7Q with vintage style identifier 636d. Moreover, in response to detecting movement input 750q, computer system 600 replaces standard style control 626a with vintage style control 626d. Vintage style control 626d includes tone parameter control 626d1 and warmth parameter control 626d2, where current tone value 626d1b (e.g., “10”) and current warmth value 626d2b (e.g., “50”) are default values for each respective parameter for vintage style 634d (e.g., which are different from the default values for other media-processing styles in the set of available media-processing styles). At FIG. 7R, computer system 600 detects tap input 750r on warmth parameter control 626d2.

As illustrated in FIG. 7S, in response to detecting tap input 750r, computer system 600 expands warmth parameter control 626d2 and ceases to display tone parameter control 626d1 (e.g., using one or more similar techniques as discussed above in relation to FIG. 7B). While displaying control 628 in FIG. 7S, computer system 600 detects tap input 750s on control 628. As illustrated in FIG. 7T, in response to detecting tap input 750s, computer system shrinks warmth parameter control 626d2 and re-displays tone parameter control 626d1 (e.g., using one or more techniques as described above in relation to FIG. 7D). At FIG. 7T, computer system 600 detects a portion of movement input 750t on warmth parameter control 626d2.

As illustrated in FIG. 7U, in response to detecting a portion of movement input 750t at FIG. 7T, computer system 600 expands warmth parameter control 626d2 and ceases to display tone parameter control 626d1 (e.g., using one or more similar techniques as discussed above in relation to FIG. 7B). At FIG. 7U, computer system 600 detects another portion of movement input 750t on warmth value range indicator 626d2c in a leftward direction.

As illustrated in FIG. 7V, in response to detecting the portion of movement input 750t at FIG. 7U, computer system 600 moves the tick marks of warmth value range indicator 626d2c to the left and updates current warmth value 626d2b from “50” (e.g., in FIG. 7U) to “62” (e.g., in FIG. 7V). In addition to updating current tone value 626d1b, computer system 600 replaces vintage style identifier 636d with custom vintage style identifier 636dd and adds custom vintage paging dot 638dd to the left of vintage paging dot 638d in paging dots 638. In other words, at FIG. 7V, computer system 600 adds a custom version of vintage style 634d to the set of available styles in response to updating current tone value 626d1b from the default value (“50”) to the modified value (e.g., “62”). Accordingly, at FIG. 7V, computer system 600 does not update the default value of the tone parameter of vintage style 634d (e.g., as shown in FIG. 7X) but, instead, creates a modified version of vintage style 634d with the updated value. Thus, in some embodiments, a user can access the modified version of vintage style 634d (e.g., custom vintage style 634dd) at a later time.

As illustrated in FIG. 7V, in response to detecting the portion of movement input 750t at FIG. 7U, computer system 600 updates the middle section of live preview 630, such that the middle section is displayed using custom vintage style 634dd in FIG. 7V instead of using vintage style 634d in FIG. 7U. It should be understood that computer system 600 displays custom vintage style 634dd in FIG. 7V with an increased amount of warmth (e.g., 62) than the warmth of vintage style 634d (e.g., “50”) to reflect the change in value of the warmth parameter for the vintage media-processing style. For illustrative purposes only, custom vintage style 634dd (e.g., in FIG. 7V) is shown with the same pattern (e.g., vertical lines) as vintage style 634d (e.g., in FIG. 7U) to indicate that custom vintage style 634dd is a modified version of vintage style 634d. However, the lines of custom vintage style 634dd are dotted instead of solid like the lines of vintage style 634d of FIG. 7U to illustrate that custom vintage style 634dd is different from vintage style 634d. Notably, at FIG. 7V, custom vintage style identifier 636dd (e.g., and 634dd when an input is detected) is displayed to the left of vintage style identifier 636d (e.g., and 634d) and not to the left of standard style identifier 636a (or 634a when an input is detected) (e.g., as indicated by paging dots 638). This is because custom vintage style 634dd is a modified version of vintage style 634d and not standard style 634a. Thus, in some embodiments, computer system 600 groups a custom respective media-processing style together with the non-custom (and/or non-modified) version of the respective media-processing style.

Moreover, custom vintage style identifier 636dd includes the word “WARM” because computer system 600 displays custom vintage style 634dd in FIG. 7V with an increased amount of warmth (e.g., 62) than the warmth of vintage style 634d (e.g., “50”) and/or the current value of the warmth parameter in FIG. 7V is greater than the default value of the warmth parameter for vintage style 634d. In addition, computer system 600 updates the appearance of media-processing styles indicator 602b by increasing the amount of dark gray in the color of media-processing styles indicator 602b based on movement characteristics of the portion of movement input 750t (e.g., using one or more similar techniques as described above in relation to FIGS. 6L and 7C). At FIG. 7V, computer system 600 detects an end of movement input 750t on warmth value range indicator 626d2c.

As illustrated in FIG. 7W, in response to detecting the end of movement input 750u, computer system 600 re-displays tone parameter control 626d1 and shrinks warmth parameter control 626d2 (e.g., using one or more techniques as discussed above in relation to FIG. 7G). In response to detecting the end of movement input 750t, computer system 600 also displays reset control 722. At FIG. 7W, computer system 600 detects tap input 750w on reset control 722.

As illustrated in FIG. 7W1, in response to detecting tap input 750w, computer system 600 displays prompt 768, which includes the words “reset to vintage.” Here, prompt 768 includes the words “reset to vintage” to indicate that a confirmation needs to be provided before the currently displayed style can be reset (e.g., via an input). Here, the word “vintage” indicates the media-processing style that will be applied to live preview 630 and/or the media-processing style to which the currently applied media processing style will be set in response to computer system 600 detecting confirmation input. At FIG. 7W1, computer system 600 detects tap input 750w1 on reset control 722. In some embodiments, computer system 600 detects tap input 750w1 on prompt 768 instead of reset control 722 and, in response to detecting tap input 750w1 on prompt 768 performs the functions described below with respect to detecting tap input 750w1 on reset control 722.

As illustrated in FIG. 7X, in response to detecting tap input 750w at FIG. 7W or tap input 750w1 at FIG. 7W1, computer system 600 removes custom vintage style 634dd from the set of available media-processing styles. Moreover, computer system 600 replaces custom vintage style identifier 636dd with vintage style identifier 636d and removes custom vintage paging dot 638dd from paging dots 638 because custom vintage style 634dd has been removed from the set of available media-processing styles. Accordingly, while displaying vintage style identifier 636d, computer system 600 displays the middle section using vintage style 634d. Thus, computer system 600 can remove a custom media-processing style when a custom media-processing for a respective media-processing style is reset to the default values for (e.g., and/or no longer different from) one or more of the media-processing style in the available sets of media-processing styles. In some embodiments, in response to detecting tap input 750w at FIG. 7W or tap input 750w1 at FIG. 7W1, computer system 600 resets the parameters for the custom vintage media-processing style and does not remove the custom vintage media-processing style from the set of available media-processing styles.

As shown above in FIGS. 7A-7X, computer system 600 displays a custom style identifier (e.g., custom standard style identifier 634aa and/or custom vintage style identifier 636dd) using words (and/or symbols and/or numbers) that are based on one or more current values of one or more parameters. In some embodiments, when the current value of the tone parameter is above a median value and/or a default value (e.g., “0”) (e.g., and/or a range of values that includes the median value and/or default value), the custom style identifier can include a first word, such as “rich.” In some embodiments, when the current value of the tone parameter is below the median value, the custom the custom style identifier can include a second word, such as “soft” that is different from (e.g., opposite from and/or an antonym of) the first word. In some embodiments, when the current value of the warmth parameter is above the median value (e.g., “0”), the custom style identifier can include a third word (e.g., that is different from the first word and the second word), such as the word “warm.” In some embodiments, when the current value of the warmth parameter is below the median value (e.g., “0”), the custom style identifier can include a fourth word (e.g., that is different from the first word, second word, and third word), such as the word “cool.” In some embodiments, the third word is opposite from and/or an antonym of the fourth word. Thus, in some embodiments, the custom style identifier can be combination of words that are indicative of the current value for multiple parameters, such as “rich-warm,” “rich-cool,” “soft-warm,” or “soft cool.” In some embodiments, when the current values of both parameters are set to the median value, the custom style identifier can include a word, such as “standard.” In some embodiments, when the current value for one of the parameters is set to the median value and the current value for another parameter is not set to the median value, the custom style identifier includes a word that is indicative of the parameter that is not currently set to the median value but does not include a word that is indicative of the parameter that is currently set to the median value, such as “rich” or “soft” if the tone parameter is not currently set to the median value and the warmth parameter is set to the median value; or “warmth” or “cool” if the warmth parameter is not currently set to the median value and the tone parameter is set to the median value. In some embodiments, a customer style identifier can include one or more words for one or more other parameters (e.g., a third parameter, a fourth parameter, a fifth parameter, etc.). Thus, when there is a third parameter (or a fourth parameter or a fifth parameter) for a media-processing style, the custom style identifier can include a different word based on the current value of the third parameter (along with the words for the first parameter and/or the second parameters (and the third parameter and/or the fourth parameter)) based on whether the third parameter is above/below a median value, such as “bright” (e.g., above the median value) or “dull” (e.g., below the median value) for a brightness parameter. In some embodiments, the custom style identifier can include a word to identify a media-processing style with a particular value for the tone parameter and a particular value for the warmth parameter, such as “vibrant” having a default tone value of “80” and a default warm value of “0” (e.g., as discussed above in relation vibrant style 634b of FIG. 6H) (e.g., same for the particular default values for the parameters for “luxe” and/or “vintage” discussed above). In some embodiments, the custom style identifier can include one or more additional words based on whether the current value for a parameter is above/below the default value for a particular media-processing style, such as “vibrant-cool” when the current value for the parameter value is below “0”, “vibrant-warm” when the current value for the warm parameter is above “0”, “vibrant-soft” when the current value for the tone parameter is below “80”, “vibrant-rich” when the current value for the tone parameter is above “80,” or a combination thereof (e.g., “vibrant-soft-rich”, “vibrant-soft-warm”, “vibrant-rich-warm”, or “vibrant-rich-cool”). In some embodiments, custom identifiers for other media-processing styles (e.g., luxe 634c of FIG. 6M and/or vintage 634d of FIG. 7U) can use the same paradigm discussed above in relation to vibrant style 634b. Moreover, the words used to describe the current values for the particular parameters above are merely exemplary, and one or more other words can be used in place of the words (e.g., “warm,” “cool”, “soft”, “rich”, “dull”, “bright”, “standard”, “luxe”, “vibrant,” and/or “vintage”) discussed above.

FIGS. 8A-8C illustrate exemplary user interfaces for selecting media-processing styles using a computer system in accordance with some embodiments. The user interfaces in these figures are used to illustrate the processes described below, including the processes in FIGS. 9 and 10A-10B.

FIG. 8A illustrates computer system 600 displaying a settings user interface that includes settings 844. Settings 844 include media-processing styles setting 844a. At FIG. 8A, computer system 600 detects tap input 850a on media-processing styles setting 844a. As illustrated in FIG. 8B, in response to detecting tap input 850a, computer system 600 displays media-processing styles user interface 810 that includes representation of standard style 878a and representation of vibrant style 878b. Representation of standard style 878a is a sample image (e.g., a stock image) and representation of vibrant style 878b is a sample image. Each respective sample image for the respective styles have the respective individual media-processing style applied. As illustrated in FIG. 8B, paging dots 638 indicate that there are four available styles in the set of available styles, which are standard style 634a (e.g., corresponding to standard paging dot 638a), vibrant style 634b (e.g., corresponding to vibrant paging dot 638b), luxe style 634c (e.g., corresponds to luxe paging dot 638c), and vintage style 634d (e.g., corresponding to vintage paging dot 638d) that have been previously discussed above. In some embodiments, when user interface 810 is displayed while a custom media-processing style is added to the available sets of media-processing styles, computer system 600 displays paging dots and/or a representation for the custom media-processing style.

As illustrated in FIG. 8B, user interface 810 includes area 814a that includes the default values for the parameters for the media-processing style (e.g., standard style 634a, as discussed above) that corresponds to representation of standard style 878a and selection control 816a. In some embodiments, in response to detecting an input on selection control 816a, computer system 600 sets standard style 634a (e.g., using one or more techniques discuss below in relation to FIG. 8C) as the currently selected media-processing style. At FIG. 8B, computer system 600 detects movement input 850b.

As illustrated in FIG. 8C, in response to detecting movement input 850b, computer system 600 moves the representations of media-processing styles to the left and displays the representation of vibrant style 878b in between a portion of the representation of standard style 878a and a portion of representation of luxe style 878c. Because the representation of vibrant style 878b is in a predetermined position on the display, computer system 600 replaces area 814a with 814b, which includes the default values for the parameters for vibrant style 634b (e.g., as described above). At FIG. 8C, computer system detects tap input 850c on selection control 816b In some embodiments, in response to detecting tap input 850c, computer system sets vibrant style 634b as the currently selected media-processing style. In some embodiments, while vibrant style 634b is the currently selected media-processing style, computer system 600 will use vibrant style 634b as the default media-processing style to display representations of previously captured media, display representations (e.g., live preview 630) of the FOV, and/or to capture media in the future. In some embodiments, while vibrant style 634b is the currently selected media-processing style, computer system 600 detects a request to re-display the camera user interface and, in response to detecting the request, computer system 600 displays live preview 630 in the camera user interface using the currently selected media-processing style (e.g., vibrant style 634b). In some embodiments, while displaying live preview 630 using the currently selected media-processing style, computer system 600 captures media and displays media using the currently selected media-processing style that was selected (e.g., with an input, such as tap input 850c) via user interface 810.

FIG. 9 is a flow diagram illustrating methods for selecting media-processing styles using a computer system in accordance with some embodiments. Method 900 is performed at a computer system (e.g., 100, 300, 500, 600) (e.g., a smartphone, a desktop computer, a laptop, and/or a tablet) that is in communication with a display generation component (e.g., a display controller, and/or a touch-sensitive display system) and one or more input devices (e.g., a touch-sensitive surface and/or a first camera of one or more cameras (e.g., one or more cameras (e.g., dual cameras, triple camera, quad cameras, etc.) on the same side or different sides of the computer system (e.g., a front camera and/or a back camera))). Some operations in method 900 are, optionally, combined, the orders of some operations are, optionally, changed, and some operations are, optionally, omitted.

As described below, method 900 provides an intuitive way for selecting media-processing styles using a computer system. The method reduces the cognitive burden on a user for selecting media-processing styles using a computer system, thereby creating a more efficient human-machine interface. For battery-operated computing devices, enabling a user to select media-processing styles using a computer system faster and more efficiently conserves power and increases the time between battery charges.

The computer system displays (902), via the display generation component, a style-selection user interface (e.g., a media capture user interface, a media viewing user interface, and/or a media editing user interface) that includes a representation (e.g., 630, 676a, 676b, 676c, 680c, and/or 680d) (e.g., an image) (e.g., photo media and/or video media) (e.g., live media, a live preview (e.g., media corresponding a representation of a field-of-view (e.g., a current field-of-view) of the one or more cameras that has not been stored/captured (e.g., in response to detecting a request to capture media (e.g., detecting selection of a shutter affordance (e.g., user interface object))), and/or previously captured media (e.g., media corresponding a representation of a field-of-view (e.g., a previous field-of-view) of the one or more cameras that has been captured, a media item that has been saved and is able to be accessed by a user at a later time, a representation of media that was displayed in response to receiving a gesture on a thumbnail representation of media (e.g., in a media gallery)) of media (e.g., information, data that is being captured (e.g., the media is a representation of a field of view of one or more cameras of the computer system) or that has been captured by one or more cameras of the computer system), where a first portion (e.g., a portion of middle section, the left section, and/or the right section of 630, 676a, 676b, 676c, 680c, and/or 680d) of the representation (e.g., 630, 676a, 676b, 676c, 680c, and/or 680d) and a second portion (e.g., a portion of middle section, the left section, and/or the right section of 630, 676a, 676b, 676c, 680c, and/or 680d) of the representation (e.g., 630, 676a, 676b, 676c, 680c, and/or 680d) are displayed using (e.g., according to, with) a first media-processing style (e.g., 634a-634d, 634aa, and/or 634dd) (e.g., while operating in a camera mode). In some embodiments, the first media-processing style is one of a plurality of media-processing styles (e.g., that include the second media-processing style and the third media-processing style). In some embodiments, each plurality of styles have the same set of parameters (e.g., the same type of parameters), but with different values for one or more parameters. In some embodiments, the set of parameters is a set of media processing parameters used to determine an appearance of media (e.g., color characteristics (e.g., warmth, tone, hue, brightness, saturation, shade, tint, colorfulness, coldness, and/or harmony) and/or depth parameters) that is applied to visual content of the media (e.g., that affects (e.g., portions of) the display of the representation of the media) (e.g., that changes one or more characteristics (e.g., color characteristics, depth characteristics) of a displayed representation of the media) (e.g., and displaying without using a second style that is applied to the visual content of the media). In some embodiments, the first portion and the second portion do not overlap and/or the first portion does not surround a subset of the second portion and/or the second portion does not surround a subset of the first portion. In some embodiments, the first portion and the second portion are different. In some embodiments, the media-processing style also affects the capture of media that was captured while in a media capture (e.g., camera) application.

While the first portion of the representation (e.g., a portion of middle section, and/or the left section, the right section of 630, 676a, 676b, 676c, 680c, and/or 680d) and the second portion (e.g., a portion of middle section, and/or the left section, the right section of 630, 676a, 676b, 676c, 680c, and/or 680d) of the representation are displayed using the first media-processing style (e.g., 634a-634d, 634aa, and/or 634dd), the computer system detects (904), via the one or more input devices, an input (e.g., 650d, 650k1, 650k2, 750j, and/or 750q) (e.g., a movement input/gesture (e.g., a swipe input/gesture that includes velocity at the end of the input/gesture or a drag input/gesture that causes changes based on movement during the input/gesture)) (and/or, in some embodiments, detecting a non-movement input/gesture, a tap input/gesture (e.g., single tap input/gesture, a double tap input/gesture) and/or a press-and-hold input/gesture) directed to the representation (e.g., 630, 676a, 676b, 676c, 680c, and/or 680d).

In response to detecting the input directed to the representation (e.g., 630, 676a, 676b, 676c, 680c, and/or 680d) and (and, in some embodiments, while continuing to detect the input (and while continuing to display the representation of the media)) in accordance with a determination that the input (e.g., 650d, 650k1, 650k2, 750j, and/or 750q) is in a first direction (e.g., right, left, up, down, and/or diagonal) (and in accordance with a determination that the computer system is operating in a media-processing style selection mode (e.g., a mode that enables a user to instruct the computer system to apply one or more media-processing styles to media captured by the computer system after the one or more media-processing styles are selected by the user), the computer system displays (906), via the display generation component, the first portion (e.g., a portion of middle section, the left section, and/or the right section of 630, 676a, 676b, 676c, 680c, and/or 680d) of the representation using a second media-processing style (e.g., 634a-634d, 634aa, and/or 634dd) (e.g., that is applied to visual content of the media, that affects the display of the representation of the media) (e.g., without displaying the first portion of the representation using the first media-processing style and/or the third media-processing style) (e.g., that is different from the first media-processing style) while continuing to display the second portion (e.g., a portion of middle section, the left section, and/or the right section of 630, 676a, 676b, 676c, 680c, and/or 680d) of the representation using the first media-processing style (e.g., 634a-634d, 634aa, and/or 634dd) (e.g., without displaying the second portion of the representation using the second media-processing style and/or the third media-processing style) (e.g., without displaying a visual element corresponding to the third media-processing style). In some embodiments, the input includes a component of motion in the first direction. In some embodiments, the input is not detected at a location on the style-selection user interface that corresponds to and/or of the second media-processing style and/or the input is not detected at a location on the style-selection user interface that corresponds to and/or of the first media-processing style. In some embodiments, the input is not detected at a location on the style-selection user interface that corresponds to the edge and/or border of the second media-processing style and/or the first media-processing style. In some embodiments, the input is detected at a location on the style-selection user interface that corresponds to a central location (e.g., non-border/edge) of the first media-processing style and/or the second media-processing style.

As a part of displaying, via the display generation component, the first portion of the representation using a second media-processing while continuing to display the second portion of the representation using the first media-processing style, the computer system, in response to detecting a first portion of the input (e.g., 650d, 650k1, 650k2, 750j, and/or 750q) directed to the representation, where the first portion of the input (e.g., 650d, 650k1, 650k2, 750j, and/or 750q) has a first input magnitude (e.g., a first amount of movement in a first direction from a beginning of the input), displays (908) the first portion of the representation using the second media-processing style (e.g., 634a-634d, 634aa, and/or 634dd) (e.g., without using the first media-processing style) while the second portion (e.g., a portion of middle section, the left section, and/or the right section of 630, 676a, 676b, 676c, 680c, and/or 680d) of the representation and a third portion (e.g., a portion of middle section, the left section, and/or the right section of 630, 676a, 676b, 676c, 680c, and/or 680d) of the representation that is between the first portion of the representation and the second portion of the representation are displayed using the first media-processing style (e.g., 634a-634d, 634aa, and/or 634dd) (e.g., without using the second media-processing style).

As a part of displaying, via the display generation component, the first portion of the representation using a second media-processing while continuing to display the second portion of the representation using the first media-processing style, the computer system, after displaying the first portion of the representation using the second media-processing style (e.g., 634a-634d, 634aa, and/or 634dd) while the second portion (e.g., a portion of middle section, the left section, and/or the right section of 630, 676a, 676b, 676c, 680c, and/or 680d) of the representation and the third portion (e.g., a portion of middle section, the left section, and/or the right section of 630, 676a, 676b, 676c, 680c, and/or 680d) of the representation are displayed using the first media-processing style (e.g., 634a-634d, 634aa, and/or 634dd) and in response to detecting a second portion of the input (e.g., 650d, 650k1, 650k2, 750j, and/or 750q) directed to the representation, where the second portion of the input has a second input magnitude that is greater than the first input magnitude (e.g., a second amount of movement in the first direction from a beginning of the input), displays (910) the first portion (e.g., a portion of middle section, the left section, and/or the right section of 630, 676a, 676b, 676c, 680c, and/or 680d) of the representation and the third portion (e.g., a portion of middle section, the left section, and/or the right section of 630, 676a, 676b, 676c, 680c, and/or 680d) of the representation using the second media-processing style (e.g., 634a-634d, 634aa, and/or 634dd) while the second portion (e.g., a portion of middle section, the left section, and/or the right section of 630, 676a, 676b, 676c, 680c, and/or 680d) of the representation is displayed using the first media-processing style (e.g., 634a-634d, 634aa, and/or 634dd). In some embodiments, the first portion of the representation, the second portion of the representation, and the third portion of the representation do not overlap. Displaying different portions of the representation using a respective media-processing style based on the magnitude of a portion of the input directed to the representation allows the user to control which portions of the representation that are displayed using the respective media-processing style and provides visual feedback concerning how the respective media-processing style would affect media representative of the portion of the representation that could be captured, which improves visual feedback.

In some embodiments, before detecting the input (e.g., 650d, 650k1, 650k2, 750j, 750q) (including the first portion and the second portion) directed to the representation (e.g., 630, 676a, 676b, 676c, 680c, and/or 680d), the first portion (e.g., a portion of middle section, the left section, and/or the right section of 630, 676a, 676b, 676c, 680c, and/or 680d) of the representation and the second portion (e.g., a portion of middle section, the left section, and/or the right section of 630, 676a, 676b, 676c, 680c, and/or 680d) of the representation are not displayed using the second media-processing style.

In some embodiments, the first media-processing style (e.g., 634a-634d, 634aa, and/or 634dd) is different from the second media-processing style (e.g., 634a-634d, 634aa, and/or 634dd). Displaying different portions of the representation using different respective media-processing styles based on the magnitude of a portion of the input directed to the representation allows the user to control which portions of the representation that are displayed using the different respective media-processing styles and provides visual feedback concerning how the different respective media-processing style would affect media representative of the portion of the representation that could be captured differently, which improves visual feedback.

In some embodiments, in response to detecting the first portion of the input (e.g., 650d, 650k1, 650k2, 750j, and/or 750q) directed to the representation (e.g., 630, 676a, 676b, 676c, 680c, and/or 680d), the second portion (e.g., a portion of middle section, the left section, and/or the right section of 630, 676a, 676b, 676c, 680c, and/or 680d) of the representation and the third portion (e.g., a portion of middle section, the left section, and/or the right section of 630, 676a, 676b, 676c, 680c, and/or 680d) of the representation are not displayed using the second media-processing style (e.g., 634a-634d, 634aa, and/or 634dd). In some embodiments, in response to detecting the second portion of the input, the first portion of the representation and the third portion of the representation are not displayed using the first media-processing style.

In some embodiments, an amount of the representation (e.g., 630, 676a, 676b, 676c, 680c, and/or 680d) to which the second media-processing style (e.g., 634a-634d, 634aa, and/or 634dd) (and/or the first media-processing style) is applied is based on an amount of (e.g., proportional to) movement (e.g., velocity, acceleration, and/or displacement (e.g., distance between two points (e.g., starting point of input, ending point of input)) (and, in some embodiments, direction) of the input (e.g., 650d, 650k1, 650k2, 750j, and/or 750q) directed to the representation. Displaying an amount of the representation to which the second media-processing style applied is based on an amount of movement of the input directed to the representation allows the user to control the amount of the representation to which a respective media-processing style is applied by the amount of movement of an input, which provides additional control options without cluttering the user interface.

In some embodiments, in response to detecting an end of the input (e.g., 650d, 650k1, 650k2, 750j, and/or 750q) (e.g., 650d at FIG. 6H) directed to the representation: (e.g., and while the representation is displayed using the first media-processing style and the second media-processing style) (and in accordance with a determination that the input is in the first direction), the computer system, in accordance with a determination that more than a predetermined portion of the representation (e.g., 630, 676a, 676b, 676c, 680c, and/or 680d) (e.g., 25%, 30%, 40% 50%, 60%, 75%) was displayed using the first media-processing style (e.g., 634a-634d, 634aa, and/or 634dd) (e.g., 634b in FIG. 6H) when (e.g., at the same time as, immediately before, and/or immediately after) the end of the input (e.g., 650d) directed to the representation was detected (e.g., and/or in accordance with a determination that the second media-processing style was (and/or the first media-processing style was not) being applied to a particular portion of the representation before the end of the input directed to the representation was detected), displays (e.g., snapping to the display of, abruptly and/or immediately displaying after detecting the end of the input) the first portion (e.g., the middle section) of the representation (and, optionally, the second portion of the representation) using the first media-processing style (e.g., 634a-634d, 634aa, and/or 634dd) (e.g., 634b) (e.g., without displaying the first portion, the second portion, and/or another portion of representation using the second media-processing style). In some embodiments, the predetermined portion of the representation is a greater portion of the representation that is displayed (e.g., currently displayed) using one respective media-processing style than any other portion of the representation that is displayed using another media-processing style. In some embodiments, in response to detecting an end of the input (e.g., 650d, 650k1, 650k2, 750j, and/or 750q) (e.g., 650d at FIG. 6H) directed to the representation: (e.g., and while the representation is displayed using the first media-processing style and the second media-processing style) (and in accordance with a determination that the input is in the first direction), the computer system, in accordance with a determination that less than the predetermined portion of the representation (e.g., 630) was displayed using the first media-processing style (e.g., 634a-634d, 634aa, and/or 634dd) when (e.g., at the same time as, immediately before or immediately after) the end of the input (e.g., 650d) directed to the representation was detected (e.g., and/or in accordance with a determination that the second media-processing style was not (and/or the first media-processing style was) being applied to the particular portion of the representation before the end of the input directed to the representation was detected), displays (e.g., snapping to the display of, abruptly and/or immediately displaying after detecting the end of the input) the first portion (e.g., the middle section) of the representation (e.g., 630) (and, optionally, the second portion of the representation) using the second media-processing style (e.g., 634a-634d, 634aa, and/or 634dd) (e.g., as discussed above in relation to 634a at FIG. 6I) (e.g., without displaying the first portion, the second portion, and/or another portion of representation using the first media-processing style). Automatically displaying the first portion of the representation and the second portion of the representation using a particular media-processing style when prescribed conditions are met allows the computer system to automatically select one or more media-processing styles that will be applied to the representations of media and provides visual feedback to the user regarding which media-processing style was selected to be applied to the representation of the media in response to detecting an end of the input directed to the representation, which performs an operation when a set of conditions has been met without requiring further user input and provides improved visual feedback.

In some embodiments, in response to detecting the input (e.g., 650d, 650k1, 650k2, 750j, and/or 750q) (e.g., 650k2) directed to the representation and in accordance with a determination that the input is in a second direction (e.g., right, left, up, down, and/or diagonal) (e.g., an opposite direction of the first direction) that is different from (e.g., the opposite of) the first direction, the computer system displays the second portion of the representation using a third media-processing style (e.g., 634a-634d, 634aa, and/or 634dd) (e.g., 634a) (e.g., that is applied to visual content of the media, that affects the display of the representation of the media) (e.g., without displaying the third portion of the representation using the first media-processing style and/or the second media-processing style) while continuing to display the first portion of the representation using the first media-processing style (e.g., 634a-634d, 634aa, and/or 634dd) (e.g., 634b) (e.g., without displaying the first portion of the representation using the second media-processing style and/or the third media-processing style) (e.g., without displaying a visual element (e.g., a visual element that represents and/or looks like an edge of a style, an edge of a frame) corresponding to the second media-processing style) (e.g., without displaying a visual element corresponding to the second media-processing style), where the third media-processing style is different from the first media-processing style and the second media-processing style (e.g., 634a-634d, 634aa, and/or 634dd) (e.g., 634c). In some embodiments, the input includes a component of motion in the second direction. In some embodiments, the first portion and second portion of the media do not move positions on the representation of the media (e.g., continued to be displayed in the same location). In some embodiments, the first media-processing style, the second media-processing style, and the third media-processing style have the same set of parameters (e.g., the same type of parameters (e.g., as described below in relation to method 1000 and FIGS. 7A-7X)). In some embodiments, the first media-processing style, the second media-processing style, and the third media-processing style are different because one or more values for the set of parameters for each respective media-processing style is different. In some embodiments, before detecting the input directed to the representation, the first portion includes a first object that is displayed using the first media-processing style and/or the second portion includes a second object that is displayed using the first media-processing style. In some embodiments, in response to detecting the input directed to the representation and while continuing to detect the input, in accordance with a determination that the input is in a first direction, the first object is displayed using the second media-processing style; and in accordance with a determination that the input is in a second direction, the second object is displayed using the third media-processing style and/or the first media-processing style. In some embodiments, a visual element corresponding to the second media-processing style and visual element corresponding to the third media-processing style is displayed before the input is detected. Displaying the second portion of the representation using a third media-processing style that is different from the first media-processing style and the second media-processing style in accordance with a determination that the input is in a second direction (e.g., a different that is different from the first direction) allows the user to control which portions of the representation that are displayed using a media-processing style that is different from the first media-processing style and the second media-processing style, which provides additional control options without cluttering the user interface.

In some embodiments, in response to detecting the input (e.g., 650d, 650k1, 650k2, 750j, and/or 750q) directed to the representation (e.g., 630, 676a, 676b, 676c, 680c, and/or 680d) and in accordance with a determination that the input (e.g., 650d, 650k1, 650k2, 750j, and/or 750q) is in the first direction (e.g., and in accordance with a determination that an end (e.g., lift off) of the input directed to the representation is detected (or in response to detecting an end of the input directed to the representation) and/or while the representation is displayed using the first media-processing style and the second media-processing style), the computer system displays a visual element (e.g., 660a, 660b) (e.g., that was not previously displayed before the input directed to the representation was detected) corresponding to a fourth media-processing style (e.g., 634a-634d, 634aa, and/or 634dd) (e.g., an indication, such as text and/or symbols) (e.g., a visual element, such as a user interface object (e.g., a border, outline of a shape, and/or a visual element that indicates that that the representation can be displayed using the fourth media-processing style) (e.g., without displaying the visual element corresponding to the fifth media-processing style) (e.g., while displaying the first portion of the representation and the second portion of the representation using the second media-processing style) (e.g., a visual element that represents and/or looks like an edge of a style, and/or an edge of a frame). In some embodiments, the visual element corresponding to the fourth media-processing style is displayed at a location/area (e.g., right and/or left edge, in a direction that is opposite of the first direction) of the style-selection user interface. In some embodiments, in response to detecting the input (e.g., 650d, 650k1, 650k2, 750j, and/or 750q) directed to the representation (e.g., 630, 676a, 676b, 676c, 680c, and/or 680d) and in accordance with a determination that the input (e.g., 650d, 650k1, 650k2, 750j, and/or 750q) is in a third direction (e.g., right, left, up, down, and/or diagonal) (e.g., an opposite direction of the first direction) that is different from the first direction (e.g., and in accordance with a determination that the end (e.g., lift off) of the input directed to the representation is detected (e.g., and/or while the representation is displayed using the first media-processing style and the third media-processing style (e.g., as discussed above)), the computer system displays a visual element (e.g., 660a, 660b) (e.g., that was not previously displayed before the input directed to the representation was detected) corresponding to a fifth media-processing style (e.g., 634a-634d, 634aa, and/or 634dd) (e.g., an indication, such as text and/or symbols) (e.g., a visual element, such as a user interface object (e.g., a boarder, outline of a shape, and/or a visual element that the representation can be displayed using the fourth media-processing style) (e.g., a visual element that represents and/or looks like an edge of a style, and/or an edge of a frame) that is different from the fourth media-processing style (e.g., without displaying the visual element corresponding to the fourth media-processing style) (e.g., while displaying the first portion of the representation and the second portion of the representation using the third media-processing style (e.g., as discussed above)). In some embodiments, the visual element corresponding to the fourth media-processing style is displayed at a first location (e.g., an edge of the representation of the media) on the style-selection user interface and the visual element corresponding to the fifth media-processing style is displayed at a second location (e.g., an edge of the representation of the media, an opposite of the first location) on the style-selection user interface that is different from the first location on the style-selection user interface. In some embodiments, the visual element corresponding to the fourth media-processing style and/or the visual element corresponding to the fifth media-processing style is displayed concurrently with a visual element corresponding to the first media-processing style. In some embodiments, the visual element corresponding to the fifth media-processing style is displayed at a location/area (e.g., right and/or left edge, in a direction that is opposite of the third direction) of the style-selection user interface that is different from the area/location of the style-selection user interface at which the visual element corresponding to the fifth media-processing style would be displayed. Displaying a visual element that corresponds to a respective style based on the direction of the input that is directed to the representation provides the user with visual feedback concerning a style that can be selected via an additional input directed to the representation, which provides improved visual feedback.

In some embodiments, before detecting the input (e.g., 650d, 650k1, 650k2, 750j, and/or 750q) directed to the representation (e.g., 630, 676a, 676b, 676c, 680c, and/or 680d) (and, in some embodiments, while the first portion of the representation and the second portion of the representation are displayed using the first media-processing style), the style-selection user interface includes a visual element (e.g., 660a, 660b) (e.g., a visual element that represents and/or looks like an edge of a style, and/or an edge of a frame) corresponding to the second media-processing style (e.g., 634a-634d, 634aa, and/or 634dd) and a visual element (e.g., 660a, 660b) corresponding to a sixth media-processing style (e.g., 634a-634d, 634aa, and/or 634dd) (e.g., third media-processing style (e.g., as described above in relation to method 900) (e.g., a visual element that represents and/or looks like an edge of a style, and/or an edge of a frame). In some embodiments, in response to detecting the input (e.g., 650d, 650k1, 650k2, 750j, and/or 750q) directed to the representation (e.g., in accordance with a determination that the end of the input is detected or before and after the input directed to the representation is detected) and in accordance with a determination that the input (e.g., 650d, 650k1, 650k2, 750j, and/or 750q) is in the first direction, the computer system ceases to display the visual element (e.g., 660a, 660b) corresponding to the second media-processing style without displaying the representation (e.g., any portion of the representation) using the second media-processing style (e.g., 634a-634d, 634aa, and/or 634dd) (e.g., without applying the second media-processing style to the representation of the media). In some embodiments, in response to detecting the input (e.g., 650d, 650k1, 650k2, 750j, and/or 750q) directed to the representation (e.g., in accordance with a determination that the end of the input is detected or before and after the input directed to the representation is detected) and in accordance with a determination that the input (e.g., 650d, 650k1, 650k2, 750j, and/or 750q) is in a fourth direction that is different from the first direction, the computer system ceases to display the visual element (e.g., 660a, 660b) corresponding to the sixth media-processing style without displaying the representation (e.g., 630, 676a, 676b, 676c, 680c, and/or 680d) (e.g., any portion of the representation) using the sixth media-processing style (e.g., 634a-634d, 634aa, and/or 634dd) (e.g., without applying the sixth media-processing style to the representation of the media). Ceasing to display the visual element corresponding to the second media-processing style without displaying the representation using the second media-processing style in accordance with a determination that the input is in the first direction or ceasing to display the visual element corresponding to the sixth media-processing style without displaying the representation using the sixth media-processing style in accordance with a determination that the input is in a fourth direction that is different from the first direction provides the user with visual feedback that informs the user that the respective media-processing style corresponding to the visual element that has ceased to be displayed cannot be selected by the input being provided in a particular direction and/or that the user will need to change the direction of the input in order for the respective media-processing style to be selected, which provides improved visual feedback.

In some embodiments, the input (e.g., 650d, 650k1, 650k2, 750j, and/or 750q) directed to the representation (e.g., 630, 676a, 676b, 676c, 680c, and/or 680d) is not detected at an indication (e.g., a portion of) of the second media-processing style (e.g., 634a-634d, 634aa, and/or 634dd) (e.g., a portion of the representation of the media that is displayed using the second media-processing style (and/or the third media-processing style (e.g., as discussed above in relation to method 900), an indication (e.g., one or more text/symbols), a portion of the second media-processing style, and/or visual element (e.g., border of an object) that represents the second media-processing style). Displaying different portions of the representation using a respective media-processing style in response to an input that is not detected at an indication of the second media-processing style allows the user to select a respective media-processing style via the input without the need for the user to select an object that represents the respective media-processing style and/or for the object that represents the respective media-processing style to be displayed, which can clutter the UI, which provides additional control options without cluttering the user interface.

In some embodiments, the representation of the media is a representation (e.g., 676a, 676b, 676c, 680c, and/or 680d) of previously captured media (e.g., is not a preview/view of a live camera field-of-view). In some embodiments, after detecting the input (e.g., 650d, 650kl, 650k2, 750j, and/or 750q) directed to the representation, the computer system displays an option (e.g., 816a, 816b) to use a seventh media-processing style (e.g., 634a-634d, 634aa, and/or 634dd) for media captured in response to future media capture requests (e.g., a user interface object labeled “use”). In some embodiments, while displaying the option (e.g., 816a, 816b) to use the seventh media-processing style (e.g., 634a-634d, 634aa, and/or 634dd), the computer system detects an input (e.g., 850c) (e.g., a tap input (e.g., a tap gesture) (e.g., a single tap input, a double tap input)) (and/or, in some embodiments, in response to detecting a non-tap input/gesture (e.g., a movement input/gesture, a press-and-hold input/gesture, a voice input)) directed to the option to use the seventh media-processing style (e.g., and/or to apply the seventh media-processing style to visual content of media). In some embodiments, in response to detecting the input (e.g., 850c) directed to the option to use the seventh media-processing style, the computer system configures the computer system to use the seventh media-processing style (e.g., for media captured in response to future media capture requests). In some embodiments, while the computer system (e.g., 600) is configured to use the seventh media-processing style (e.g., for media captured in response to future media capture requests), the computer system detects a request (e.g., 650a, as discussed in relation to FIGS. 8A-8C) to capture media. In some embodiments, in response to detecting the request (e.g., 650a, as discussed in relation to FIGS. 8A-8C) to capture media while the computer system is configured to use the seventh media-processing style, the computer system captures respective media. In some embodiments, after capturing the respective media (e.g., and in response to a request to display the respective media), the computer system displays a first user interface (e.g., 668) (e.g., as discussed in relation to FIGS. 8A-8C) that includes a representation (e.g., 680c, 680d) (e.g., as discussed in relation to FIGS. 8A-8C) of the respective media (e.g., previously captured media). In some embodiments, the representation of the respective media is displayed in the first user interface (e.g., that includes the representation of the respective media) using the seventh media-processing style. In some embodiments, the first user interface is displayed in response to detecting an input (e.g., a tap input (e.g., a tap gesture) (e.g., a single tap input, a double tap input)) (and/or, in some embodiments, in response to detecting a non-tap input/gesture (e.g., a movement input/gesture, a press-and-hold input/gesture, and/or a voice input)) on a media gallery user interface object and/or a thumbnail that is representative of the representation of the media using the seventh media-processing style. In some embodiments, while displaying the representation of the media using the seventh media-processing style, the computer system detects a request to display a representation of second (e.g., previously captured) media and, in response to detecting the request to display the representation of other media, the computer system displays the representation of other media using the seventh media-processing style. In some embodiments, the computer system displays the representation of other media using the seventh media-processing style, irrespective of whether the other media was captured using the seventh media-processing style. In some embodiments, the computer system displays the representation of other media using the seventh media-processing style only when the representation of the media was not captured using another media-processing style. In some embodiments, the other media was captured before the input directed to the option to use the seventh media-processing style to display one or more representations of the media was detected. Configuring the computer system to use the seventh media-processing style in response to detecting the input directed to the option to use the seventh media-processing style for media captured in response to future media capture requests allows a user to control which media-processing style(s) will be applied to one or more representations of media that will be captured in the future (and, in some embodiments, representations of previously captured media), which provides additional control options without cluttering the user interface. Displaying different portions of a representation of previously captured using respective media-processing style(s) allows the user to select a media-processing style for previously captured media by providing an input and provides visual feedback to the user concerning how the respective media-processing style(s) would affect one or more portions of the previously captured media, which provides additional control options without cluttering the user interface and provides improved visual feedback.

In some embodiments, the computer system is in communication with one or more cameras that includes the first camera. In some embodiments, the representation of the media includes a representation (e.g., 630) (e.g., a live representation, a live preview) of at least a portion of a current field-of-view of at least the first camera. In some embodiments, the representation is updated when the portion of the current field-of-view of at least the first camera changes. In some embodiments, the portion of the current field-of-view of at least the first camera changes when the computer system is moved around, one or more objects are moved into and/or out of the field-of-view of at least the first camera, and/or when other changes occur (e.g., lighting changes) in the field-of-view of at least the first camera. In some embodiments, after detecting the input (e.g., 650d, 650k1, 650k2, 750j, and/or 750q) directed to the representation, the computer system displays an option (e.g., 816a, 816b) to use an eighth media-processing style for media captured in response to future media capture requests (e.g., a user interface object labeled “use”). In some embodiments, while displaying the option to use the eighth media-processing style (e.g., 634a-634d, 634aa, and/or 634dd), the computer system detects an input (e.g., 850c) (e.g., a tap input (e.g., a tap gesture) (e.g., a single tap input, a double tap input)) (and/or, in some embodiments, in response to detecting a non-tap input/gesture (e.g., a movement input/gesture, a press-and-hold input/gesture, and/or a voice input)) directed to the option to use the eighth media-processing style (e.g., and/or to apply the eighth media-processing style to visual content of media). In some embodiments, in response to detecting the input (e.g., 850c) directed to the option to use the eighth media-processing style, the computer system configures the computer system (e.g., 600) to use the eighth media-processing style (e.g., for media captured in response to future media capture requests). In some embodiments, while the computer system (e.g., 600) is configured to use the eighth media-processing style, the computer system detects a second request (e.g., 650a, as described in relation to FIGS. 8A-8C) to capture media. In some embodiments, in response to detecting the second request (e.g., 650a, as described in relation to FIGS. 8A-8C) to capture media while the computer system is configured to use the eighth media-processing style, the computer system captures second respective media. In some embodiments, after capturing the second respective media, the computer system displays a second user interface (e.g., 668) (e.g., as discussed in relation to FIGS. 8A-8C) that includes a representation (e.g., 680c, 680d) (e.g., as described in relation to FIGS. 8A-8C) of the second respective media. In some embodiments, the representation of the second respective media (e.g., previously captured media) is displayed in the second user interface (e.g., that includes a representation of the second respective media) using the eighth media-processing style. In some embodiments, as a part of detecting the second request, the computer system detects an input (e.g., a tap input (e.g., a tap gesture) (e.g., a single tap input, a double tap input)) (and/or, in some embodiments, in response to detecting a non-tap input/gesture (e.g., a movement input/gesture, a press-and-hold input/gesture, and/or a voice input)) on a camera application icon (e.g., to open a camera application). In some embodiments, while displaying the representation of the media using the eighth media-processing style, the computer system detects a requests to close and re-open an application, and in response to detecting the requests to close and re-open the application, the computer system displays a different representation of media using the eighth media-processing style. In some embodiments, before capturing the respective media and while the computer system is configured to use the eighth media-processing style, the computer system displays a third user interface that includes a representation of media (e.g., a live preview and/or a portion of a current field-of-view of at least one camera) using the eighth media-processing style. In some embodiments, in response to detecting the second request to capture media while the computer system is configured to use the eighth media-processing style, the computer system captures third respective media. In some embodiments, after capturing the third respective media, the computer system does not display a user interface that includes a representation of the third respective media using the eighth media-processing style. Configuring the computer system to use the eighth media-processing style in response to detecting the input directed to the option to use the eighth media-processing style for media captured in response to future media capture requests allows a user to control which media-processing style(s) will be applied to one or more representations of media that will be captured in the future (and, in some embodiments, representations of previously captured media), which provides additional control options without cluttering the user interface. Displaying different portions of a representation of at least a portion of a current field-of-view of at least the first camera using respective media-processing style(s) allows the user to select a media-processing style for media that will be captured in response to receiving a request to capture the media (e.g., activation of a shutter button) by providing an input and provides visual feedback to the user concerning how the respective media-processing style(s) will be applied to one or more portions of the current field-of-view after the media corresponding to the current field-of-view is captured, which provides additional control options without cluttering the user interface and provides improved visual feedback.

In some embodiments, as a part of applying a respective media-processing style (e.g., 634a-634d, 634aa, and/or 634dd) to captured media (e.g., displaying a respective representation using a respective media-processing style), the computer system applies a first set of operations (e.g., media processing operations) to the captured media (e.g., 680b, 680c). In some embodiments, as a part of applying the respective media-processing style (e.g., 634a-634d, 634aa, and/or 634dd) to a live preview (e.g., 630) (e.g., a current field-of-view) of a portion of a field-of-view of one or more cameras (e.g., displaying a respective portion of a field-of-view of one or more cameras), the computer system applies a second set of operations (e.g., media processing operations) to the live preview (e.g., 630). In some embodiments, parameters for the media processing operations in the first set of operations and the second set of operations are selected based on the respective media-processing style. In some embodiments, the first set of operations take a longer time or greater amount of processing power to apply and the second set of operations can be applied more quickly or with a smaller amount of processing power, and using the first set of operations provides a higher quality result than using the second set of operations. In some embodiments, applying the second set of operations is a less intense (e.g., includes less operations, requires less processing resources (e.g., random access memory and/or instruction sets) process than applying the first set of operations. In some embodiments, applying the second set of operations to the live preview allows the computer system to display the live preview using the respective media-processing style with reduced latency and/or visual distortion than when the first set of operations is applied to the live preview. Applying the first set of operations to the capture media and the second set of operations to the live preview enhances the computer system's ability to provide visual feedback concerning how the respective media-processing style would affect media representative of the portion of the representation that could be captured with a less computationally intense set of operations for applying a respective media-processing style to the visual content of media, which provides improved visual feedback.

In some embodiments, while the first portion (e.g., a portion of middle section, the left section, and/or the right section of 630, 676a, 676b, 676c, 680c, and/or 680d) of the representation and the second portion (e.g., a portion of middle section, the left section, and/or the right section of 630, 676a, 676b, 676c, 680c, and/or 680d) of the representation are displayed using the first media-processing style (e.g., 634a-634d, 634aa, and/or 634dd), an identifier (e.g., 636a-636d, 636aa, and/or 636dd) (e.g., one or more symbols and/or text (e.g., “Standard”, “Vibrant”)) that corresponds to the first media-processing style is displayed. In some embodiments, the identifier is overlaid on the representation of the media. In some embodiments, the identifier is positioned above, below, to the left, to the right of, and/or overlaid on a portion of the representation of the media. Displaying an identifier that corresponds to the first media-processing style while the first portion of the representation and the second portion of the representation are displayed using the first media-processing style provides visual feedback to the user so that the user can quickly identify which media-processing style is being applied without having to determine the type of media-processing style being applied by how the media-processing style is being applied to the representation of the media, which provides improved visual feedback.

In some embodiments, as a part of displaying the first portion (e.g., a portion of middle section, the left section, and/or the right section of 630, 676a, 676b, 676c, 680c, and/or 680d) of the representation using the second media-processing style (e.g., 634a-634d, 634aa, and/or 634dd) while continuing to display the second portion (e.g., a portion of middle section, the left section, and/or the right section of 630) of the representation using the first media-processing style (e.g., 634a-634d, 634aa, and/or 634dd), the computer system displays a divider (e.g., 640) (e.g., an area and/or a portion of the representation; a visually distinct user interface object that delineates the intersection between the first and second portions) between the first portion of the representation and the second portion of the representation. In some embodiments, the divider is an area and/or a portion of the representation that does not have the first media-processing style, the second media-processing style, and/or any other media-processing style applied. In some embodiments, the divider is translucent. In some embodiments, the divider is not translucent. In some embodiments, the computer system moves the divider across the display based on the magnitude of the input directed to the representation. In some embodiments, when the divider is moved across the display (e.g., in response to detecting an input), the computer system, optionally, changes the sizes of the first portion of the representation and the second portion of the representation. In some embodiments, the first portion of the representation and the second portion of the representation are changed relatively and/or in an indirectly proportional manner (e.g., as the first portion of the representation increases in size, the second portion of the representation decreases in size (e.g., by the same amount that the first portion increased in size) (or vice-versa). Displaying a divider between the first portion of the representation and the second portion of the representation as a part of displaying the first portion of the representation using the second media-processing style while continuing to display the second portion of the representation using the first media-processing style provides visual feedback to the user so that the user can quickly identify which portion of the representation that is being displayed using the second media-processing style and/or which portion of the representation that is being displayed using the first media-processing style, which provides improved visual feedback.

In some embodiments, the input (e.g., 650d, 650k1, 650k2, 750j, and/or 750q) directed to the representation is a movement input (e.g., a swipe input/gesture that includes velocity at the end of the input/gesture or a drag input/gesture that causes changes based on movement during the input/gesture) (or, in some embodiments, is not a movement input (e.g., is a tap input, a press-and-hold input)).

In some embodiments, the computer system is in a first capture mode. In some embodiments, while displaying the style-selection user interface and while the computer system (e.g., 600) is in the first capture mode (e.g., indicative of photo mode control 620c in FIG. 6N), the computer system detects an input (e.g., 650n) (e.g., a movement input) (and/or, in some embodiments, detecting a non-movement input/gesture (e.g., a press-and-hold input/gesture, voice input, and/or a tap input)) directed to the style-selection user interface (e.g., not directed to the representation, directed to one or more camera capture mode user interface objects, at the bottom of user interface, at a different location than the location at which the input directed to the representation of the media is detected). In some embodiments, that is different from the input directed to the representation). In some embodiments, the computer system displays a camera control region that includes a plurality of selectable user interface objects for camera capture modes. In some embodiments, each camera mode (e.g., video, photo/still, portrait, slow-motion, panoramic modes) has a plurality of settings (e.g., for a portrait capture mode: a studio lighting setting, a contour lighting setting, a stage lighting setting) with multiple values (e.g., levels of light for each setting) of the mode (e.g., portrait capture mode) that a camera (e.g., a camera sensor) is operating in to capture media (including post-processing performed automatically after capture). In this way, for example, capture modes are different from modes which do not affect how the camera operates when capturing media or do not include a plurality of settings (e.g., a flash mode having one setting with multiple values (e.g., inactive, active, auto). In some embodiments, capture modes allow user to capture different types of media (e.g., photos or video) and the settings for each mode can be optimized to capture a particular type of media corresponding to a particular mode (e.g., via post processing) that has specified properties (e.g., shape (e.g., square, rectangle), speed (e.g., slow motion, time elapse), audio, video). For example, when the computer system is configured to operate in a still photo capture mode, the one or more cameras of the computer system, when activated, captures media of a first type (e.g., rectangular photos) with particular settings (e.g., flash setting, one or more filter settings); when the computer system is configured to operate in a square capture mode, the one or more cameras of the computer system, when activated, captures media of a second type (e.g., square photos) with particular settings (e.g., flash setting and one or more filters); when the computer system is configured to operate in a slow motion capture mode, the one or more cameras of the computer system, when activated, captures media that media of a third type (e.g., slow motion videos) with particular settings (e.g., flash setting, frames per second capture speed); when the computer system is configured to operate in a portrait capture mode, the one or more cameras of the computer system captures media of a fifth type (e.g., portrait photos (e.g., photos with blurred portions (e.g., background and/or foreground) and, in some embodiments, the computer system generates the photos with blurred portions by applying a synthetic depth-of-field effect to at least a portion of a field-of-view of one or more cameras of the computer system).) with particular settings (e.g., amount of a particular type of light (e.g., stage light, studio light, and/or contour light), f-stop, and/or blur) (and, in some embodiments, the particular type of light is synthetic (e.g., computer generated) (e.g., generated by the computer system using depth information of the photo and/or at least a portion of the field-of-view (e.g., current field-of-view) of one or more cameras of the computer system); and/or when the computer system is configured to operate in a panoramic capture mode, the one or more cameras of the computer system captures media of a fourth type (e.g., panoramic photos (e.g., wide photos) with particular settings (e.g., zoom and/or amount of field to view to capture with movement). In some embodiments, when switching between capture modes, the display of the representation of the field-of-view changes to correspond to the type of media that will be captured by the capture mode (e.g., the representation is rectangular while the computer system is operating in a still photo capture mode and the representation is square while the computer system is operating in a square capture mode). In some embodiments, the synthetic (e.g., computer-generated), depth-of-field effect adjusts the photo such that it appears that the photo has been captured with a camera that has a different aperture (e.g., physical aperture, effective aperture) and/or focal length (e.g., physical focal length, effective focal length) than the aperture and/or focal length of the one or more cameras that actually captured the photo. In some embodiments, in response to detecting the input directed to the style-selection user interface, the computer system transitions the computer system from being in the first capture mode to being in a different capture mode (e.g., indicative of portrait mode control 620d in FIG. 6O) (e.g., while continuing to display a representation of media using at least one media-processing style, and/or while continuing to apply the media-processing style to the visual content of the media). Transitioning the computer system from being in the first capture mode to being in a second capture mode that is different from the first capture mode in response to detecting the input directed to the style-selection user interface allows a user to control the capture mode in which the computer system operates, which provides additional control options without cluttering the user interface.

In some embodiments, after transitioning the computer system (e.g., 620) from being in the first capture mode (e.g., indicative of photo mode control 620c in FIG. 6N) to being in the different capture mode (e.g., indicative of portrait mode control 620d in FIG. 6O), the computer system detects a request to capture media. In some embodiments, in response to detecting the request to capture media, the computer system captures media with the different capture mode based on a currently selected media-processing style (e.g., 634a-634d, 634aa, and/or 634dd) (e.g., as discussed in relation to FIG. 6O), including: in accordance with a determination that the currently selected media-processing style is the first media-processing style (e.g., 634a-634d, 634aa, and/or 634dd), capturing the media in the different capture mode with the first media-processing style (e.g., as discussed in relation to FIG. 6O); and in accordance with a determination that the currently selected media-processing style is the second media-processing style (e.g., 634a-634d, 634aa, and/or 634dd), capturing the media in the different capture mode with the second media-processing style (e.g., 634a-634d, 634aa, and/or 634dd). In some embodiments, the currently selected media-processing style is applied to different media (e.g., media captured in different camera mode). In some embodiments, a representation of the currently selected media-processing style continues to be displayed when switching from a respective capture mode to a different respective capture mode.

In some embodiments, the computer system (e.g., 600) is in a third capture mode (e.g., indicated by 602c) (e.g., before and after detecting the input directed to the representation) (e.g., still camera, video, slow motion, and/or portrait) (e.g., as discussed in relation to FIGS. 8A-8C). In some embodiments, after detecting the input directed to the representation (e.g., 630), the computer system detects a request to display a second user interface that includes a second representation of media (e.g., as discussed in relation to FIGS. 6N-60). In some embodiments, in response to detecting the request to the display the second user interface that includes the second representation of media, the computer system displays the second user interface that includes the second representation (e.g., 630) of media. In some embodiments, while displaying the second user interface, the computer system detects an input (e.g., a movement input) (and/or, in some embodiments, detecting a non-movement input/gesture (e.g., a press-and-hold input/gesture, voice input, and/or a tap input)) (e.g., 650d, 650k1, 650k2, 750j, and/or 750q) (e.g., as discussed in relation to FIGS. 6N-60) directed to the second representation. In some embodiments, in response to detecting the input (e.g., 650n1, 650n2) (e.g., as discussed in relation to FIGS. 8A-8C) directed to the second representation (e.g., 630) and in accordance with a determination that the computer system is not in a first media-processing style selection mode (e.g., a mode that causes the computer system to apply one or more media-processing styles to the second representation), the computer system transitions the computer system from being in the third capture mode (e.g., indicated by 620c) to being in a fourth capture mode (e.g., indicated by 620d) (e.g., still camera, video, slow motion, and/or portrait) (e.g., without displaying a media-processing style being applied to the second representation that was not previously applied) (e.g., as discussed in relation to FIGS. 8A-8C). In some embodiments, in response to detecting the input (e.g., 650d, 650k1, 650k2, 750j, and/or 750q) (e.g., as discussed in relation to FIGS. 8A-8C) directed to the second representation (e.g., 630) and in accordance with a determination that the computer system is in the first media-processing style selection mode (e.g., as indicated by 602b), the computer system maintains the computer system in the third capture mode (e.g., indicated by 620c) (e.g., media-processing and displaying an indication that the media-processing style for capturing media has changed) (e.g., still camera, video, slow motion, and/or portrait) (e.g., forgoing transitioning the computer system from being in the fifth capture mode to being in a sixth capture mode) (e.g., as discussed in relation to FIGS. 6N-60). Choosing whether to transition the computer system from being in the third capture mode to being in a fourth capture mode or maintain the computer system in the third capture mode based on whether the computer system is in the media-processing style selection mode when prescribed are met allows the computer system to intelligently perform different operations based whether computer system is in the media-processing style selection mode, which performs an operation when a set of conditions has been met without requiring further user input.

In some embodiments, before detecting the input directed to the representation, the style-selection user interface includes a plurality of selectable user interface objects (e.g., 626a1, 626a2, 626b1, 626b2, 626c1, 626c2, 626d1, 626d2) for (e.g., editing/modifying parameters (e.g., visual characteristics (e.g., a color characteristic (e.g., warmth, tone, hue, brightness, saturation, shade, tint, colorfulness, coldness, and/or harmony)) and/or a depth parameter) of the) the first media-processing style (e.g., as described in relation to FIGS. 7A-7X and method 1000). Displaying a plurality of selectable user interface objects for the first media-processing style before detecting the input directed to the representation provides the user with visual feedback concerning the parameters that can be adjusted for how the first media-processing style is applied to visual content of media, which provides improved visual feedback.

In some embodiments, in response to detecting the input (e.g., 650d, 650k1, 650k2, 750j, and/or 750q) directed to the representation and in accordance with the determination that the input directed to the representation is in the first direction and in accordance with a determination that the second media-processing style is being applied to a fourth portion (e.g., a middle portion) (e.g., the middle section and/or a portion of middle section, the left section, and/or the right section of 630, 676a, 676b, 676c, 680c, and/or 680d) of the representation (e.g., 630) of the media (and/or in accordance with a determination that more than a predetermined portion of the representation (e.g., 25%, 30%, 40% 50%, 60%, 75%) was displayed using the second media-processing style when (e.g., at the same time as, immediately before, and/or immediately after) the end of the input directed to the representation was detected) (e.g., in response to detecting the input directed to the representation), the computer system displays a plurality of selectable user interface objects (e.g., 626a1, 626a2, 626b1, 626b2, 626c1, 626c2, 626d1, 626d2) for the second media-processing style (e.g., 634a-634d, 634aa, and/or 634dd) (e.g., user interface objects that are displayed with representations of current values for the second media-processing style that are different from the representations of current values for the first media-processing style) and ceasing to display the plurality of selectable user interface objects for the first media-processing style (e.g., 634a-634d, 634aa, and/or 634dd) (e.g., replacing display of the plurality of selectable user interface objects for the first media-processing style with display of the plurality of selectable user interface objects for the second media-processing style) (e.g., as described in relation to FIGS. 6A-6D and method 900). In some embodiments, in response to detecting the input (e.g., 650d, 650k1, 650k2, 750j, and/or 750q) directed to the representation and in accordance with the determination that the input directed to the representation is in the first direction and in accordance with a determination that the second media-processing style is not being applied to the fourth portion (e.g., a middle portion) (e.g., the middle section and/or a portion of middle section, the left section, and/or the right section of 630, 676a, 676b, 676c, 680c, and/or 680d) of the representation (e.g., 630) of the media (and/or in accordance with a determination that less than a predetermined portion of the representation (e.g., 25%, 30%, 40% 50%, 60%, 75%) was displayed using the second media-processing style when (e.g., at the same time as, immediately before, and/or immediately after) the end of the input directed to the representation was detected) (e.g., in response to detecting the input directed to the representation), the computer system continues to display the plurality of selectable user interface objects (e.g., 626a1, 626a2, 626b1, 626b2, 626c1, 626c2, 626d1, 626d2) for the first media-processing style without displaying the plurality of selectable user interface objects for the second media-processing style (e.g., forgoing replacing display of the plurality of selectable user interface objects for the first media-processing style with display of the plurality of selectable user interface objects for the second media-processing style)) (e.g., as described in relation to FIGS. 6A-6D and method 900). Choosing whether to display the plurality of selectable user interface objects for the second media-processing style or continue to display the plurality of selectable user interface objects for the first media-processing style when prescribed conditions are met allows the computer system to provide relevant selectable options to the user for a media-processing style in situations that are determined to may be relevant to the user, which performs an operation when a set of conditions has been met without requiring further user input.

In some embodiments, the plurality of selectable user interface objects (e.g., 626a1, 626a2, 626b1, 626b2, 626c1, 626c2, 626d1, 626d2) for the first media-processing style) (e.g., as described in relation to FIGS. 6A-6D and method 900) is displayed at one or more locations on (e.g., and/or at) (is overlaid on) the representation (e.g., 630, 676a, 676b, 676c, 680c, and/or 680d) (e.g., a live preview and/or previously captured media) of the media. In some embodiments, the one or more locations in a bottom portions of the representations of media, in a bottom portion of the representation of media that is displayed in a camera display region (e.g., 604), in one or more locations adjacent to (e.g., above) a user interface object for capturing media (e.g., 610) and/or camera capture mode user interface objects, between an indicator region (e.g., 602) and a control region (e.g., 606). In some embodiments, as a part of displaying the plurality of selectable user interface objects for the first media-processing style, the computer system ceases to display one or more other selectable user interface objects (e.g., one or more selectable objects for controlling a zoom level of the representation of media, one or more selectable objects for control a synthetic lighting effect that can be applied to the representation of the media). Displaying the plurality of the selectable objects for the first media-processing style at one or more locations on the representations of the media provides the user with feedback concerning selectable user interface objects that are available for (e.g., for editing, corresponding to) the first media-processing style while concurrently providing feedback concerning the representation of media to the user while efficiently using limited space for displaying user interface elements (e.g., on a display or in a predetermined display region that is available for displaying user interface elements), which provides additional control options without cluttering the user interface.

In some embodiments, while the first media-processing style is selected for use (e.g., while displaying the first portion of the representation and the second portion of the representation are displayed using the first media-processing style), the computer system (e.g., 600) a first request (e.g., 650a, 650c, 650j) to capture media (e.g., detecting an input (e.g., a tap input (e.g., a tap gesture) (e.g., a single tap input, a double tap input)) (and/or, in some embodiments, in response to detecting a non-tap input/gesture (e.g., a movement input/gesture, a press-and-hold input/gesture, and/or a voice input)) on a user interface object for captured media). In some embodiments, in response to detecting the first request to capture media, the computer system captures media (e.g., one or more photo(s) and/or video(s) corresponding to different activations and/or a single activation of a user interface object for capturing media) with the first media-processing style (e.g., 634a-634d, 634aa, and/or 634dd) applied (e.g., without having the second media-processing style applied). In some embodiments, in response to detecting the first request to capture media, the computer system captures and applies the first media-processing style to multiple photo and/or videos. In some embodiments, the first request to capture media includes multiple requests (e.g., includes detecting multiple inputs/gestures) to capture media. In some embodiments, the first request to capture media includes a single request (e.g., includes detecting a single input/gesture). In some embodiments, after capturing media with the first media-processing style applied, and while the second media-processing style (e.g., 634a-634d, 634aa, and/or 634dd) is selected for use (e.g., while the first portion of the representation and the second of the representation are displayed using the second media-processing style) (e.g., as discussed in relation to FIGS. 60-6U), the computer system detects a second request (e.g., 650a, 650c, 650j) to capture media (e.g., detecting an input (e.g., a tap input (e.g., a tap gesture) (e.g., a single tap input, a double tap input)) (and/or, in some embodiments, in response to detecting a non-tap input/gesture (e.g., a movement input/gesture, a press-and-hold input/gesture, and/or a voice input)) on a user interface object for captured media). In some embodiments, in response to detecting the second request to capture media, the computer system captures media (e.g., one or more photo(s) and/or video(s) corresponding to different activations and/or a single activation of a user interface object for capturing media) with the second media-processing style applied (e.g., as discussed in relation to FIGS. 60-6U) (e.g., without having the first media-processing style applied). In some embodiments, a representation of the media that includes the first portion of the representation and the second of the representation with the second media-processing style applied is different from a representation of media that includes the first portion of the representation and the second of the representation with the first media-processing style applied. In some embodiments, in response to detecting the second request to capture media, the computer system captures and applies the second media-processing style to multiple photo and/or videos. In some embodiments, the second request to capture media includes multiple requests (e.g., includes detecting multiple inputs/gestures) to capture media. In some embodiments, the first request to capture media includes a single request (e.g., includes detecting a single input/gesture). Capturing media that includes one or more portions of the representation that have a respective media-processing style applied in response to detecting a request to capture media when one or more portions of the representations was displayed with the respective media-processing style applied allows the computer system to intelligently capture media that is representative of the media that was displayed when the request to capture the media was detected, which performs an operation when a set of conditions has been met without requiring further user input.

In some embodiments, in response to detecting the input (e.g., 650d, 650k1, 650k2, 750j, and/or 750q) directed to the representation (e.g., 630, 676a, 676b, 676c, 680c, and/or 680d) and in accordance with a determination that an end (e.g., liftoff) of the input has been detected and in accordance with a determination that the input directed to the representation satisfies one or more movement criteria (e.g., input has been detected longer than a certain duration, has been detected to have a velocity (e.g., average velocity, highest velocity) above a threshold (e.g., a non-zero threshold), has been detected to end at a certain position on the style-selection user interface, and/or to has been detected over (e.g., from start position to end position) a threshold (e.g., a non-zero threshold) distance), the computer system displays (e.g., snapping to the display of, abruptly and/or immediately displaying after detecting the end of the input) the first portion of the representation and the second portion of the representation using the second media-processing style (e.g., 650d, 650k1, 650k2, 750j, and/or 750q) (e.g., without using the first media-processing style) (e.g., to indicate that the second media-processing style has been selected for use when capturing media in response to future media capture inputs). In some embodiments, in response to detecting the input (e.g., 650d, 650k1, 650k2, 750j, and/or 750q) directed to the representation (e.g., 630, 676a, 676b, 676c, 680c, and/or 680d) and in accordance with a determination that an end (e.g., liftoff) of the input has been detected and in accordance with a determination that the input directed to the representation does not satisfy one or more movement criteria, the computer system displays (e.g., snapping to the display of, abruptly and/or immediately displaying after detecting the end of the input) the first portion of the representation and the second portion of the representation using the first media-processing style (e.g., 650d, 650k1, 650k2, 750j, and/or 750q) (e.g., without using the second media-processing style) (e.g., to indicate that the first media-processing style has been selected for use when capturing media in response to future media capture inputs). Choosing whether to display the first portion of the representation and the second portion of the representation using the second media-processing style or display the first portion of the representation and the second portion of the representation using the first media-processing style based on the movement of the input allows the computer system to intelligently provide feedback to the user concerning which media-processing style is selected and will impact the display and/or capture of the media going forward, which performs an operation when a set of conditions has been met without requiring further user input and provides improved visual feedback.

In some embodiments, after detecting the input (e.g., 650d, 650k1, 650k2, 750j, and/or 750q) directed to the representation, the computer system displays the first portion of the representation and the second portion of the representation using the second media-processing style (e.g., 634a-634d, 634aa, and/or 634dd). In some embodiments, while displaying the representation and the second portion of the representation are displayed using the second media-processing style, the computer system detects a second input (e.g., 650d, 650k1, 650k2, 750j, and/or 750q) directed to the representation (and, in some embodiments includes movement in the same direction as a movement direction of the input directed to the representation). In some embodiments, in response to detecting the second input directed to the representation, in accordance with a determination that the second input directed to the representation is in the first direction, the computer system displays the first portion of the representation using a ninth media-processing style (e.g., 634a-634d, 634aa, and/or 634dd) (e.g., that is different from the first media-processing style, the second media-processing style, and the third media-processing style (e.g., as described above in relation to method 900)) while continuing to display the second portion of the representation using the second media-processing style. In some embodiments, as a part of displaying the first portion of the representation using the ninth media-processing style while continuing to display the second portion of the representation using the second media-processing style (e.g., 634a-634d, 634aa, and/or 634dd), the computer system, in response to detecting a first portion of the second input directed to the representation (and, in some embodiments, the first portion of the second input has a third input magnitude), displays (e.g., concurrently displaying) the first portion of the representation using the ninth media-processing style while the second portion of the representation and the third portion of the representation are displayed using the second media-processing style. In some embodiments, after displaying the first portion of the representation using the seventh media-processing style while the second portion of the representation and the third portion of the representation are displayed using the second media-processing style and in response to detecting a second portion of the second input directed to the representation. In some embodiments, the second portion of the second input has a fourth input magnitude that is greater than the second input magnitude, the computer system displays the first portion of the representation and the third portion of the representation using the seventh media-processing style while the second portion of the representation is displayed using the second media-processing style.

In some embodiments, in response to detecting the second input (e.g., 650d, 650k1, 650k2, 750j, and/or 750q) directed to the representation and in accordance with a determination that an end of the second input has been detected, the computer system: in accordance with a determination that the second input directed to the representation satisfies one or more movement criteria (e.g., input has been detected longer than a certain duration, has been detected to have a velocity (e.g., average velocity, highest velocity) above a threshold (e.g., a non-zero threshold), has been detected to end at a certain position on the style-selection user interface, and/or to has been detected over (e.g., from start position to end position) a threshold (e.g., a non-zero threshold) distance), displays (e.g., snapping to the display of, abruptly and/or immediately displaying after detecting the end of the input) the first portion of the representation and the second portion of the representation using the seventh media-processing style (e.g., 634a-634d, 634aa, and/or 634dd) (e.g., without using the first media-processing style and second media-processing style); and in accordance with a determination that the input directed to the representation does not satisfy one or more movement criteria, displays (e.g., snapping to the display of, abruptly and/or immediately displaying after detecting the end of the input) the first portion of the representation and the second portion of the representation using the second media-processing style (e.g., without using the seventh media-processing style and first media-processing style). Choosing whether to display the first portion of the representation and the second portion of the representation using the seventh media-processing style or display the first portion of the representation and the second portion of the representation using the second media-processing style based on the movement of the input allows the computer system to intelligently provide feedback to the user concerning which media-processing style is selected and will impact the display and/or capture of the media going forward, which provides additional control options without cluttering the user interface and provides improved visual feedback. Displaying the first portion of the representation using the seventh media-processing style while the second portion of the representation and the third portion of the representation are displayed using the second media-processing style in response to detecting a first portion of the second input directed to the representation provides the user with visual feedback concerning how different media-processing style(s) impact the visual content represented by the representation of the media differently and concerning at least some media-processing style(s) that can be selected based on the second input directed to the representation, which provides improved visual feedback. Displaying the first portion of the representation using a ninth media-processing style while continuing to display the second portion of the representation using the second media-processing style in response to detecting the second input directed to the representation after detecting the input directed to the representation and in accordance with a determination that the second input directed to the representation is in the first direction, allows the user to control which portions of the representation that are displayed using a media-processing style that is different from the first media-processing style and the second media-processing style, which provides additional control options without cluttering the user interface.

In some embodiments, before displaying the style-selection user interface that includes the representation of the media that is displayed using the first media-processing style, (e.g., 634a-634d, 634aa, and/or 634dd) displaying a user interface that includes (e.g., a fourth representation of the media (e.g., that is not displayed using the first media-processing style) (or any other media-processing style (e.g., any other user-selected/predefined media-processing style (e.g., that is applied to the representation in response to detecting an input, such as the input directed to the representation) like the first media-processing style, second media-processing style, third media-processing style discussed above)) and) a user interface object (e.g., 602b) for displaying the style-selection user interface that is displayed at a first respective location in the user interface that includes a fourth representation of the media (e.g., a mode that causes the computer system to apply one or more media-processing styles to the second representation) (e.g., as described in relation to method 1000). In some embodiments, while displaying the user interface object (e.g., 602b) for displaying the style-selection user interface, the computer system detects an input (e.g., 650b) (e.g., a tap input (e.g., a tap gesture) (e.g., a single tap input, a double tap input)) (and/or, in some embodiments, detecting a non-tap input/gesture (e.g., a movement input/gesture, a press-and-hold input/gesture, and/or a voice input)) directed to the user interface object for displaying the style-selection user interface (e.g., and/or directed to the first respective location). In some embodiments, in response to detecting the input directed to the user interface object for displaying the style-selection user interface, the computer system displays the style-selection user interface (e.g., an interface that includes one or more of (e.g., 634a-634d, 634aa, and/or 634dd)) (e.g., and/or ceasing to display the representation of the media that is not displayed using the first media-processing style or any other media-processing style (e.g., any other user-selected/predefined media-processing style)). In some embodiments, in response to detecting the first input directed to the user interface object for displaying the style-select user interface, the computer system is configured to operation in the styles-mode. In some embodiments, as a part of displaying style-selection user interface, the computer system displays (and/or continues to display) a representation of media using the currently selected media-processing style. Displaying the representation of the media that is displayed using the first media-processing style in response to detecting the input directed to user interface object for displaying the style-selection user interface provides the user with control over the computer system regarding whether a style-selection user interface will be displayed, where a user can set a new media-processing style to apply to a representation of media, which provides additional control options without cluttering the user interface.

In some embodiments, the style-selection user interface includes a user interface object (e.g., 602b) for controlling a setting (e.g., an f-stop setting (e.g., to control a depth parameter), a setting to turn off a photo capture setting, where a plurality of photos are captured in response to a single request to capture media)) (as described above in relation to 602c and 602d) at a second respective location in the style-selection user interface (e.g., an interface that includes one or more of (e.g., 634a-634d, 634aa, and/or 634dd)). In some embodiments, while displaying the style-selection user interface and the user interface object (e.g., 602b) for controlling the setting at the second respective location, detecting an input (e.g., a tap input (e.g., a tap gesture) (e.g., a single tap input, a double tap input)) (and/or, in some embodiments, detecting a non-tap input/gesture (e.g., a movement input/gesture, a press-and-hold input/gesture, a voice input)) directed to the second respective location in the style-selection user interface (e.g., directed to a location at which the user interface object for displaying the style-selection user interface was previously displayed). In some embodiments, in response to detecting the input directed to the second respective location in the style-selection user interface, the computer system ceases to display the style-selection user interface (e.g., as discussed above in relation inputs detected on 602c and 602d) (or any other media-processing style ((e.g., any other user-selected/predefined media-processing style (e.g., that is applied to the representation in response to detecting an input, such as the input directed to the representation) like the first media-processing style, second media-processing style, third media-processing style discussed above)) (e.g., and/or ceasing to display the representation of the media that is displayed and/or where portions of the representation are displayed using the media-processing styles (e.g., the first media-processing style and/or the second media-processing style)). In some embodiments, in response to detecting the input directed to the second respective location in the user interface, the computer system displays one or more user interface objects (e.g., a slider) for controlling to the setting. In some embodiments, in response to detecting the input directed to the second respective location in the style-selection user interface, the computer system is not configured to operate in the media-processing style selection mode. In some embodiments, as a part of ceasing style-selection user interface, the computer system maintains display of a representation using the currently selected media-processing style. Ceasing to display the style-selection user interface in response to detecting the input directed to the user interface object for controlling a setting (e.g., that was detected while displaying the user interface that includes the representation of the media that is displayed using the first media-processing style) provides the user with control over the computer system regarding whether a style-selection user interface will be displayed, where a user can select a new media-processing style to apply to a representation of media, which provides additional control options without cluttering the user interface.

In some embodiments, after displaying the style-selection user interface, the computer system receives a request to displaying a camera user interface. In some embodiments, in response to receiving the request to display the camera user interface, the computer system displays a camera user interface (e.g., user interface that includes 602, 604, and/or 606) that includes concurrently displaying, in the camera user interface: a representation (e.g., 630) of a field of view of one or more cameras; and a respective user interface object (e.g., 602b) that, when selected, causes the style-selection user interface to be displayed (e.g., a user interface object for displaying the style-selection user interface), including: in accordance with a determination that the first media-processing style is currently selected as a media-processing style, displaying the respective user interface object (e.g., 602b) with a first appearance (e.g., without displaying the affordance with the second appearance). In some embodiments, in accordance with a determination that the second media-processing style is currently selected as a media-processing style, the computer system displays the respective user interface object (e.g., 602b) with a second appearance that is different from the first appearance (e.g., described above in relation to 602b at FIGS. 6A-6D) (e.g., without displaying the affordance with the first appearance). In some embodiments, the camera user interface also includes a user interface object for capturing media (e.g., 610) that is concurrently displayed with the representation of the field of view of the one or more cameras and the affordance that, when selected, causes the device to capture media with one or more cameras of the device. In some embodiments, the computer system displays the respective user interface object with the first appearance when a default style is the currently selected media-processing style and displays the respective user interface object with the second appearance when one or more (and/or a predetermined number) of different non-default styles are selected. Displaying the user interface object, that when selected, causes the style-selection user interface to be displayed with a different visual appearance based on whether a respective media-processing style being a first media-processing style or the second media-processing style provides the user with visual feedback concerning the media-processing style that is currently being and/or currently configured to be applied to the visual content of the media, which provides improved visual feedback.

In some embodiments, the user interface includes a first user interface object (e.g., as discussed in relation to FIGS. 8A-8C) that is concurrently displayed with the first portion of the representation and the second portion of the representation that is displayed using the first media-processing style. In some embodiments, while displaying the first user interface object that is concurrently displayed with the first portion of the representation and the second portion of the representation that is displayed using the first media-processing style, the computer system displays, via the one or more input devices, an input (e.g., a tap input (e.g., a tap gesture) (e.g., a single tap input, a double tap input)) (and/or, in some embodiments, detecting a non-tap input/gesture (e.g., a movement input/gesture, a press-and-hold input/gesture, a voice input)) directed to the first user interface object (e.g., as discussed in relation to FIGS. 8A-8C). In some embodiments, in response to detecting the input directed to the first user interface object, the computer system displays the first portion of the representation and the second portion of the representation without using the first media-processing style (e.g., as discussed in relation to FIGS. 8A-8C) (e.g., a style that is displayed when the computer system is not operating in a media-processing style selection mode, and/or a style that cannot be detected by an input like the input directed to the representation) for displaying content). In some embodiments, in response to detecting the input directed to the first user interface object, the first portion of the representation and the second portion of the representation is displayed using a media-processing style that is different from the first media-processing style. In some embodiments, in response to detecting the input directed to the first user interface object, the first portion of the representation and the second portion of the representation is displayed using a neutral style (and/or default style). Displaying the first portion of the representation and the second portion of the representation without using the first media-processing style in response to detecting the input directed to the first user interface object (e.g., that was detected while displaying the first user interface object that is concurrently displayed with the first portion of the representation and the second portion of the representation that is displayed using the first media-processing style) allows the user to control whether or not the representation of the first media-processing style will be displayed using the first media-processing style, which provides additional control options without cluttering the user interface.

In some embodiments, the style-selection user interface includes a selectable user interface object (e.g., 610) for capturing media (e.g., a shutter button). In some embodiments, while displaying the representation (e.g., 630) of the media using the first media-processing style (e.g., 634a-634d, 634aa, and/or 634dd), and the selectable user interface object for capturing media (e.g., and the style-selection user interface), the computer system detects an input (e.g., 650a, 650c, 650j) (e.g., a tap input (e.g., a tap gesture) (e.g., a single tap input, a double tap input)) (and/or, in some embodiments, detecting a non-tap input/gesture (e.g., a movement input/gesture, a press-and-hold input/gesture, and/or a voice input)) directed to the selectable user interface object for capturing media (e.g., a location in the style selection user interface). In some embodiments, in response to detecting the input (e.g., 650a, 650c, 650j) directed to the selectable user interface object for capturing media, the computer system captures media that has the first media-processing style applied (e.g., based on the current value of the parameters of the first media-processing style). In some embodiments, in response to detecting the input directed to the selectable user interface object for capturing media and while detecting an input directed to the plurality of selectable user interface objects for the first media-processing style and/or detecting an input to directed to the representation (e.g., as request to switch media-processing styles (e.g., in response to detecting the input directed to the representation), the computer initiates the capture of media that has a media-processing style applied that is applied to a predetermined portion of the representation (e.g., 25%, 30%, 40% 50%, 60%, 75%) was displayed using the first media-processing style and/or a greater (or equal to) portion of the representation of the media than other portions of the representation of the media that was displayed (and/or when (e.g., immediately before/after) the input detecting to the selectable user interface object for capturing media was detected. In some embodiments, in response to detecting the input directed to the selectable user interface object for capturing media, the computer system display a representation (e.g., a thumbnail representation) of the capture media that has the first media-processing style applied in the style-selection user interface). Capturing media that has the first media-processing style applied in response to detecting the input directed to the selectable user interface object for capturing media (e.g., that was detected while displaying the representation of the media using the first media-processing style and the selectable user interface object for capturing media) allows the user to capture media that will have the currently selected media-processing style applied, which provides additional control options without cluttering the user interface.

In some embodiments, as a part of displaying the first portion of the representation using the first media-processing style, the computer system applies the first media-processing style (e.g., 650d, 650k1, 650k2, 750j, and/or 750q) differently (e.g., using a different set of visual parameters (e.g., color characteristics (e.g., warmth, tone, hue, brightness, saturation, shade, tint, colorfulness, coldness, and/or harmony) and/or depth parameters) for one type of identified object as compared to a different type of identified object (e.g., subjects (e.g., a person) as compared to non-subjects) to one or more objects (e.g., the person in live preview 630) (e.g., people and/or faces of people) (e.g., identifiable object) in (e.g., detected in) the first portion of the representation (e.g., 630) than to a subset of the first portion that does not include the one or more objects (e.g., displaying a first subset of the first portion (e.g., a subset that includes an object) with a different visual appearance than a second subset of the first portion (e.g., a subset that does not include an object)). In some embodiments, the first media-processing style is applied differently different portions of the representation to attempt to preserve the appearance of some of the particular portions of a scene (e.g., portion(s) of the scene that include the sky, a skin tone, a face of a user, etc.) included in the representation of the media.

In some embodiments, the first media-processing style (e.g., 650d, 650k1, 650k2, 750j, and/or 750q) is applied to the representation of the media based one or more parameters selected from the group consisting of contrast, vibrancy, warmth, and a combination thereof (e.g., as described in relation to FIGS. 6A-6C and method 70).

In some embodiments, while the first portion (e.g., a portion of middle section, the left section, and/or the right section of 630, 676a, 676b, 676c, 680c, and/or 680d) of the representation and the third portion (e.g., a portion of middle section, the left section, and/or the right section of 630, 676a, 676b, 676c, 680c, and/or 680d) of the representation is displayed using the second media-processing style (e.g., 634a-634d, 634aa, and/or 634dd) while the second portion of the representation is displayed using the first media-processing style, the computer system detects an end of the input (e.g., 650d, 650k1, 650k2, 750j, and/or 750q) directed to the representation. In some embodiments, in response to detecting the end of the input (e.g., 650d, 650k1, 650k2, 750j, and/or 750q) directed to the representation, the computer system ceases to display the second portion (e.g., at least a portion of the second portion, an edge of the representation) of the representation using the first media-processing style (e.g., fading out the second portion of the representation that is displayed using the first media-processing style) and decreasing a visual prominence of (e.g., dimming out, darkening, fading out, greying out, not highlighting, and/or increasing opacity of) a subset (e.g., 660a, 660b, and/or a portion of middle section, the left section, and/or the right section of 630, 676a, 676b, 676c, 680c, and/or 680d) (e.g., a portion of the representation that is included in and smaller than the second portion the representation) of the second portion of the representation (and displaying the first portion of the representation, the second portion of the representation, and/or the third portion of the representation using the second media-processing style). In some embodiments, the first portion of the representation is displayed using the second media-processing style and while the second portion of the representation and the third portion of the representation are displayed using the first media-processing style, the computer system detects an end of the input directed to the representation. In some embodiments, in response to detecting the end of the input directed to the representation while the first portion of the representation is displayed using the second media-processing style and while the second portion of the representation and the third portion of the representation are displayed using the first media-processing style, the computer system ceases to display the first portion (e.g., at least a portion of the second portion, an edge of the representation) of the representation using the second media-processing style and decreases a visual prominence of a subset (e.g., a portion of the representation that is included in and smaller than the second portion the representation) of the first portion of the representation. In some embodiments, while the subset of the second portion (e.g., a portion of middle section, the left section, and/or the right section of 630, 676a, 676b, 676c, 680c, and/or 680d) of the representation is displayed with the decreased visual prominence, the computer system detects a third input (e.g., 650d, 650k1, 650k2, 750j, and/or 750q) directed to the representation (e.g., 630, 676a, 676b, 676c, 680c, and/or 680d). In some embodiments, in response to detecting the third input directed to the representation, the computer system increases the visual prominence of (e.g., undimming, brightening, fading in, highlighting, and/or decreasing opacity of) the subset of the second portion of the representation. Increasing the visual prominence the subset of the second portion of the representation in response to detecting the fourth input directed to the representation provides the user with visual feedback that the end of the input directed to the representation has not been detected and, in some embodiments, provides the user with visual feedback concerning how a media-processing style can affect the subset of the second portion of the representation, which provides improved visual feedback. Decreasing the visual prominence the subset of the second portion of the representation in response to detecting the end of the input directed to the representation provides the user with visual feedback that the a media-processing style has been selected via the input and/or that the input is not currently being detected, which gives the user confidence that an unintended change regarding changing of the selected media-processing style will not occur without further user input, which provides improved visual feedback.

In some embodiments, displaying the representation of the media includes: in accordance with a determination that the representation of the media (e.g., and/or a portion of the presentation of media) would be displayed using a tenth media-processing style (e.g., 634a-634d, 634aa, and/or 634dd) (and/or any media-processing style) in response to detecting a fourth input (e.g., 650d, 650k1, 650k2, 750j, and/or 750q) directed to the representation, a fifth portion (e.g., 660a, 660b, the right section, and/or the left section) (e.g., an edge (e.g., left edge and/or right edge), a visual element) of the representation is displayed with a first visual appearance (e.g., a first color and/or not grayed-out); and in accordance with a determination that the representation of the media (e.g., and/or a portion of the presentation of media) would not be displayed using the tenth media-processing style (and/or any media-processing style) in response to detecting the fourth input directed to the representation, the fifth portion (e.g., 660a, 660b, the right section, and/or the left section) of the representation is displayed with a second visual appearance that is different from the first visual appearance. Displaying the fourth portion of the representation differently based on a determination of whether or not the representation of the media would be displayed using a tenth media-processing style provides the user with visual feedback concerning whether the user can select a respective media-processing style via an input and/or whether the respective media-processing style can be accessed via an input in a particular direction, which provides improved visual feedback.

In some embodiments, before detecting the input (e.g., 650d, 650k1, 650k2, 750j, and/or 750q) directed to the representation and while displaying the first portion of the representation and the second portion of the representation using the first media-processing style, a sixth portion (e.g., 660a, 660b, the right section, and/or the left section) (e.g., an edge (e.g., left edge and/or right edge), a portion) of the representation of the media is displayed using the first media-processing style (e.g., with a media-processing style being applied to the area/edge of the representation of the media). Displaying a sixth portion of the representation of the media is displayed using the first media-processing style provides the user with feedback concerning how the first media-processing style could impact the second area of the representation, which provides improved visual feedback.

In some embodiments, before detecting the input (e.g., 650d, 650k1, 650k2, 750j, and/or 750q) directed to the representation and while displaying the first portion of the representation and the second portion of the representation using the first media-processing style (e.g., 634a-634d, 634aa, and/or 634dd), a seventh portion (e.g., 660a, 660b, the right section, and/or the left section) (e.g., an edge (e.g., left edge and/or right edge), a portion) of the representation of the media is not displayed using the first media-processing style (e.g., 634a-634d, 634aa, and/or 634dd) (without any media-processing style (e.g., first media-processing style, second media-processing style, third media-processing style, etc.) being applied to the area/edge of the representation of the media). In some embodiments, in response to detecting the input (e.g., 650d, 650k1, 650k2, 750j, and/or 750q) directed to the representation, the computer system displays an animation of the seventh portion (e.g., 660a, 660b, the right section, and/or the left section) of the representation of the media transitioning from not being displayed using the first media-processing style to being displayed using the first media-processing style (e.g., fading in the first media-processing style being applied to the representation of the media). Displaying an animation of the second area of the representation of the media transitioning from not being displayed using the first media-processing style to being displayed using the first media-processing style in response to detecting the input directed to the representation provides a user with feedback concerning how the first media-processing style could impact the second area of the representation (e.g., when the user would more than likely want to see how the first media-processing style could impact the second area of the representation), which provides improved visual feedback.

In some embodiments, before displaying the style-selection user interface, where the first portion of the representation and the second portion of the representation are displayed using the first media-processing style that is applied to visual content of the media, the computer system displays a user interface object (e.g., 844a) for enabling a second media-processing style selection mode. In some embodiments, while displaying the user interface object (e.g., 844a) for enabling the second media-processing style selection mode, the computer system detects an input (e.g., 850a) (e.g., a tap input (e.g., a tap gesture) (e.g., a single tap input, a double tap input)) (and/or, in some embodiments, detecting a non-tap input/gesture (e.g., a movement input/gesture, a press-and-hold input/gesture, and/or a voice input)) directed to the user interface object for enabling the second media-processing style selection mode. In some embodiments, in response to detecting the input directed to the user interface object for enabling the second media-processing style selection mode, the computer system displays a respective user interface that includes concurrently displaying a representation (e.g., 878a) of previously captured media (e.g., sample media, media that has not been captured by the computer system and/or a template) that has the first media-processing style applied (e.g., 634a) and a representation (e.g., 878b) of previously captured media (e.g., sample media, media that has not been captured by the computer system and/or a template) that has the second media-processing style (e.g., 634b) applied. In some embodiments, while displaying the respective, the computer system detects an input (e.g., a tap input (e.g., a tap gesture) (e.g., a single tap input, a double tap input)) (and/or, in some embodiments, detecting a non-tap input/gesture (e.g., a movement input/gesture, a press-and-hold input/gesture, and/or a voice input)) directed to the respective user interface. In some embodiments, in response to detecting the input directed to the respective user interface and in accordance with a determination that the input directed to the respective user interface corresponds to selection of an option to use the first media-processing style, the computer system displays the user interface that includes the representation of the media in response to detecting a request to display a media user interface (e.g., without using the second media-processing style). In some embodiments, in response to detecting the input directed to the respective user interface and in accordance with a determination that the input directed to the respective user interface corresponds to selection of an option to use the second media-processing style, the computer system displays a user interface that includes a representation of media using the second media-processing style in response to detecting the request to display the media user interface (e.g., without using the first media-processing style).

In some embodiments, the style-selection user interface includes a first styles-mode user interface object (e.g., 602b and/or 688b) that, when selected, causes (e.g., causes the computer system to toggles between) the style-selection user interface to be displayed (e.g., a user interface object for displaying the style-selection user interface, and/or a user interface object that, when selected, causes the style-section user interface to be displayed) (e.g., or cease to be displayed). In some embodiments, the first styles-mode user interface object is concurrently displayed with one or more camera setting user interface objects (e.g., 688) (e.g., one or more camera setting user interface objects (e.g., a user interface of object for controlling a camera setting) are displayed based on the camera capture mode in which the one or more cameras are configured to capture media (e.g., settings for each camera capture mode)). In some embodiments, before displaying the user interface object for displaying the style-selection user interface is displayed, the computer system detects an input (e.g., 650w) (e.g., swipe input, tap input, and/or drag input) directed to a respective user interface and, in response to detecting the input directed to the respective user interface, the computer system displays the user interface object for displaying the style-selection user interface (e.g., that was not previously displayed) and one or more camera setting affordances (e.g., that was not previously displayed). In some embodiments, in response to detecting selection of a respective camera setting user interface object of the one or more camera setting user interface object, the computer system displays one or more controls for adjusting a camera setting (e.g., a control, that when selected, causes the computer system to turn a mode on (e.g., a flash mode, a night mode, an animated image capture mode, and/or a timer mode), a control that, when selected, causes the computer system to turn the mode off), a control that, when selected, causes a value for a capture setting (e.g., an exposure value, a time value for a timer mode) to be adjusted, and/or a control for changing one or more filters and/or zoom levels used to capture and/or display media). Displaying the style-selection user interface includes a first styles-mode user interface object concurrently with one or more user camera setting user interface objects allows user to access a control that can cause the style-selection user interface to be displayed and cease to be displayed while allowing a user to access controls for controlling one or more user camera settings, which reduces the number inputs that it takes to access the respective controls if they were not concurrently displayed.

In some embodiments, the style-selection user interface includes a second styles-mode user interface object (e.g., 602b and/or 688b) that, when selected, causes (e.g., causes the computer system to toggle between) the style-selection user interface to be displayed (e.g., a user interface object for displaying the style-selection user interface, and/or a user interface object that, when selected, causes the style-section user interface to be displayed) (e.g., or cease to be displayed). In some embodiments, the computer system, while displaying the first portion of the representation (e.g., 630) using the second media-processing style while the second portion of the representation and the third portion of the representation are displayed using the first media-processing style, displays the second styles-mode user interface object (e.g., 602b and/or 688b) with a third appearance (e.g., a color, a size, with a first border (e.g., line (e.g., that is shown in a clockwise and/or counter-clockwise direction) surrounding the second styles-modes user interface object, where in the line surrounds and/or is around a portion (e.g., 0%-100%) of the second styles-mode user interface object)) (e.g., as discussed above in relation to FIG. 6L). In some embodiments, after displaying the first portion of the representation using the second media-processing style while the second portion of the representation and the third portion of the representation are displayed using the first media-processing style and in response to detecting the second portion of the input (e.g., 650d, 650k1, 650k2, 750j, and/or 750q) directed to the representation, the computer system changes (e.g., displays and/or displays an animation of the second styles-mode user interface changing) the second styles-mode user interface object from being displayed with the third appearance to being displayed with a fourth appearance (e.g., a color, a size, with a first border (e.g., line (e.g., that is shown in a clockwise and/or counter-clockwise direction) surrounding the second styles-modes user interface object, where in the line surrounds and/or is around a portion (e.g., 0%-100%) of the second styles-mode user interface object)) that is different from the third appearance (e.g., while displaying the first portion of the representation and the third portion of the representation using the second media-processing style while the second portion of the representation is displayed using the first media-processing style) (e.g., as discussed above in relation to FIG. 6L). Changing the second styles-mode user interface object from being displayed with the third appearance to being displayed with the fourth appearance provides visual feedback to the user regarding how a switch to a media-processing style that is being applied to a representation effects display of the representation differently, which provides improved visual feedback.

In some embodiments, as a part of changing the second styles-mode user interface object (e.g., 602b) from being displayed with the third appearance to being displayed with the fourth appearance, in accordance with a determination that a value (e.g., 626a and/or 626b) of a first parameter of the first media-processing style (e.g., 634a-634d, 634aa, and/or 634dd) is different from a value of the first parameter (e.g., 626a and/or 626b) of the second media-processing style (e.g., 634a-634d, 634aa, and/or 634dd), the computer system changes display of a first visual aspect (e.g., color of 602b and/or line around 602b (e.g., as discussed above in relation to FIG. 6L)) (e.g., a color, a shading, and/or a tint of at least a portion (and, in some embodiments, the portion includes the border (e.g., a line surrounding) of the second media-processing style)) of the second styles-mode user interface object (e.g., 602b) (e.g., without changing the second visual aspect of the second styles-mode user interface object based on the determination that the value of the first parameter of the first media-processing style is different from the value of the first parameter of the second media-processing style). In some embodiments, in accordance with a determination that the value of the first parameter of the first media-processing style is not different from the value of the first parameter of the second media-processing style, the computer system does not change the first visual aspect of the second styles-mode user interface object. In some embodiments, while displaying the first portion of the representation using the second media-processing style while the second portion of the representation and the third portion of the representation are displayed using the first media-processing style, the first visual aspect corresponds to (is and/or is represented by) a first color and, after displaying the first portion of the representation using the second media-processing style while the second portion of the representation and the third portion of the representation are displayed using the first media-processing style and in response to detecting the second portion of the input directed to the representation, the second visual aspect corresponds to (is and/or is represented by) a second color that is different from the first color length (e.g., as described above in relation to method 1000). In some embodiments, as a part of changing the second styles-mode user interface object (e.g., 602b) from being displayed with the third appearance to being displayed with the fourth appearance, in accordance with a determination that a value of a second parameter (e.g., 626a and/or 626b) of the first media-processing style is different from a value of the second parameter (e.g., 626a and/or 626b) of the second media-processing style, where the first parameter is different from the second parameter, the computer system changes display of a second visual aspect (e.g., color of 602b and/or line around 602b (e.g., as discussed above in relation to FIG. 6L)) (e.g., a size, a length, and/or a fill of at least a portion (e.g., a borderline and/or line that is around, adjacent to, and/or surrounds the second styles-mode user interface object) of the second media-processing style) of the second styles-mode user interface object. In some embodiments, the second visual aspect is different from the first visual aspect (e.g., without changing the first visual aspect of the second styles-mode user interface object based on the determination that the value of the second parameter of the first media-processing style is different from the value of the second parameter of the second media-processing style). In some embodiments, in accordance with a determination that the value of the second parameter of the first media-processing style is not different from the value of the second parameter of the second media-processing style, the computer system does not change the second visual aspect of the second styles-mode user interface object. In some embodiments, while displaying the first portion of the representation using the second media-processing style while the second portion of the representation and the third portion of the representation are displayed using the first media-processing style, the second visual aspect corresponds to (is and/or is represented by) a first length and, after displaying the first portion of the representation using the second media-processing style while the second portion of the representation and the third portion of the representation are displayed using the first media-processing style and in response to detecting the second portion of the input directed to the representation, the second visual aspect corresponds to (is and/or is represented by) a second length that is different from the first length (e.g., as described in relation to method 1000). Changing display of a particular visual aspect of the second styles-mode user interface object based on whether a value of a particular parameter has been changed, provides visual feedback to the user regarding which parameters have been changed for a media-processing style, which provides improved visual feedback.

In some embodiment, the computer is configured to store media (e.g., and/or capture media) in a first file format (e.g., compressed format, such as JPEG and/or HEIC) (e.g., when raw capture indicator 602b is displayed in an inactive state). In some embodiments, while the computer system is configured to capture and sore media in the first file format and while the second styles-mode user interface object (e.g., 602b) is displayed in an active state (e.g., enabled state (e.g., a state where the computer system performs an action in response to detecting one or more inputs directed to the user interface object)), the computer system detects a request (e.g., 650v) to configure the computer system to capture and store media in a second file format (e.g., raw format) that is different from the first file format. In some embodiments, in response to detecting the request to configure the computer system to capture and store media in the second file format, the computer system ceases to display the second styles-mode user interface object in the active state (e.g., as discussed above in relation to FIGS. 6V-6Y) (e.g., ceasing to display the second styles-mode user interface object and/or displaying the second styles-mode user interface object in an inactive (e.g., disabled state (e.g., a state where the computer system does not perform an action in response to detecting one or more inputs directed to the user interface object)). In some embodiments, in response to detecting the request to configure the computer system to capture and store media in the second file format, the computer system configures the computer system to capture and store media in the second file format. In some embodiments, as a part of detecting the request to configure the computer system to capture and store media in the second file format, the computer system detects an input (e.g., a tap input, a press-and-hold input, and/or a swipe input) directed to the first selectable user interface object for controlling a file format for capturing media with the one or more cameras. In some embodiments, in response to detecting the request to configure the computer system to capture and store media in the second file format, the computer system changes the first selectable user interface object for controlling a file format for capturing media with the one or more cameras from being displayed in an inactive state to being displayed in an active state. Ceasing to display the second styles-mode user interface object in the active state in response to detecting the request to configure the computer system to capture and store media in the second file format provides visual feedback to the user that a media-processing style is not being applied and applying a media-processing style is not available when the computer is configured to capture and store media in the second file format, which improves visual feedback.

Note that details of the processes described above with respect to method 900 (e.g., FIG. 9) are also applicable in an analogous manner to the methods described herein. For example, method 900 optionally includes one or more of the characteristics of the various methods described above with reference to method 1000. For example, method 900 can be used to select one or more media-processing styles and method 1000 can be used to edit the media that was selected using method 900. For brevity, these details are not repeated below.

FIGS. 10A-10B are a flow diagram illustrating methods for editing media-processing styles using a computer system in accordance with some embodiments. Method 1000 is performed at a computer system (e.g., 100, 300, 500, 600) (e.g., a smartphone, a desktop computer, a laptop, and/or a tablet) that is in communication with a display generation component (e.g., a display controller and/or a touch-sensitive display system) and one or more input devices (e.g., a touch-sensitive surface and/or a first camera of one or more cameras (e.g., one or more cameras (e.g., dual cameras, triple camera, quad cameras, etc.) on the same side or different sides of the computer system (e.g., a front camera and/or a back camera))). Some operations in method 1000 are, optionally, combined, the orders of some operations are, optionally, changed, and some operations are, optionally, omitted.

As described below, method 1000 provides an intuitive way for editing media-processing styles using a computer system. The method reduces the cognitive burden on a user for editing media-processing styles using a computer system, thereby creating a more efficient human-machine interface. For battery-operated computing devices, enabling a user to edit media-processing styles using a computer system faster and more efficiently conserves power and increases the time between battery charges.

The computer system displays (1002), via the display generation component, a user interface (e.g., a style-selection user interface, a media capture user interface, a media viewing user interface a media editing user interface) that includes a representation (e.g., 630, 676a, 676b, 676c, 680c, and/or 680d) (e.g., photo media, video media) (e.g., live media, a live preview (e.g., media corresponding a representation of a field-of-view (e.g., a current field-of-view) of the one or more cameras that has not been stored/captured (e.g., in response to detecting a request to capture media (e.g., detecting selection of a shutter affordance (e.g., user interface object))), previously captured media (e.g., media corresponding a representation of a field-of-view (e.g., a previous field-of-view) of the one or more cameras that has been captured, a media item that has been saved and is able to be accessed by a user at a later time, and/or a representation of media that was displayed in response to receiving a gesture on a thumbnail representation of media (e.g., in a media gallery)) of media (e.g., information, data that is being captured or that has been captured by one or more cameras of the computer system) (e.g., while operating in a camera mode) (e.g., and while operating in a particular style-mode (e.g., a media-processing styles mode)), where the representation of the media is displayed using a first media-processing style (e.g., 634a-634d, 634aa, and/or 634dd) (e.g., according to, with) that is applied to visual content of the media. In some embodiments, the first media-processing style is one of a plurality of media-processing style. In some embodiments, each plurality of styles have the same set of parameters. In some embodiments, the set of parameters is a set of visual characteristics (e.g., color characteristics (e.g., warmth, tone, hue, brightness, saturation, shade, tint, colorfulness, coldness, and/or harmony) and/or depth parameters) (e.g., without a second style being applied to the media).

While displaying the representation of the media using the first media-processing style (e.g., 634a-634d, 634aa, and/or 634dd), the computer system concurrently displays (1004), via the display generation component, a plurality of selectable user interface objects for (e.g., editing parameters (e.g., visual characteristics (e.g., a color characteristic (e.g., warmth, tone, hue, brightness, saturation, shade, tint, colorfulness, coldness and/or harmony)) and/or a depth parameter) of) the first media-processing style, including: a first selectable user interface object (e.g., 626a1, 626a2, 626b1, 626b2, 626c1, 626c2, 626d1, and/or 626d2) for editing a first parameter (e.g., as indicated by 626a1a, 626a2a, 626b1a, 626b2a, 626c1a, 626c2a, 626d1a, and/or 626d2a) (e.g., visual characteristics (e.g., a color characteristic (e.g., warmth, tone, hue, brightness, saturation, shade, tint, colorfulness, coldness, and/or harmony)) and/or a depth parameter) of the first media-processing style (1006) that is displayed with (e.g., concurrently displayed with, includes) a representation (e.g., 626a1b, 626a2b, 626b1b, 626b2b, 626c1b, 626c2b, 626d1b, and/or 626d2b) of a current value for the first parameter of the first media-processing style (e.g., a number (e.g., 0-100), a percentage (e.g., 0-100%), an indication of the number on a control (e.g., a slider, a rotatable knob) (e.g., a slider bar that is displayed at a particular position on a slider), one or more characters that is indicated for the first value), a compressed control and/or a portion of a control) and a second electable user interface object (e.g., 626a1, 626a2, 626b1, 626b2, 626c1, 626c2, 626d1, and/or 626d2) for editing a second parameter (e.g., as indicated by 626a1a, 626a2a, 626b1a, 626b2a, 626c1a, 626c2a, 626d1a, and/or 626d2a) (e.g., visual characteristics (e.g., a color characteristic (e.g., warmth, tone, hue, brightness, saturation, shade, tint, colorfulness, coldness, and/or harmony)) and/or a depth parameter) of the first media-processing style (1008) that is displayed with (e.g., concurrently displayed with, includes) a representation (e.g., 626a1b, 626a2b, 626b1b, 626b2b, 626c1b, 626c2b, 626d1b, and/or 626d2b) of a current value for the second parameter of the first media-processing style (e.g., a number (e.g., 0-100), a percentage (e.g., 0-100%), an indication of the number on a control (e.g., a slider and/or a rotatable knob) (e.g., a slider bar that is displayed at a particular position on a slider), one or more characters that is indicated for the first value), a compressed control, and/or a portion of a control), where the first parameter is different from the second parameter. In some embodiments, in accordance with a determination that the first value corresponds to a first amount of the parameter, the first value is displayed to indicate the first amount of the first parameter. In some embodiments, in accordance with a determination that the first value corresponds to a second amount of the parameter, the first value is displayed to indicate the second amount of the first parameter, where the first amount is different from the second amount. In some embodiments, the first value for the second parameter is different from the first value for the first parameter. In some embodiments, first selectable user interface object is different from the second selectable user interface object. In some embodiments, the plurality of selectable user interface objects was not displayed before the request to edit how the first media-processing style is applied to the visual content was applied. In some embodiments, the plurality of selectable user interface objects for editing parameters of the first media-processing style are displayed next to each other (e.g., next to each other in a line) (e.g., aligned with each other, in-lined).

While displaying the plurality of selectable user interface objects (e.g., 626a1, 626a2, 626b1, 626b2, 626c1, 626c2, 626d1, and/or 626d2) for the first media-processing style (e.g., and while displaying the representation of the media that is displayed using the first media-processing style) (e.g., and while operating in a particular style-mode (e.g., a media-processing styles mode)), the computer system detects (1010), via the one or more input devices, an input (e.g., 750a, 750d, 750g, 750k, 750n, 750r, and/or 750t) (e.g., a tap input (e.g., a tap gesture) (e.g., a single tap input, a double tap input)) (and/or, in some embodiments, detecting a non-tap input/gesture (e.g., a movement input/gesture (e.g., a swipe input/gesture that includes velocity at the end of the input/gesture or a drag input/gesture that causes changes based on movement during the input/gesture), and/or a press-and-hold input/gesture)) directed to the plurality of selectable user interface objects for the first media-processing style.

In response to (1012) detecting the input (e.g., 750a, 750d, 750g, 750k, 750n, 750r, and/or 750t) (e.g., a tap input (e.g., a tap gesture) (e.g., a single tap input, a double tap input)) (and/or, in some embodiments, detecting a non-tap input/gesture (e.g., a movement input/gesture (e.g., a movement input/gesture that includes velocity at the end of the input/gesture or a drag input/gesture that causes changes based on movement during the input/gesture), and/or a press-and-hold input/gesture)) directed to the plurality of selectable user interface objects for the first media-processing style (e.g., and while displaying the representation of the media using the first media-processing style and/or while continuing to operate in a particular camera mode and/or while operating in a particular style-mode (e.g., a media-processing styles mode)) (and/or, in some embodiments, in response to detecting a non-tap input/gesture (e.g., a movement input/gesture and/or a press-and-hold input/gesture) directed to the plurality of selectable user interface objects for editing parameters that correspond to the first media-processing style), the computer system, in accordance with a determination that the input is directed to the first selectable user interface object for editing the first parameter of the first media-processing style, displays (1014), via the display generation component, a first control (e.g., 626a1, 626a2, 626b1, 626b2, 626c1, 626c2, 626d1, and/or 626d2) (e.g., a slider and/or a rotatable knob) (e.g., an expanded control (e.g., an expanded control of a compress control that was previously displayed)) for adjusting (e.g., changing) the current value for the first parameter (e.g., as indicated by 626a1a, 626a2a, 626b1a, 626b2a, 626c1a, 626c2a, 626d1a, and/or 626d2a) (e.g., without displaying the control for adjusting the first value for the second parameter) (e.g., without adjusting the second value for the first parameter) (e.g., concurrently with the representation of the first media-processing style being applied to the visual content) (e.g., while continuing to detect the input directed to the plurality of selectable user interface objects for the first media-processing style). In some embodiments, in response to detecting an input (e.g., a movement input) (and/or, in some embodiments, in response to detecting a non-movement input (e.g., tap input, a rotation dragging gesture, a press-and-hold gesture, and/or a voice input) directed to the first control for adjusting the current value for the first parameter, the computer system updates the representation of the media and/or a portion of the representation of the media (e.g., to reflect that that the current value for the first parameter) and/or updates the current value for the first parameter. In some embodiments, in response to detecting the input directed to the first control for adjusting the current value for the first parameter, the computer system does not update the representation of the media and/or a portion of the representation of the media to reflect the current value of the second parameter and/or does not update the current value for the second parameter.

In response to (1012) detecting the input (e.g., 750a, 750d, 750g, 750k, 750n, 750r, and/or 750t) (e.g., a tap input (e.g., a tap gesture) (e.g., a single tap input, a double tap input)) (and/or, in some embodiments, detecting a non-tap input/gesture (e.g., a movement input/gesture (e.g., a movement input/gesture that includes velocity at the end of the input/gesture or a drag input/gesture that causes changes based on movement during the input/gesture), and/or a press-and-hold input/gesture)) directed to the plurality of selectable user interface objects for the first media-processing style (e.g., and while displaying the representation of the media using the first media-processing style and/or while continuing to operate in a particular camera mode and/or while operating in a particular style-mode (e.g., a media-processing styles mode)) (and/or, in some embodiments, in response to detecting a non-tap input/gesture (e.g., a movement input/gesture and/or a press-and-hold input/gesture) directed to the plurality of selectable user interface objects for editing parameters that correspond to the first media-processing style), the computer system, in accordance with a determination that the input is directed to the second user interface object for editing the second parameter of the first media-processing style, displays (1016), via the display generation component, a second control (e.g., 626a1, 626a2, 626b1, 626b2, 626c1, 626c2, 626d1, and/or 626d2) (e.g., a slider and/or a rotatable knob) (e.g., an expanded control (e.g., an expanded control of a compress control that was previously displayed)) for adjusting (e.g., changing) the current value for the second parameter (e.g., as indicated by 626a1a, 626a2a, 626b1a, 626b2a, 626c1a, 626c2a, 626d1a, and/or 626d2a) (e.g., without displaying the control for adjusting the first value for the first parameter) (e.g., concurrently with the representation of the first media-processing style being applied to the visual content) (e.g., while continuing to detect the input directed to the plurality of selectable user interface objects for the first media-processing style). In some embodiments, in response to detecting an input (e.g., a movement input) (and/or, in some embodiments, in response to detecting a non-movement input (e.g., tap input, a rotation dragging gesture, and/or a press-and-hold gesture) directed to the second control for adjusting the current value for the second parameter, the computer system updates the representation of the media and/or a portion of the representation of the media (e.g., to reflect that that the current value for the second parameter) and/or updates the current value for the second parameter. In some embodiments, in response to detecting the input directed to the second control for adjusting the current value for the second parameter, the computer system does not update the representation of the media and/or a portion of the representation of the media to reflect the current value of the first parameter and/or does not update the current value for the first parameter. Displaying a respective control for adjusting the current value for a respective parameter in accordance with a determination that the input is directed to a respective user interface object for editing the respective parameter of the first media-processing style allows a user to access a control for adjusting the current value for a respective parameter based on the respective user interface object at which the input was directed, which provides additional control options without cluttering the user interface. While displaying the representation of the media using the first media-processing style, concurrently displaying, via the display generation component, the plurality of selectable user interface objects for the first media-processing style provides the user with visual feedback concerning a plurality of selectable user interface objects that can be used to edit how the first media-processing style is applied to visual content, which provides improved visual feedback.

In some embodiments, as a part of displaying the first control (e.g., 626a1, 626a2, 626b1, 626b2, 626c1, 626c2, 626d1, and/or 626d2), the computer system displays (e.g., concurrently with the first control; as part of the first control) a second representation (e.g., 626a1b, 626a2b, 626b1b, 626b2b, 626c1b, 626c2b, 626d1b, and/or 626d2b) of the current value for the first parameter of the first media-processing style (e.g., 634a-634d, 634aa, and/or 634dd). In some embodiments, as a part of displaying the second control (e.g., 626a1, 626a2, 626b1, 626b2, 626c1, 626c2, 626d1, and/or 626d2), the computer system displays (e.g., concurrently with the second control; as part of the second control) a second representation (e.g., 626a1b, 626a2b, 626b1b, 626b2b, 626c1b, 626c2b, 626d1b, and/or 626d2b) of the current value for the second parameter of the first media-processing style. Displaying a respective control with a representation of a current respective value for the respective control in accordance with a determination that the input is directed to a respective user interface object for editing the respective parameter provides the user with visual feedback concerning the current value for the respective parameter and how the user can adjust the current value for the respective parameter to change how a media-processing style is applied to visual content, which provides improved visual feedback.

In some embodiments, while displaying the representation (e.g., 630, 676a, 676b, 676c, 680c, and/or 680d) of the media using the first media-processing style (e.g., 634a-634d, 634aa, and/or 634dd) and the plurality of selectable user interface objects for the first media-processing style (e.g., 626a1, 626a2, 626b1, 626b2, 626c1, 626c2, 626d1, and/or 626d2) (e.g., and while operating in a particular style-mode (e.g., a media-processing style selection mode)), the computer system detects a request (e.g., 650d, 650k1, 650k2, 750j, and/or 750q) to display the representation of the media using a second media-processing style (e.g., 634a-634d, 634aa, and/or 634dd) (e.g., a style that differs from the first style in one or more visual characteristics) that is applied to visual content of the media. In some embodiments, in response to detecting the request (e.g., 650d, 650k1, 650k2, 750j, and/or 750q) to display the representation of the media using the second media-processing style that is applied to visual content of the media (e.g., and while operating in a particular style-mode (e.g., a media-processing styles mode)), the computer system ceases to display the plurality of selectable user interface objects for the first media-processing style. In some embodiments, in response to detecting the request to display the representation of the media using the second media-processing style that is applied to visual content of the media, the computer system displays the representation of the media using the second media-processing style that is applied to visual content of the media. In some embodiments, in response to detecting the request to display the representation of the media using the second media-processing style that is applied to visual content of the media, the computer system displays the representation of the media using the second media-processing style that is applied to visual content of the media concurrently with a plurality of selectable user interface objects for the second media-processing style. In some embodiments, the plurality of selectable user interface objects for the second media-processing style includes a first selectable user interface object for editing a third parameter of the second media-processing style that is displayed with a representation of a current value for the third parameter of the second media-processing style; and a second electable user interface object for editing a fourth parameter of the second media-processing style that is displayed with a representation of a current value for the fourth parameter of the second media-processing style. In some embodiments, the third parameter is different (e.g., a different type of parameter) from the fourth parameter. In some embodiments, the first parameter is the same (e.g., the same type of parameter) as the third parameter. In some embodiments, the second parameter is the same (e.g., the same type of parameter) as the fourth parameter. In some embodiments, in response to detecting input directed to the plurality of selectable user interface objects for the second media-processing style, the computer system, in accordance with a determination that the input is directed to the first selectable user interface object for editing the third parameter of the second media-processing style, displays, via the display generation component, a control for adjusting the current value for the third parameter. In some embodiments, in response to detecting input directed to the plurality of selectable user interface objects for the second media-processing style, the computer system, in accordance with a determination that the input is directed to the second selectable user interface object for editing the fourth parameter of the second media-processing style, the computer system displays, via the display generation component, a control for adjusting the current value for the fourth parameter. Ceasing to display the plurality of selectable user interface objects for the first media-processing style in response to detecting the request to display the representation of the media using the second media-processing style that is applied to visual content of the media allows the computer system to source relevant user interface objects that pertain to the media-processing style that is being applied to representation of media without sourcing user interface objects that do not pertain to the media-processing style that is being applied to representation of media, which performs an operation when a set of conditions has been met without requiring further user input and provides improved visual feedback.

In some embodiments, as a part of displaying, via the display generation component, the first control (e.g., 626a1, 626a2, 626b1, 626b2, 626c1, 626c2, 626d1, and/or 626d2) for adjusting the current value for the first parameter (e.g., in response to detecting the input directed to the plurality of selectable user interface objects for the first media-processing style and in accordance with a determination that the input is directed to the first selectable user interface object for editing the first parameter of the first media-processing style), the computer system expands (and/or enlarging) the first selectable user interface object (e.g., 626a1, 626a2, 626b1, 626b2, 626c1, 626c2, 626d1, and/or 626d2) for editing the first parameter of the first media-processing style (e.g., to display the first control for adjusting the current value for the first parameter) (e.g., expanding in-line, expanding the first selectable user interface object for editing the first parameter of the first media-processing style such that the first control for adjusting the current value for the first parameter occupies the same area (and/or a portion of the same area) that the first user interface object for editing the first parameter of the first media-processing style occupied before the input directed to the plurality of selectable user interface objects for the first media-processing style was detected) (e.g., displaying an animation of expanding). In some embodiments, as a part of displaying, via the display generation component, the second control for adjusting the current value for the second parameter (e.g., in response to detecting the input directed to the plurality of selectable user interface objects for the first media-processing style and in accordance with a determination that the input is directed to the second user interface object for editing the second parameter of the first media-processing style), the computer system expands the second selectable user interface object for editing the second parameter of the first media-processing style (e.g., to display the second control for adjusting the current value for the second parameter) (e.g., expanding in-line, expanding the second user interface object for editing the second parameter of the first media-processing style such that the second control for adjusting the current value for the second parameter occupies the same area (and/or a portion of the same area) that the second user interface object for editing the second parameter of the first media-processing style occupied before the input directed to the plurality of selectable user interface objects for the first media-processing style was detected). In some embodiments, the first control for adjusting the current value for the first parameter is related to (e.g., is a larger version of, is larger than, includes a portion of, and/or includes one or more characteristics of) the first selectable user interface object for editing the first parameter of the first media-processing style. In some embodiments, the second control for adjusting the current value for the second parameter is related to (e.g., is a larger version of, is larger than, includes a portion of, and/or includes one or more characteristics of) the second selectable user interface object for editing the second parameter of the first media-processing style. Expanding the first selectable user interface object for editing the first parameter of the first media-processing style as a part of displaying, via the display generation component, the first control for adjusting the current value for the first parameter in response to the input provides visual feedback to the user that the first selectable user interface object for editing the first parameter of the first media-processing style corresponds to the first control for adjusting the current value for the first parameter, which reduces the confusion for the user while also providing a de-cluttered user interface and provides improved visual feedback.

In some embodiments, while displaying, via the display generation component, the first control (e.g., 626a1, 626a2, 626b1, 626b2, 626c1, 626c2, 626d1, and/or 626d2) for adjusting the current value for the first parameter (e.g., and continuing to detect the input directed to the plurality of selectable user interface objects for the first media-processing style), the computer system detects an end of the input directed to the plurality of selectable user interface objects for the first media-processing style. In some embodiments, in response to detecting the end (e.g., liftoff) of the input (e.g., 750a, 750d, 750g, 750k, 750n, and/or 750t) directed to the plurality of selectable user interface objects for the first media-processing style, the computer system reduces a size of (e.g., shrinking) the first control for adjusting the current value for the first parameter (e.g., to display the first selectable user interface object for editing a first parameter of the first media-processing style that is displayed with the representation of the current value for the first parameter of the first media-processing style) (e.g., displaying an animation of shrinking). In some embodiments, after shrinking the first control for adjusting the current value for the first parameter and/or in response to detecting the end of the input directed to the plurality of selectable user interface objects for the first media-processing style, the computer system re-displays the first selectable user interface object for editing the first parameter and the second selectable user interface object for editing the second parameter). In some embodiments, after shrinking the first control for adjusting the current value for the first parameter and/or in response to detecting the end of the input directed to the plurality of selectable user interface objects for the first media-processing style, the computer system re-displays the first selectable user interface object for editing the first parameter and displays the representation of the current value of the first parameter at a different position on the first selectable user interface object for editing the second parameter from the position that the representation of the current value of the first parameter was previously displayed before the input was detected. In some embodiments, while displaying, via the display generation component, the second control for adjusting the current value for the second parameter (e.g., and continuing to detect the input directed to the plurality of selectable user interface objects for the first media-processing style), the computer system detects an end of the input directed to the plurality of selectable user interface objects for the first media-processing style; and in response to detecting the end of the input directed to the plurality of selectable user interface objects for the first media-processing style, the computer system reduces the size of the second control for adjusting the current value for the second parameter (e.g., to display the second selectable user interface object for editing the second parameter of the first media-processing style that is displayed with the representation of the current value for the second parameter of the first media-processing style). In some embodiments, after reducing the size of the second control for adjusting the current value for the second parameter and/or in response to detecting the end of the input directed to the plurality of selectable user interface objects for the first media-processing style, the computer system re-displays the first selectable user interface object for editing the first parameter and the second selectable user interface object for editing the second parameter. In some embodiments, after reducing the size of the second control for adjusting the current value for the second parameter and/or in response to detecting the end of the input directed to the plurality of selectable user interface objects for the first media-processing style, the computer system re-displays the second selectable user interface object for editing the second parameter and displays the representation of the current value of the second parameter at a different position on the second selectable user interface object for editing the second parameter from the position that the representation of the current value of the second parameter was previously displayed before the input was detected. Reducing the size of the first control for adjusting the current value for the first parameter in response to detecting the end of the input directed to the plurality of selectable user interface objects for the first media-processing style provides visual feedback to the user that the first selectable user interface object for editing the first parameter of the first media-processing style corresponds to the first control for adjusting the current value for the first parameter, which reduces the confusion for the user while also providing a de-cluttered user interface and provides improved visual feedback.

In some embodiments, before detecting the input (e.g., 750a, 750d, 750g, 750k, 750n, and/or 750t) directed to the plurality of selectable user interface objects for the first media-processing style, the current value for the first parameter is a first value (e.g., represented by 626a1b, 626a2b, 626b1b, 626b2b, 626c1b, 626c2b, 626d1b, and/or 626d2b). In some embodiments, while displaying, via the display generation component, the first control (e.g., 626a1, 626a2, 626b1, 626b2, 626c1, 626c2, 626d1, and/or 626d2) for adjusting the current value for the first parameter (e.g., and continuing to detect the input directed to the plurality of selectable user interface objects for the first media-processing style), the computer system detects an end (e.g., liftoff) of the input directed to the plurality of selectable user interface objects for the first media-processing style. In some embodiments, in response to detecting the end (e.g., liftoff) of the input directed to the plurality of selectable user interface objects for the first media-processing style, the computer system displays the representation (e.g., 626a1b, 626a2b, 626b1b, 626b2b, 626c1b, 626c2b, 626d1b, and/or 626d2b) of the current value of the first parameter. In some embodiments, the current value is a second value that is different from the first value. In some embodiments, the second value is the same as the first value. In some embodiments, while displaying, via the display generation component, the first control for adjusting the current value for the first parameter and in response to detecting the end (e.g., liftoff) of the input directed to the plurality of selectable user interface objects for the first media-processing style, the computer system displays the representation of the current value of the second parameter, where the current value of the representation of the second parameter is a value after the input directed to the plurality of selectable user interface objects for the first media-processing style was detected that is the same as the value that the current value was before the input directed to the plurality of selectable user interface objects for the first media-processing style was detected (e.g., the current value for the second parameter does not change). In some embodiments, before detecting the input directed to the plurality of selectable user interface objects for the first media-processing style, the current value for the first parameter is a third value, while displaying, via the display generation component, the second control for adjusting the current value for the second parameter (e.g., and continuing to detect the input directed to the plurality of selectable user interface objects for the first media-processing style), the computer system: detects an end (e.g., liftoff) of the input directed to the plurality of selectable user interface objects for the first media-processing style; and in response to detecting the end (e.g., liftoff) of the input directed to the plurality of selectable user interface objects for the first media-processing style, displays the representation of the current value of the second parameter. In some embodiments, the current value is a third value that is different from the fourth value (and/or displaying the representation of the current value of the first parameter as the same value that the current value of the first parameter was displayed before the input directed to the plurality of selectable user interface objects for the first media-processing style was detected). Displaying the representation of the current value of the first parameter, where the current value is a second value that is different from the first value, in response to detecting the end of the input directed to the plurality of selectable user interface objects for the first media-processing style provides the user with visual feedback to understand that the current value of the first parameter has been adjusted by the input, which provides improved visual feedback.

In some embodiments, the first selectable user interface object (e.g., 626a1, 626a2, 626b1, 626b2, 626c1, 626c2, 626d1, and/or 626d2) for editing the first parameter is displayed with a first representation (e.g., 626a1c, 626a2c, 626b1c, 626b2c, 626c1c, 626c2c, 626d1c, and/or 626d2c) of a first range of values (e.g., −100 to 100) (e.g., and, in some embodiments, the representation of the current value for the first parameter of the first media-processing style is displayed on, adjacent to, and/or included in the representation of the first range of values) for the first parameter, the first range of values having a first distance between a first point in the first representation of the first range of values representing a first value and a second point in the first representation of the first range of values representing a second value (e.g., as discussed above in relation to FIGS. 7A-7B). In some embodiments, as a part of displaying the first control (e.g., 626a1, 626a2, 626b1, 626b2, 626c1, 626c2, 626d1, and/or 626d2), the computer system displays a second representation (e.g., 626a1c, 626a2c, 626b1c, 626b2c, 626c1c, 626c2c, 626d1c, and/or 626d2c) of a range of values which has a second distance (e.g., on the display generation component), greater than the first distance (e.g., on the display generation component), between a first point in the second representation of the range of values representing the first value and a second point in the second representation of the range of values representing the second value (e.g., as discussed above in relation to FIGS. 7A-7B). In some embodiments, the second selectable user interface object for editing the first parameter is displayed with a third representation of a first range of values (e.g., −100 to 100) (e.g., and, in some embodiments, the representation of the current value for the first parameter of the first media-processing style is displayed on, adjacent to, and/or included in the representation of the first range of values) for the second parameter, the first range of values for the second parameter having a third distance between a first point in the third representation of the first range of values for the second parameter representing a third value and a second point in the third representation of the first range of values for the second parameter representing a fourth value. In some embodiments, as a part of displaying the second control, the computer system displays a fourth representation of a second range of values for the second parameter which has a fourth distance, greater than the third distance, between a first point in the fourth representation of the second range of values for the second parameter representing the third value and a second point in the fourth representation of the second range of values for the second parameter representing the fourth value. In some embodiments, the second selectable user interface object for editing the first parameter includes a representation of a second range of values (e.g., −100 to 100) for the first parameter (e.g., and, in some embodiments, the representation of the current value for the second parameter of the first media-processing style is displayed on, adjacent to, and/or included in the representation of the second range of values). In some embodiments, as a part of displaying the second control, the computer displays a representation of a range of values (e.g., 30 to 60) that is a subset of the first range of values for the second parameter (e.g., and ceasing to displaying the representation of a first range of values for the second parameter). In some embodiments, while displaying, via the display generation component, the first control for adjusting the current value for the first parameter and continuing to detect the input directed to the plurality of selectable user interface objects for the first media-processing style (and/or while continuing to detect movement of the input directed to the plurality of selectable user interface objects for the first media-processing style), the computer system increases a first size of the first control for adjusting the current value for the first parameter (e.g., zooming into the first control, displaying one or more portions of a respective control for adjusting the current value for a respective parameter at an increased, bigger, greater size than the control was previously displayed) (e.g., on the user interface). In some embodiments, while displaying, via the display generation component, the second control for adjusting the current value for the second parameter and continuing to detect the input directed to the plurality of selectable user interface objects for the first media-processing style (and/or while continuing to detect movement of the input directed to the plurality of selectable user interface objects for the first media-processing style), increasing a size of the second control for adjusting the current value for the second parameter (e.g., zooming into the second control) (e.g., on the user interface). Displaying a representation of a range of values which has a second distance, greater than the first distance, between a second point representing the first value and a second point representing the second value as a part of displaying the first control provides the user with visual feedback that the first control for adjusting the current value for the first parameter can be manipulated to change the current value for the first parameter via the input and gives the user the ability to focus on and/or select (e.g., more easily select) values between a point representing the first value and a point representing the second value, which provides additional control options without cluttering the user interface and provides improved visual feedback.

In some embodiments, the first control (e.g., 626a1, 626a2, 626b1, 626b2, 626c1, 626c2, 626d1, and/or 626d2) is displayed with a third representation (e.g., 626a1c, 626a2c, 626b1c, 626b2c, 626c1c, 626c2c, 626d1c, and/or 626d2c) of a third range of values for the first parameter, the third range of values having a third distance between a first point in the third representation of the third range of values representing a third value and a second point in the third representation of the third range of values representing a fourth value. In some embodiments, while displaying, via the display generation component, the first control with the third representation of the third range of values for the first parameter, the computer system detects an end (e.g., liftoff) of the input (e.g., 750a, 750d, 750g, 750k, 750n, and/or 750t) directed to the plurality of selectable user interface objects for the first media-processing style. In some embodiments, in response to detecting the end of the input directed to the plurality of selectable user interface objects for the first media-processing style, the computer system displays the first selectable user interface object (e.g., 626a1, 626a2, 626b1, 626b2, 626c1, 626c2, 626d1, and/or 626d2) for editing the first parameter with a fifth representation (e.g., 626a1c, 626a2c, 626b1c, 626b2c, 626c1c, 626c2c, 626d1c, and/or 626d2c) of a range of values which has a fourth distance (e.g., on the display generation component), lesser than the third distance (e.g., on the display generation component), between a first point in the fifth representation of the range of values representing the third value and a second point in the fifth representation of the range of values representing the fourth value. In some embodiments, the second control is displayed with a fifth representation of a fifth range of values for the second parameter, the fifth range of values having a fifth distance between a first point in the fifth representation of the range of values for the second parameter representing a fifth value and a second point in the fifth representation of the fifth range of values representing a sixth value. In some embodiments, while displaying, via the display generation component, the second control with the fifth representation of the fifth range of values for the second parameter, the computer system detects an end (e.g., liftoff) of the input directed to the plurality of selectable user interface objects for the first media-processing style. In some embodiments, in response to detecting the end of the input directed to the plurality of selectable user interface objects for the first media-processing style, the computer system displays the second selectable user interface object for editing the second parameter with a sixth representation of a range of values which has a sixth distance, lesser than the fifth distance, between a first point in the sixth representation of the range of values for the second parameter representing the fifth value and a second point in the sixth representation of the range of values for the second parameter representing the sixth value. In some embodiments, the first control is displayed with a representation of a range of values that is a subset (e.g., 30 to 60) (e.g., having a min and max value that is between the second range of values) of a second range of values (e.g., −100 to 100) for the first parameter. In some embodiments, while displaying, via the display generation component, the first control with the representation of the subset of the second range of values for the first parameter, the computer system detects an end (e.g., liftoff) of the input directed to the plurality of selectable user interface objects for the first media-processing style. In some embodiments, in response to detecting the end of the input directed to the plurality of selectable user interface objects for the first media-processing style, the computer system displays a representation of a second range of values for the first parameter. In some embodiments, in response to detecting the end of the input directed to the plurality of selectable user interface objects for the first media-processing style, the computer system ceases displaying the representation of the subset of the second range of values for the first parameter. In some embodiments, in response to detecting the end of the input directed to the plurality of selectable user interface objects for the first media-processing style, the computer system displays a representation of a second range of values for the second parameter (e.g., that was not previously displayed while the representation of the subset of the second range of values for the first parameter was displayed) concurrently with the representation of the second range of values for the first parameter. In some embodiments, the second control is displayed with a representation of a range of values that is a subset (e.g., 30 to 60) of a second range of values for the second parameter. In some embodiments, while displaying, via the display generation component, the second control with the representation of the subset of the second range of values for the second parameter, the computer system detects an end (e.g., liftoff) of the input directed to the plurality of selectable user interface objects for the first media-processing style and, in response to detecting the end of the input directed to the plurality of selectable user interface objects for the first media-processing style, displays a representation of a second range of values for the second parameter. In some embodiments, in response to detecting the end of the input directed to the plurality of selectable user interface objects for the first media-processing style, the computer system ceases displaying the representation of the subset of the second range of values for the second parameter. In some embodiments, in response to detecting the end of the input directed to the plurality of selectable user interface objects for the first media-processing style, the computer system decreases a second size (e.g., same as the first size in the paragraph above) of the first control for adjusting the currently value for the first parameter (e.g., zooming out the first control, displaying one or more portions of a respective control for adjusting the current value for a respective parameter at a decreased, smaller, lesser size than the control was previously displayed) (e.g., on the user interface). In some embodiments, while displaying, via the display generation component, the second control for adjusting the current value for the second parameter, the computer system detects an end (e.g., liftoff) of the input directed to the plurality of selectable user interface objects for the first media-processing style. In some embodiments, in response to detecting the end of the input directed to the plurality of selectable user interface objects for the first media-processing style, the computer system decreases a size of the first control for adjusting the currently value for the first parameter. Displaying the first selectable user interface object for editing the first parameter with a representation of a range of values which has a fourth distance, lesser than the third distance, between a second point representing the third value and a second point representing the fourth value provides the user with visual feedback that the first control for adjusting the current value for the first parameter can be no longer manipulated to change the current value for the first parameter via the input, which provides improved visual feedback.

In some embodiments, in response to detecting the input (e.g., 750a, 750d, 750g, 750k, 750n, and/or 750t) directed to the plurality of selectable user interface objects (e.g., 626a1, 626a2, 626b1, 626b2, 626c1, 626c2, 626d1, and/or 626d2) for the first media-processing style and in accordance with a determination that the input is directed to the first selectable user interface object for editing the first parameter of the first media-processing style, the computer system moves the second control (e.g., 626a1, 626a2, 626b1, 626b2, 626c1, 626c2, 626d1, and/or 626d2) for adjusting the current value for the second parameter (e.g., represented by 626a1b, 626a2b, 626b1b, 626b2b, 626c1b, 626c2b, 626d1b, and/or 626d2b) from a first location on user interface to a second location (e.g., that is different from the first location) on the user interface (e.g., and/or one or more of the other plurality of selectable user interface objects for the first media-processing style). In some embodiments, in response to detecting the input directed to the plurality of selectable user interface objects for the first media-processing style and in accordance with a determination that the input is directed to the second selectable user interface object for editing the second parameter of the first media-processing style, the computer system moves the first control for adjusting the currently value for the first parameter from a third location on user interface to a fourth location (e.g., that is different from the third location) on the user interface (e.g., and/or one or more of the other plurality of selectable user interface objects for the first media-processing style). Moving the second control for adjusting the currently value for the second parameter from a first location on user interface to a second location in response to detecting the input directed to the plurality of selectable user interface objects for the first media-processing style and in accordance with a determination that the input is directed to the first selectable user interface object for editing the first parameter of the first media-processing style provides the user with visual feedback that the input was not directed to the second selectable user interface object for editing the first parameter of the first media-processing style, allowing a user to correct a potential error if needed, which provides improved visual feedback.

In some embodiments, in response to detecting the input (e.g., 750a, 750d, 750g, 750k, 750n, and/or 750t) directed to the plurality of selectable user interface objects (e.g., 626a1, 626a2, 626b1, 626b2, 626c1, 626c2, 626d1, and/or 626d2) for the first media-processing style and in accordance with a determination that the input is directed to the first selectable user interface object (e.g., 626a1, 626a2, 626b1, 626b2, 626c1, 626c2, 626d1, and/or 626d2) for editing the first parameter of the first media-processing style, the computer system ceases to display the second control (e.g., 626a1, 626a2, 626b1, 626b2, 626c1, 626c2, 626d1, and/or 626d2) for adjusting the current value for the second parameter (e.g., and/or one or more of the other plurality of selectable user interface objects for the first media-processing style). In some embodiments, in response to detecting the input directed to the plurality of selectable user interface objects for the first media-processing style and in accordance with a determination that the input is directed to the second selectable user interface object for editing the second parameter of the first media-processing style, the computer system ceases to display the first control for adjusting the currently value for the first parameter (e.g., and/or one or more of the other plurality of selectable user interface objects for the first media-processing style). Ceasing to display the second control for adjusting the currently value for the second parameter in response to detecting the input directed to the plurality of selectable user interface objects for the first media-processing style and in accordance with a determination that the input is directed to the first selectable user interface object for editing the first parameter of the first media-processing style provides the user with visual feedback that the input was not directed to the second selectable user interface object for editing the first parameter of the first media-processing style, allowing a user to correct a potential error if needed, which provides improved visual feedback.

In some embodiments, while displaying the representation of the media using the first media-processing style and before detecting the input directed to the plurality of selectable user interface objects for the first media-processing style, a first identifier (e.g., 636a-636d) (e.g., one or more symbols and/or text (e.g., “Standard”, “Vibrant”)) that corresponds to the first media-processing style (e.g., 634a-634d) is displayed. In some embodiments, in response to detecting the input (e.g., 750a, 750g) directed to the plurality of selectable user interface objects for the first media-processing style and in accordance with a determination that the current value for the first parameter has changed (e.g., after the input directed to the plurality of selectable user interface objects for the first media-processing style, in response to detecting movement of the input directed to the plurality of selectable user interface objects for the first media-processing style) to (or is) a value (e.g., a numerical value (e.g., −100-100), and/or a percentage) that is different from a default value (e.g., a predefined value) (e.g., 0) of the first parameter of the first media-processing style (and/or in accordance with a determination that the current value for the second parameter has change (e.g., after the input directed to the plurality of selectable user interface objects for the first media-processing style, in response to detecting movement of the input directed to the plurality of selectable user interface objects for the first media-processing style) to (or is) a value that is different from a default value of the second parameter of the first media-processing style), the computer system displays a second identifier (e.g., 636aa and/or 636dd) (e.g., one or more symbols and/or text (e.g., “Custom”, “Custom-Standard”, “Custom-Vibrant”)) that corresponds to a third media-processing style (e.g., 634aa, and/or 634dd) (e.g., a media-processing style that is different from the first media-processing style and the second media-processing style, a media-processing style that was not predefined before the input directed to the plurality of selectable user interface objects for the first media-processing style was detected). In some embodiments, the second identifier is different from the first identifier (and ceasing to display the first identifier). In some embodiments, the second incitation includes a portion (e.g., one or more words) of the first identifier. In some embodiments, while displaying the second identifier, the computer system detects other input directed to the plurality of selectable user interface objects for the first media-processing style. In some embodiments, in response to detecting the other input directed to the plurality of selectable user interface objects for the first media-processing style and in accordance with a determination that the current value for the first parameter is a default value for the first parameter of the first media-processing style and the current value for the second parameter is a default value for the second parameter of the first media-processing style, the computer system displays (e.g., re-displays) the first identifier and ceases to display the second identifier. In some embodiments, the first media-processing style is different from the third media-processing style. In some embodiments, the first media-processing style is a predefined media-processing style (e.g., a style that is not created in response to detecting an input directed to the computer system) and the third media-processing style is not a predefined media-processing style. Displaying a second identifier that corresponds to a third media-processing style in accordance with a determination that the current value for the first parameter has changed to a value that is different from a default value for the first parameter provides the user with visual feedback that the first media-processing style has been edited such that at least one parameter for the first media-processing style is not the default value for the at least one parameter of the media-processing style and/or that a custom media-processing style that has been customized by the user has been created, which provides improved visual feedback.

In some embodiments, the user interface includes a selectable user interface object (e.g., 722) for resetting one or more parameters of the first media-processing style. In some embodiments, while displaying the selectable user interface object (e.g., 722) for resetting one or more parameters of the first media-processing style, the computer system detects an input (e.g., 750w) (e.g., a tap input (e.g., a tap gesture) (e.g., a single tap input, a double tap input)) (and/or, in some embodiments, detecting a non-tap input/gesture (e.g., a movement input, a press-and-hold input/gesture, and/or a voice input)) directed to the selectable user interface object for resetting the one or more parameters of the first media-processing style. In some embodiments, in response to detecting the input (e.g., 750w) directed to the selectable user interface object for resetting the one or more parameters of the first media-processing style, the computer system displays the representation of the current value (e.g., represented by 626a1b, 626a2b, 626b1b, 626b2b, 626c1b, 626c2b, 626d1b, 626d2b) for the first parameter of the first media-processing style as a second default value (e.g., represented by 626a1b, 626a2b, 626b1b, 626b2b, 626c1b, 626c2b, 626d1b, and/or 626d2b) e.g., a numerical value (e.g., −100-100), a percentage) for the first parameter of the first media-processing style (e.g., and/or setting the current value for the first parameter of the first media-processing style to the default value of the first parameter of the first media-processing style); and displays the representation of the current value for the second parameter of the first media-processing style as a second default value (e.g., represented by 626a1b, 626a2b, 626b1b, 626b2b, 626c1b, 626c2b, 626d1b, and/or 626d2b) (e.g., a numerical value (e.g., −100-100), a percentage) for the second parameter of the first media-processing style (e.g., and/or setting the current value for the first parameter of the first media-processing style to the default value of the second parameter of the first media-processing style). In some embodiments, in response to detecting the input directed to the selectable user interface object for resetting the one or more parameters of the first media-processing style, the computer system sets the current value for the first parameter of the first media-processing style as the second default value for the first parameter of the first media processing style and sets the current value for the first parameter of the first media-processing style as the second default value for the first parameter of the first media processing style (e.g., without displaying the representation of the current value for the first parameter and/or the second parameter in response to detecting the input directed to the selectable user interface object for resetting the one or more parameters of the first media-processing style). In some embodiments, a default value for the first parameter is different from a default value of the second parameter. In some embodiments, the selectable user interface object for resetting one or more parameters of first media-processing style is only displayed in accordance with a determination that the current value for the first parameter of the first media-processing style is a value that is not the default value for the first parameter and/or the current value for the second parameter of the second media-processing style is a value that is not the default value for the second parameter of the first media-processing style. In some embodiments, in response to detecting the input directed to the plurality of selectable user interface objects for the first media-processing style (and while displaying, via the display generation component, the first control for adjusting the current value for the first parameter and/or displaying, via the display generation component, the second control for adjusting the current value for the second parameter), the computer system displays the selectable user interface object for resetting the one or more parameters first media-processing style. In some embodiments, the first control for adjusting the current value for the first parameter is displayed concurrently with the selectable user interface object for resetting one or more parameters of the first media-processing style is displayed concurrently with the first control for adjusting the current value for the first parameter (or the second control for adjusting the current value for the second parameter). In some embodiments, plurality of selectable user interface objects for the first media-processing style is displayed concurrently with the selectable user interface object for resetting one or more parameters of the first media-processing style. In some embodiments, in response to detecting the input (e.g., 750w) directed to the selectable user interface object for resetting the one or more parameters of the first media-processing style, the computer system displays an animation of the current value for the first parameter of the first media-processing style changing (e.g., gradually changing over time) to the second default value for the first parameter of the first media-processing style (e.g., as discussed above in relation to FIGS. 7W-7X). In some embodiments, in response to detecting the input directed to the selectable user interface object for resetting the one or more parameters of the first media-processing style, the computer system displays an animation of the current value for the second parameter of the first media-processing style changing to the second default value for the second parameter of the first media-processing style. In some embodiments, the animation of the current value for the first parameter of the first media-processing style changing is displayed concurrently the animation of the current value for the second parameter of the first media-processing style changing. In some embodiments, in response to detecting the input directed to the selectable user interface object for resetting the one or more parameters of the first media-processing style, computer system displays an animation of the first control changing into the first user interface object for the first parameter. Displaying an animation of the current value for the first parameter of the first media-processing style changing to the second default value for the first parameter of the first media-processing style provides the user with feedback that the input directed to the selectable user interface object for resetting the one or more parameters of the first media-processing style has caused the current value for the first parameter of the first media-processing style to change, which provides improved visual feedback. Displaying (and/or setting) the representation of the current value for the first parameter of the first media-processing style and the current value for the first parameter of the first media-processing style as default values in response to detecting the input directed to the selectable user interface object for resetting the one or more parameters of the first media-processing style provides the user with the ability to reset a media-processing style via one input instead of multiple inputs, which reduces the number of inputs needed to perform an operation.

In some embodiments, the prompt (e.g., 768) is displayed with an indication (e.g., “reset to warm”, “reset to cool”, “reset to neutral”, reset to “rich” and/or “reset to soft”) of how at least one of the one or more parameters of the first media-processing style will be reset (e.g., an indication includes a characteristic (e.g., a word that indicates a characteristic) of a parameter, such as “warm and/or cold” being a characteristic of a “warmth” parameter and/or “soft” being a characteristic of a “tone” parameter). Displaying a prompt that includes an indication of how at least one of the one or more parameters of the first media-processing style will be reset provides visual feedback to the user that one or more parameters of the first media-processing style will be reset in a particular way and/or to a particular style if one or more additional inputs are received from the user, which improves visual feedback and reduces the performance of unintended operations.

In some embodiments, before detecting the input (e.g., 750w and/or 750w1) directed to the selectable user interface object (e.g., 722) for resetting the one or more parameters of the first media-processing style, the computer system displays a first styles-mode user interface object (e.g., 602b) that, when selected, causes (e.g., causes the computer system to toggles between) the representation to be displayed (e.g., a user interface object for displaying the style-selection user interface, and/or a user interface object that, when selected, causes the style-section user interface to be displayed) with a first selected media-processing style (634a-634d) applied or causes the representation to be displayed without the first selected respective media-processing style applied. In some embodiments, the first styles-mode user interface object is displayed with a first appearance e.g., 602b) that is based on the current value for the first parameter of the first media-processing style (e.g., using one or more techniques as described above in relation to the styles-mode user interface object and the second styles-mode user interface object described above in relation to method 900 and/or FIGS. 6L and 7C). In some embodiments, in response to detecting the input directed to the selectable user interface object for resetting the one or more parameters of the first media-processing style, the computer system displays an animation of the first styles-mode user interface object transitioning from being displayed with the first appearance (e.g., a visual appearance that has the first visual aspect and the second visual aspect as described above in relation to method 900 and/or FIGS. 6L and 7C) that is based on the current value for the first parameter of the first media-processing style to being displayed with a second appearance e.g., a visual appearance that has the first visual aspect and the second visual aspect as described above in relation to method 900 and/or FIGS. 6L and 7C) that is based on the second default value for the first parameter of the first media-processing style. In some embodiments, the animation is a gradual transition that occurs over period of time (e.g., 0.01-10 seconds). Displaying an animation of the first styles-mode user interface object transitioning from being displayed with the first appearance that is based on the current value for the first parameter of the first media-processing style to being displayed with the second appearance that is based on the second default value for the first parameter of the first media-processing style provides visual feedback to the user regarding how a resetting a media-processing style will change the media-processing style and that the media-processing style has changed, which provides improved visual feedback.

In some embodiments, while displaying the first control (e.g., 626a1, 626a2, 626b1, 626b2, 626c1, 626c2, 626d1, 626d2) for adjusting the current value for the first parameter and in response to detecting movement of an input (e.g., 750a, 750d, 750g, 750k, 750n, and/or 750t) (e.g., a tap input (e.g., a tap gesture) (e.g., a single tap input, a double tap input)) (and/or, in some embodiments, detecting a non-tap input/gesture (e.g., a movement input/gesture, a press-and-hold input/gesture, a voice input)) directed to the first control (e.g., and/or in response to detecting movement of the input directed to the plurality of selectable user interface objects for the first media-processing style), the computer system changes the current value (e.g., 626a1b, 626a2b, 626b1b, 626b2b, 626c1b, 626c2b, 626d1b, and/or 626d2b) for the first parameter from a third value for the first parameter to a fourth value for the first parameter (e.g., without changing the current value for the second parameter) (e.g., replacing the display of a representation of the third value for the first parameter to the display of the representation of the fourth value for the first parameter). In some embodiments, the input directed to the first control is the same as the input directed to the plurality of selectable user interface objects for the first media-processing style. In some embodiments, the third value is different from the fourth value. In some embodiments, while displaying the first control for adjusting the current value for the first parameter, the computer system detects movement of the input directed to the first control. In some embodiments, while displaying the second control for adjusting the current value for the second parameter and in response to detecting that movement of the input directed to the second control (e.g., and/or in response to detecting movement of the input directed to the plurality of selectable user interface objects for the first media-processing style), the computer system changes the current value for the second parameter from a third value for the second parameter to a fourth value for the second parameter (e.g., without changing the current value for the first parameter) (e.g., replacing the display of a representation of the third value for the first parameter to the display of the representation of the fourth value for the first parameter). In some embodiments, the input directed to the first control is the same as the input directed to the plurality of selectable user interface objects for the first media-processing style. In some embodiments, while displaying the second control for adjusting the current value for the second parameter, the computer system detects movement of the input directed to the second control. In some embodiments, the third value is different from the fourth value. Changing the current value for the first parameter from a third value for the first parameter to a fourth value for the first parameter in response to detecting that movement of an input directed to the first control provides the user with control over to what the current value for the first parameter is set based on movement of the input, which provides additional control options without cluttering the user interface.

In some embodiments, while displaying the first control for adjusting the current value for the first parameter and in response to detecting the movement of the input (e.g., 750a, 750d, 750g, 750k, 750n, and/or 750t) directed to the first control, the computer system displays (e.g., before and/or after detecting an end of the input directed to the first control) a second representation (e.g., 630) of media using a modified first media-processing style (e.g., 634a-634d). In some embodiments, the second representation of the media using the modified first media-processing style (e.g., 634aa, and/or 634dd) is different from the representation of the media using the first media-processing style. In some embodiments, the second representation of the media using the first media-processing style is displayed based on the changed value (e.g., fourth value) for the first parameter and the representation of the media using the first media-processing style is displayed based on the value before the input directed to the first control was detected (e.g., third value). In some embodiments, while displaying the second control for adjusting the current value for the second parameter and in response to detecting that movement of the input directed to the second control, the computer system displays (e.g., before and/or after detecting an end of the input directed to the second control) a third representation of media using the first media-processing style, where the third representation of the media using the first media-processing style is different form the representation of the media using the first media-processing style and the second representation of the media using the first media-processing style. Displaying a second representation of media using the first media-processing style, where the second representation of the media using the first media-processing style is different from the representation of the media using the first media-processing style in response to detecting that movement of the input directed to the first control provides the user with feedback concerning how the input impacted how the first media-processing style is applied to the representation of the media, which provides improved visual feedback.

In some embodiments, while displaying the representation (e.g., 630) of the media using the first media-processing style, the computer system detects a first request (e.g., 650a, 650c, 650j) to capture media. In some embodiments, in response to detecting the first request to capture media, the computer system captures first media. In some embodiments, while displaying the second representation (e.g., 630) of media using the modified first media-processing style, the computer system detects a second request to capture media. In some embodiments, in response to detecting the first request to capture media, the computer system captures second media. In some embodiments, after capturing the first media and the second media, the computer system: displays a representation (e.g., 680c) of the first media having the first media-processing style (e.g., as discussed above in relation to FIGS. 7A-7X); and displays a representation (e.g., 680d) of the second media having the modified first media-processing style (e.g., as discussed above in relation to FIGS. 7A-7X). In some embodiments, the computer system transitions from displaying the representation of the first media to displaying the representation of the second media (or vice-versa) in response to detecting an input (e.g., a movement input) (and/or, in some embodiments, in response to detecting a non-movement input (e.g., tap input, a rotation dragging gesture, and/or a press-and-hold gesture) directed to the representation of the first media (or an input (e.g., a movement input) (and/or, in some embodiments, in response to detecting a non-movement input (e.g., tap input, a rotation dragging gesture, and/or a press-and-hold gesture) directed to the representation of the second media). In some embodiments, the representation of the first media and the representation of the current media are displayed sequentially in a media viewer interface (e.g., FIGS. 6A-6U). In some embodiments, the representation of the first media and the representation of the second media are displayed concurrently in a media viewer interface and/or a media grid (e.g., amongst a plurality of other representations of media).

In some embodiments, the user interface includes a second selectable user interface object (e.g., 610) for capturing media. In some embodiments, while displaying the representation (e.g., 630) of the media using the first media-processing style (e.g., 634a-634d, 634aa, and/or 634dd) and the second selectable user interface object (e.g., 610) for capturing media, the computer system detects an input (e.g., a tap input (e.g., a tap gesture) (e.g., a single tap input, a double tap input)) (and/or, in some embodiments, in response to detecting a non-tap input/gesture (e.g., a movement input/gesture, a press-and-hold input/gesture, and/or a voice input)) directed to the second selectable user interface object for capturing media. In some embodiments, in response to detecting the input (e.g., 650a, 650c, 650j) directed to the second selectable user interface object for capturing media, the computer system captures third media that has the first media-processing style applied (e.g., based on the current value of the parameters of the first media-processing style). In some embodiments, in response to detecting the input directed to the selectable user interface object for capturing media and while detecting an input directed to the plurality of selectable user interface objects for the first media-processing style and/or detecting an input to directed to the representation (e.g., as request to switch media-processing styles, as described above in relation to method 900 and FIGS. 6A-6P), the computer initiates the capture of media that has a media-processing style applied that is applied to a more of a predetermined portion of the representation (e.g., 25%, 30%, 40% 50%, 60%, 75%) of media and/or greater portion of the representation of the media than other portions of the representation of the media that have another media-processing style applied (e.g., portions as described above in relation to method 900 and FIGS. 6A-6P) when (e.g., immediately before/after) the input directed to the selectable user interface object for capturing media was detected. Capturing media that has the first media-processing style applied in response to detecting the input directed to the second selectable user interface object for capturing media allows the user to capture media that will have the currently selected media-processing style applied, which provides additional control options without cluttering the user interface.

In some embodiments, as a part of displaying the representation using the first media-processing style, the computer system applies the first media-processing style differently (e.g., using a different set of visual parameters (e.g., color characteristics (e.g., warmth, tone, hue, brightness, saturation, shade, tint, colorfulness, coldness, and/or harmony) and/or depth parameters) for one type of identified object as compared to a different type of identified object (e.g., subjects (e.g., a person) as compared to non-subjects) to one or more objects (e.g., person shown in 630) (e.g., people and/or faces of people) (e.g., identifiable object) in the representation than to a portion of the first portion that does not include the one or more objects (e.g., displaying a first portion of the representation (e.g., a portion that includes an object) with a different visual appearance than a second portion of the representation (e.g., a subset that does not include an object)).

In some embodiments, while displaying the plurality of selectable user interface objects for the first media-processing style, the computer system detects, via the one or more input devices, a first input (e.g., 650d, 650k1, 650k2, 750j, and/or 750q) (e.g., a movement input) (and/or, in some embodiments, in response to detecting a non-movement input (e.g., tap input, a rotation dragging gesture, and/or a press-and-hold gesture) directed to the representation (e.g., 630) of the media. In some embodiments, in response to detecting the first input directed to the representation of the media, the computer system displays a representation (e.g., 626a1b, 626a2b, 626b1b, 626b2b, 626c1b, 626c2b, 626d1b, and/or 626d2b) of a current value for a first parameter of a fourth media-processing style and ceasing to display the representation (e.g., 626a1b, 626a2b, 626b1b, 626b2b, 626c1b, 626c2b, 626d1b, and/or 626d2b) of the current value for the first parameter for the first media-processing style. In some embodiments, in response to detecting the first input directed to the representation of the media, the computer system displays a portion of the representation of the media using the fourth media-processing style (e.g., a portion of the representation of the media that was displayed using the first media-processing style before the input directed to the representation of the media was detected). In some embodiments, in response to detecting the first input directed to the representation of the media, the computer system displays a representation of a current value for a second parameter of the fourth media-processing style and ceases to display the representation of the current value for the second parameter for the first media-processing style. In some embodiments, as a part of displaying the representation of the current value for the first parameter of the fourth media-processing style, the computer system displays an animation (e.g., a sliding animation, a dissolving animation, and/or a fading in/out animation) that changes the representation (e.g., 626a1b, 626a2b, 626b1b, 626b2b, 626c1b, 626c2b, 626d1b, and/or 626d2b) of the current value for the first parameter for the first media-processing style into the representation (e.g., 626a1b, 626a2b, 626b1b, 626b2b, 626c1b, 626c2b, 626d1b, and/or 626d2b) of the current value for the first parameter for the fourth media-processing style. In some embodiments, as a part of displaying the representation of the current value for the second parameter of the fourth media-processing style, the computer system displays an animation (e.g., a gradual animation over time) that changes the representation of the current value for the second parameter for the first media-processing style into the representation of the current value for the second parameter for the fourth media-processing style. Displaying an animation that changes the representation of the current value for the first parameter for the first media-processing style into the representation of the current value for the first parameter for the fourth media-processing style provides the user with visual feedback that the user interface objects for the first media-processing are changing into the user interface objects for the fourth media-processing style, which can possibly reduce potential mistakes, which provides improved visual feedback. Displaying a representation of a current value for a first parameter of a fourth media-processing style and ceasing to display the representation of the current value for the first parameter for the first media-processing style in response to detecting the first input directed to the representation of the media allows the computer system to source relevant user interface objects that pertain to the media-processing style that is being applied to representation of media without sourcing user interface objects that do not pertain to the media-processing style that is being applied to representation of media, which performs an operation when a set of conditions has been met without requiring further user input and provides improved visual feedback.

In some embodiments, while displaying the plurality of selectable user interface objects (e.g., 626a1, 626a2, 626b1, 626b2, 626c1, 626c2, 626d1, 626d2) for the first media-processing style, the computer system detects, via the one or more input devices, a second input (e.g., 650d, 650k1, 650k2, 750j, and/or 750q) directed to the representation of the media. In some embodiments, in response to detecting the second input directed to the representation of the media, the computer system displays a portion of the representation of the media using a fifth media-processing style (e.g., 634a-634d, 634aa, and/or 634dd) (e.g., a portion of the representation of the media that was displayed using the first media-processing style before the input directed to the representation of the media was detected). In some embodiments, while displaying the portion of the representation of the media using the fifth media-processing style and in accordance with a determination that the portion of the representation of the media using the fifth media-processing style is greater than a threshold amount (e.g., 25%, 30%, 40%, 50%, 51%, 60%, or 75%) of the representation (e.g., 630) (and/or display generation component) (and/or is located at a particular portion (e.g., middle of) of the representation and/or the display generation component), the computer system displays a representation (e.g., 626a1b, 626a2b, 626b1b, 626b2b, 626c1b, 626c2b, 626d1b, and/or 626d2b) of a current value for a first parameter of the fifth media-processing style and ceasing to display the representation (e.g., 626a1b, 626a2b, 626b1b, 626b2b, 626c1b, 626c2b, 626d1b, and/or 626d2b) of the current value for the first parameter for the first media-processing style. In some embodiments, while displaying the portion of the representation of the media using the fifth media-processing style and in accordance with a determination that the portion of the representation of the media using the fifth media-processing style is not greater than a threshold amount (e.g., 25%, 30%, 40%, 50%, 51%, 60%, or 75%) of the representation (and/or display generation component) (and/or is located at a particular portion (e.g., middle of) of the representation and/or the display generation component), the computer system continues to display the representation of the currently value for the first parameter for the first media-processing style and forgoes displaying the representation of a current value for a first parameter of a fifth media-processing style. Displaying a representation of a current value for a first parameter of a fifth media-processing style and ceasing to display the representation of the current value for the first parameter for the first media-processing style when prescribed conditions are met allows the computer system to source relevant user interface objects that pertain to the media-processing style that is being applied to representation of media without sourcing user interface objects that do not pertain to the media-processing style that is being applied to representation of media, which performs an operation when a set of conditions has been met without requiring further user input and provides improved visual feedback.

In some embodiments, in response to detecting the input (e.g., 750a, 750d, 750g, 750k, and/or 750t) directed to the plurality of selectable user interface objects (e.g., 626a1, 626a2, 626b1, 626b2, 626c1, 626c2, 626d1, 626d2) for the first media-processing style (e.g., and in accordance with a determination that at least one current value (e.g., represented by 626a1b, 626a2b, 626b1b, 626b2b, 626c1b, 626c2b, 626d1b, and/or 626d2b) for one or more parameters of the first media-processing style is different from (e.g., and/or substantially different from) one or more default values for the one or more parameters of the first media-processing style (e.g., 634a and/or 634d)), the computer system adds a first custom media-processing style (e.g., 634aa and/or 634dd) (e.g., a custom media-processing style that corresponds to (e.g., that is a modified version of the first media-processing style that shares a set of parameters with the first media-processing style, but that is different from the first media-processing style in at least one other parameter) the first media-processing style) that is different from the first media-processing style to a set of available media-processing styles (e.g., 634a-634d). In some embodiments, the user interface includes one or more indications corresponding to one or more media-processing styles. In some embodiments, the one or more indications includes a first indication corresponding to the first media-processing style. In some embodiments, the computer system, in response to detecting the input directed to the plurality of selectable user interface objects for the first media-processing style and in accordance with a determination that at least one current value for one or more parameters of the first media-processing style is different from one or more default values for the one or more parameters of the first media-processing style, displays a plurality of selectable user interface objects corresponding to a first custom media-processing style (e.g., a custom media-processing style that corresponds to the first media-processing style) that is different from the first media-processing style; and adds a second indication corresponding to the first custom media-processing style to the one or more indications (e.g., display the second indication, display the second indication as being a part of (e.g., among, in-line with) the one or more indications). In some embodiments, adding the first custom media-processing style includes configuring the first custom media-processing styles to be available for future use (e.g., in other user interfaces, after exiting/closing an application, after a certain time period has passed where the first custom media-processing style would not be available for use if it was not configured to be available for future use. Adding the first custom media-processing style to the set of available media-processing styles when prescribed conditions are met allows a user to reuse a customized style without providing inputs to remake the style and prevents the user from editing a non-customized media-processing style, which reduces the number of inputs needed to perform an operation.

In some embodiments, while the set of available media (e.g., 634a-634d, 634aa, and/or 634dd) processing styles includes the first custom media-processing style, the computer system detects a first request (e.g., 750n and/or 750w) to change one or more parameters of the first custom media-processing style. In some embodiments, the computer system, in response to detecting the first request to change the one or more parameters of the first custom media-processing style (e.g., and in accordance with a determination that the first custom media-processing style would be, after the first request is implemented, the same as (or substantially the same as) one or more other available media-processing styles) (e.g., in the set of available media-processing styles) (e.g., one or more parameters of the first custom media-processing style are the same as one or more parameters of one or more of the other available media-processing styles), removes the first custom media-processing style (e.g., 634aa and/or 634dd) from the set of available media-processing styles (e.g., cease to display the second indication, and/or cease to display the second indication as being a part of (e.g., among, in-line with) the one or more indications). In some embodiments, while the one or more indications includes the second indication corresponding to the first custom media-processing style that is different from the first media-processing style and while displaying the plurality of selectable user interface objects for the first custom media-processing style, the computer system detects, via the one or more input devices, a first input directed to the plurality of selectable user interface objects for the first custom media-processing style, the computer system detects, via the one or more input devices, a first input directed to the plurality of selectable user interface objects for the first custom media-processing style. In some embodiments, in response to detecting the first input and in accordance with a determination that the first custom media-processing style is the same as (or substantially the same as) one or more other available media-processing styles in the set of available media-processing styles, the computer system removes the second indication corresponding to the first custom media processing style. In some embodiments, removing the first custom media-processing style includes configuring the first custom media-processing styles to not be available for future use (e.g., in other user interfaces, after exiting/closing an application, after a certain time period has passed where the first custom media-processing style would not be available for use if it was not configured to be available for future use). Removing the first custom media-processing style from the set of available media-processing styles when prescribed conditions are met allows the computer system to automatically remove styles that may be duplicative and/or are not needed, which reduces the number of inputs needed to perform an operation.

In some embodiments, after adding the first custom media-processing style (e.g., 634aa and/or 634dd) to the set of available media-processing styles (e.g., 634a-634d, 634aa, and/or 634dd), the computer system displays a respective user interface that includes a respective representation (e.g., 630) of media that is displayed using a respective media-processing style (e.g., 634a and/or 634d).

In some embodiments, while displaying the respective user interface that includes the respective representation (e.g., 630) of media that is displayed using the respective media-processing style (e.g., 634a and/or 634d) and while the set of available media-processing styles includes the first custom media-processing style (e.g., 634aa and/or 634dd), the computer system detects a request to display the respective representation of media using a next (or previous) available media-processing style from the set of available media-processing styles. In some embodiments, as a part of detecting a request to display the representation of media using a next available media-processing style from the set of available media-processing styles includes, the computer system detects an input on the respective user interface (e.g., as described above). In some embodiments, in response to detecting the request (e.g., 7500) to display the respective representation of media using the next (e.g., or previous) available media-processing style while the respective representation of media is displayed using the respective media-processing style, the computer system: in accordance with a determination that the respective media-processing style is the first media-processing style, displays at least a portion of the respective representation of the media using the first custom media-processing style (e.g., 634aa and/or 634dd); and in accordance with a determination that the respective media-processing style is not the first media-processing style, forgoes displaying at least a portion of the respective representation of the media using the first custom media-processing style (e.g., 634aa and/or 634dd) (e.g., as discussed above in relation to FIGS. 7O-7P). In some embodiments, after removing the first custom media-processing style, the computer displays the respective user interface that includes the respective representation of media that is displayed using the first media-processing style. In some embodiments, while displaying user interface that includes the respective representation of media that is displayed using the first media-processing style and while the set of available media-processing styles does not the first custom media-processing style, the computer system detects a request to display the representation of media using the next available media-processing style. In some embodiments, in response to detecting the request to display the representation of media using the next available media-processing style, the computer system displays at least a portion of the representation of the media using the first custom media-processing style. In some embodiments, the one or more indications includes a third indication that corresponds to a sixth media-processing style. In some embodiments, the one or more indications are displayed such that the second indication is adjacent (e.g., next to, closer to, to the right of, to the left of, above, and/or below) to the first indication and not adjacent to the third indication. Displaying at least a portion of the representation of the media using the first custom media-processing style (e.g., when prescribed conditions are met) provides the user with feedback that the first custom photographic style is a customized style for the first media-processing style and not the other media-processing style, which provides improved visual feedback.

In some embodiments, while the set of available media processing styles includes the first custom media-processing style (e.g., 634aa and/or 634dd), the computer system detects a second request (e.g., 750a, 750d, 750g, 750k, and/or 750t) to change one or more parameters of the first custom media-processing style. In some embodiments, in response to detecting the second request to change the one or more parameters of the first custom media-processing style (e.g., and in accordance with a determination that the first custom media-processing style, after implementing the second request, is not the same as (or substantially the same as) one or more other available media-processing styles), the computer system updates the one or more parameters of first custom media-processing style (e.g., represent by 626a1, 626a2, 626b1, 626b2, 626c1, 626c2, 626d1, and/or 626d2) (e.g., as discussed above in relation to input 750a and/or input 750t) (and continues to include the first custom media-processing style in the set of available media-processing styles (e.g., without including the an additional custom media-processing style in the set of available media-processing styles)). In some embodiments, while the one or more indications includes the second indication corresponding to the first custom media-processing style that is different from the first media-processing style and while displaying the plurality of selectable user interface objects for the first custom media-processing style, the computer system detects, via the one or more input devices, a second input directed to the plurality of selectable user interface objects for the first custom media-processing style. In some embodiments, in response to detecting the second input directed to the plurality of selectable user interface objects for the first custom media-processing style and in accordance with a determination that the current value for the first parameter of the first custom media-processing style has changed (e.g., and at least one current value for one or more parameters of the first custom media-processing style is different from one or more default values for the one or more parameters of the first media-processing style) (e.g., has been changed via the second input and/or one or more inputs directed to the first control), the computer system does not add a fourth indication to the one or more indications (e.g., continuing to display the same number of indications that were displayed before the second input directed to the plurality of selectable user interface objects for the first custom media-processing style was detected) and updates the current value for the first parameter of the first custom media-processing style based on the second input directed to the plurality of selectable user interface objects for the first custom media-processing style. In some embodiments, in response to detecting the second input directed to the plurality of selectable user interface objects for the first custom media-processing style and in accordance with a determination that a current value for a first parameter of the first custom media-processing style has changed, the computer system continues to include the second indication as a part of the one or more indications corresponding to the first custom media-processing style (e.g., continuing to display the second indication). Updating the one or more parameters of the first custom media-processing style in response to detecting the second request to change the one or more parameters of the first custom media-processing style reduces the number inputs needed to navigate through the set of available media-processing styles and reduces the number of inputs needed to re-configure the first custom media-processing style after the one or more parameters have been updated, which reduces the number of inputs needed to perform one or more operations.

In some embodiments, while the set of available media processing styles includes the first custom media-processing style, the computer system detects a third request (e.g., 750a and/or 750t) to change one or more parameters of the first custom media-processing style (e.g., as discussed above in relation to input 750a and/or input 750t). In some embodiments, in response to detecting the third request to change the one or more parameters of the first custom media-processing style (e.g., and in accordance with a determination that the first custom media-processing style, after implementing the third request, is not the same as (or substantially the same as) one or more other available media-processing styles), the computer system adds a second custom media-processing style (e.g., for/that corresponds to the first media-processing style) to the set of available media-processing styles without updating the one or more parameters of the first custom media-processing style (e.g., as discussed above in relation to input 750a and/or input 750t) (and/or one or more parameters of the first media processing style). In some embodiments, while the one or more indications includes the second indication corresponding to the first custom media-processing style that is different from the first media-processing style and while displaying the plurality of selectable user interface objects for the first custom media-processing style, the computer system detects, via the one or more input devices, a second input (e.g., a tap input (e.g., a tap gesture) (e.g., a single tap input, a double tap input)) (and/or, in some embodiments, detecting a non-tap input/gesture (e.g., a movement input/gesture, a press-and-hold input/gesture, and/or a voice input)) directed to the plurality of selectable user interface objects for the first custom media-processing style. In some embodiments, in response to detecting the second input directed to the plurality of selectable user interface objects for the first custom media-processing style and in accordance with a determination that the current value for the first parameter of the first custom media-processing style has changed (e.g., and at least one current value for one or more parameters of the first custom media-processing style is different from one or more default values for the one or more parameters of the first media-processing style) (e.g., has been changed via the second input and/or one or more inputs directed to the first control), the computer system: adds a fifth indication to the one or more indications corresponding to a second respective media-processing style that is different from the first custom media-processing style (e.g., continuing to display the second indication); and updates a current value for a first parameter of the second custom media-processing style based on the second input directed to the plurality of selectable user interface objects for the first custom media-processing style (e.g., while forgoing updating the current value for the first parameter of the first custom media-processing style based on the second input directed to the plurality of selectable user interface objects for the first custom media-processing style and without updating the current value for the first parameter of the first custom media-processing style based on the second input directed to the plurality of selectable user interface objects for the first custom media-processing style). In some embodiments, in response to detecting the second input directed to the plurality of selectable user interface objects for the first custom media-processing style and in accordance with a determination that a current value for a first parameter of the first custom media-processing style has not changed, the computer system continues to include the second indication as a part of the one or more indications corresponding to the first custom media-processing style (e.g., continuing to display the second indication). In some embodiments, the first custom media-processing style and the second custom media-processing style are both between the first media-processing style and the second media-processing style in the set of available media-processing styles. Adding a second custom media-processing style to the set of available media-processing styles without updating the one or more parameters of the first custom media-processing style in response to detecting the third request to change the one or more parameters of the first custom media-processing style reduces the number of inputs needed to re-configure the first custom media-processing style, which reduces the number of inputs needed to perform one or more operations and provides the user with additional options to reduce the need to repeatedly reconfigure the photographic styles.

In some embodiments, the first custom media-processing style (e.g., 634aa and/or 634dd) and the second custom media-processing style (e.g., 634aa and/or 634dd) have a same respective text identifier (e.g., 636aa and/or 636dd) (e.g., a description or a name (e.g., vibrant warm, vibrant cool, warm, cool, neutral, soft warm, soft cool, vibrant, and/or soft)). In some embodiments, while displaying the user interface that includes the representation (e.g., 630) of media and in accordance with a determination that the first custom media-processing style (e.g., 634aa and/or 634dd) is being applied to the representation of the media, the computer displays the same respective text identifier concurrently with an indication (e.g., 626a and/or 626d) of a parameter for the first custom media-processing style. In some embodiments, while displaying the user interface that includes the representation (e.g., 630) of media and in accordance with a determination that the second custom media-processing style is being applied to the representation of the media, the computer system displays the same respective text identifier (e.g., 636aa and/or 636dd) concurrently with an indication (e.g., 626a and/or 626b) of the parameter for the second custom media-processing style (e.g., 634aa and/or 634dd). In some embodiments, the indication of the parameter for the first custom media-processing style is different from (e.g., a different value from) the indicator of the parameter for the second custom media-processing style (e.g., as discussed above in relation to FIGS. 7C, 7D, and 7M). Displaying the same respective identifier concurrently with an indication of the parameter for a particular media-processing style (e.g., a media-processing style that has the same identifier as another media-processing style) provides visual feedback that lets a user identify which media-processing style is being applied (e.g., and/or the difference with respective to how media-processing styles with the same identifier are being applied), which provides improved visual feedback.

In some embodiments, in response to detecting the input (e.g., 750a, 750d, 750g, 750k, and/or 750t) (e.g., directed to the plurality of selectable user interface objects for the first media-processing style and in accordance with a determination that at least one current value for one or more parameters of the first media-processing style is different from (e.g., and/or substantially different from) one or more default values for the one or more parameters of the first media-processing style: in accordance with a determination that a first difference between the at least one current value for the one or more parameters of the first media-processing style (e.g., 634a-634d, 634aa, and/or 634dd) and the one or more default values for the one or more parameters of the first media-processing style is a first difference (e.g., a positive and/or negative amount (e.g., a value between −100 to 100) of difference) (e.g., as described above in relation to FIGS. 7C and 7F), the computer system displays a first text identifier (e.g., 636aa and/or 636dd) (e.g., a description or a name such as vibrant warm, vibrant cool, warm, cool, neutral, soft warm, soft cool, vibrant, and/or soft) for the first custom media-processing style (e.g., 634aa and/or 634dd) (e.g., where the first identifier is based on the one or more parameters and/or the first difference); and in accordance with a determination that a difference between the at least one current value for the one or more parameters of the first media-processing style (e.g., 634a-634d, 634aa, and/or 634dd) and the one or more default values for the one or more parameters of the first media-processing style is a second difference (e.g., a positive and/or negative amount (e.g., a value between −100 to 100) of difference) that is different (e.g., is a different value) from the first difference (e.g., as described above in relation to FIGS. 7C and 7F), the computer system displays a second text identifier (e.g., a description or a name such as vibrant warm, vibrant cool, warm, cool, neutral, soft warm, soft cool, vibrant, and/or soft) for the first custom media-processing style (e.g., 634aa and/or 634dd). In some embodiments, the second text identifier (e.g., 636aa and/or 636dd) is different from the first text identifier (e.g., 636aa and/or 636dd)) (e.g., as described above in relation to FIGS. 7C and 7F). Displaying an identifier based on a difference between the at least one current value for the one or more parameters of the first media-processing style and the one or more default values for the one or more parameters of the first media-processing style provides visual feedback that informs the user how the changed version of the media-processing style is different from the default version of the media-processing style, which provides improved visual feedback.

In some embodiments, the first media-processing style (e.g., 634a-634d, 634aa, and/or 634dd) has a third text identifier that is different from the first text identifier and the second text identifier (e.g., as described above in relation to FIGS. 7W, 7W1, and/or 7X). In some embodiments, while the set of available media processing styles includes the first custom media-processing style, the computer system detects a third request (e.g., 750n, 750w and/or 750w1) to change one or more parameters of the first custom media-processing style. In some embodiments, in response to detecting the third request to change the one or more parameters of the first custom media-processing style and in accordance with a determination that the first custom media-processing style would be, after the first request is implemented, the same as (or substantially the same as) one or more other available media-processing styles (e.g., the first media-processing style) (e.g., in the set of available media-processing styles) (e.g., one or more parameters of the first custom media-processing style are the same as one or more parameters of one or more of the other available media-processing styles) (e.g., and/or in response to detecting a request to reset the first custom media-processing style (e.g., in response to detecting the input directed to the selectable user interface object for resetting the one or more parameters of the first media-processing style)), the computer system displays the third text identifier (e.g., 636a-636d, 636aa, and/or 636dd) (e.g., without displaying the first identifier and the second identifier) (e.g., as described above in relation to FIGS. 7W, 7W1, and/or 7X). In some embodiments, when custom media-processing style is reset, the computer system changes the styles name back to its original name. Displaying the third identifier (e.g., the identifier of a media-processing style from which the media-processing style changed) provides visual feedback that informs the user of the media-processing style that created the media-processing style, which provides improved visual feedback.

In some embodiments, the plurality of selectable user interface objects (e.g., 626a1b, 626a2b, 626b1b, 626b2b, 626c1b, 626c2b, 626d1b, and/or 626d2b) for the first media-processing style are displayed in response to detecting the request (e.g., 650b) to edit the first media-processing style (e.g., and while displaying the representation of the media that is displayed using the first media-processing style). In some embodiments, before displaying the plurality of selectable user interface objects, the computer system detects, via one or more inputs devices, a request to edit the first media-processing style (e.g., that is being applied to the visual content of the media) (e.g., a request to edit how the first media-processing style is being applied to the visual content). In some embodiments, as a part of detecting the request to edit the first media-processing style, the computer system detects a movement input (e.g., and/or, in some embodiments, a non-movement input, such as a press-and-hold input, a pinching input, etc.) on the representation of the media (e.g., as described above in relation to as described above in relation to method 900 and FIGS. 6A-6C). In some embodiments, as a part of detecting the request to edit the first media-processing style, the computer system detects a tap input (and/or a non-tap input, such as a press-and-hold input, a pinching input, etc.) on a user interface object for displaying a representation of the first media-processing style (e.g., as described above in relation to method 900 and FIGS. 6A-6C). In some embodiments, in response to detecting the request to edit the first media-processing style (e.g., and while displaying the representation of the media that is displayed using the first media-processing style), the computer system concurrently displays the plurality of selectable user interface objects. In some embodiments, a respective customize style for one media-processing style is displayed and/or included in a set of available media-processing style, even if the parameters for the respective customized style match another media-processing style in the available set of media-processing styles.

In some embodiments, the user interface including the representation (e.g., 630)) of the media includes a second styles-mode user interface object (e.g., 602b) that, when selected, causes (e.g., causes the computer system to toggles between) the representation to be displayed (e.g., a user interface object for displaying the style-selection user interface, and/or a user interface object that, when selected, causes the style-section user interface to be displayed) with a second selected media-processing style applied (e.g., or causes the representation to be displayed to be displayed without the second selected media-processing style applied). In some embodiments, the computer system detects a respective input (e.g., 750a, 750d, 750g, 750k, 750n, 750r, 750t, 750w, and/or 750w1) (e.g., a movement input (e.g., a swipe gesture and/or a dragging gesture)) (and/or, in some embodiments, in response to detecting a non-movement input (e.g., tap input, a press-and-hold gesture, and/or a voice input) (e.g., while to the first control for adjusting the current value for the first parameter or while the second control for adjusting the current value for the second parameter is displayed). In some embodiments, in response to detecting the respective input and in accordance with a determination that the respective input is directed to the first control for adjusting the current value for the first parameter, the computer system changes a first appearance g., a color, a size, with a first border (e.g., line (e.g., that is shown in a clockwise and/or counter-clockwise direction) surrounding the second styles-modes user interface object, where in the line surrounds and/or is around a portion (e.g., 0%-100%) of the second styles-mode user interface object)) (e.g., as described above in relation to method 900) of the second styles-mode user interface object (e.g., 602b) (e.g., displaying the second styles-mode user interface object with an appearance that was not displayed before the respective input was detected) (e.g., as described above in relation to FIGS. 6L, 7C, and/or 7M). Changing the first appearance of the second styles-mode user interface object in response to detecting the respective input and in accordance with a determination that the respective input is directed to the first control for adjusting the current value for the first parameter provides visual feedback that informs the user that the input has caused a change to how a media-processing style is being applied to the representation of the media, which provides improved visual feedback. In some embodiments, the first appearance of the second styles-mode user interface object (e.g., 602b) is changed gradually as the current value for the first parameter is modified (e.g., as described above in relation to FIGS. 6L, 7C, and/or 7M) (e.g., changed). In some embodiments, the respective input has a first magnitude (e.g., speed and/or acceleration). In some embodiments, the appearance of the second styles-mode user interface object is changed at a second magnitude that is based on the first magnitude. In some embodiments, as the respective input is moved and/or accelerates faster (e.g., or, alternatively, slower), the appearance of the second styles-mode user interface object is moved and/or accelerated at a faster (e.g., or, alternatively, slower) speed. Changing the first appearance of the second styles-mode user interface object gradually in response to detecting the respective input and in accordance with a determination that the respective input is directed to the first control for adjusting the current value for the first parameter provides visual feedback that informs the user that the input has caused a change to how a media-processing style is being applied to the representation of the media while reducing visual distractions that can be caused when abruptly changing user interface elements, which provides improved visual feedback.

In some embodiments, as a part of changing the first appearance of the second styles-mode user interface object, in accordance with a determination that the respective input is in a first direction (e.g., up/down/right/left direction), the computer system updates a first visual aspect (e.g., a line around the perimeter of 602b and/or the color of 602b) of the second styles-mode user interface object (e.g., 602b) (e.g., a color, a shading, and/or a tint of at least a portion (and, in some embodiments, the portion includes the border (e.g., a line surrounding) of the second media-processing style)) in a first manner (e.g., as discussed in relation to FIGS. 6F and 6L). In some embodiments, as a part of changing the first appearance of the second styles-mode user interface object, in accordance with a determination that the respective input is in a second direction that is different from the first direction (e.g., up/down/right/left direction), the computer system updates the first visual aspect in a second manner that is different from the first manner (e.g., as discussed in relation to FIGS. 6F and 6L). In some embodiments, the first manner is opposite of the second manner. In some embodiments, as a part of updating the first visual aspect in the first manner, the computer system increases (or, alternatively, decreases) the length and/or size of the first visual aspect (e.g., in a clockwise direction), and, as a part of updating the first visual aspect in the second manner, the computer system decreases (or, alternatively, increases) the length and/or size of the first visual aspect (e.g., in a counter-clockwise direction). In some embodiments, as a part of updating the first visual aspect in the first manner, the computer system adds more of a first color (e.g., red and/or black) and/or removes more of a second color (e.g., blue and/or white) from the second styles-mode user interface object, where the second color is different from the first color. In some embodiments, as a part of updating the first visual aspect in the second manner, the computer system adds more of the second color (e.g., red and/or black) and/or removes more of the first color (e.g., blue and/or white) from the second styles-mode user interface object. Updating the first visual aspect in a manner that is based on the direction of the respective input provides visual feedback that informs the user about how the first input is changing a parameter of a media-processing style, which provides improved visual feedback.

In some embodiments, as a part of changing the first appearance of the second styles-mode user interface object (e.g., 602b), the computer system displays the second styles-mode user interface object with a visual element that is an open shape (e.g., as shown by 602b in FIGS. 7C-7F) that has an opening. In some embodiments, in accordance with a determination that the respective input has set a second current value for the first parameter (e.g., 626a1 and/or 626a2) to a maximum value (e.g., 100, 150, 200, 256, and/or 300) for the first parameter, the opening (e.g., a gap) is on a first side (e.g., a side with respect to the midpoint, center, and/or origin of the shape) (e.g., a left side) of the open shape (e.g., without having an opening on the second side of the open shape) (e.g., as described above in relation to FIGS. 7C-7F). In some embodiments, in accordance with a determination that the respective input has set the second current value for the first parameter to a minimum value (e.g., 100, 150, 200, 256, and/or 300) for the first parameter that is different from the maximum value for the first parameter, the opening is on a second side (e.g., a side with respect to the midpoint, center, and/or origin of the shape) (e.g., a right side) of the open shape (e.g., without having an opening on the second side of the first open shape) that is different from the first side (e.g., without having an opening on the first side of the open shape) e.g., as shown by 602b in FIGS. 7C-7F). Displaying visual element that is an open shape, where the shape has an opening that is displayed on a different side based on whether the second current value is a minimum or a maximum value for the first parameter provides the user with visual feedback regarding the direction (e.g., clockwise direction and/or counter-clockwise direction) that the visual element progressed before reaching a position that indicates the minimum or maximum value for the first parameter, which provides improved visual feedback.

In some embodiments, as a part of changing an appearance of the second styles-mode user interface object (602b), the computer system changes display of a third visual aspect (e.g., a color of 602b and/or a line of 602b (e.g., as discussed above in relation to FIGS. 6F, 6L, 7C, 7D, and/or 7M) (e.g., a color, a shading, and/or a tint of at least a portion (and, in some embodiments, the portion includes the border (e.g., a line surrounding) of the second media-processing style)) of the second styles-mode user interface object (e.g., without changing the second visual aspect of the second styles-mode user interface object based on the determination that the value of the first parameter of the first media-processing style is different from the value of the first parameter of the second media-processing style).

In some embodiments, in response to detecting the respective input and in accordance with a determination that the respective input (e.g., 750a, 750d, 750g, 750k, 750n, 750r, and/or 750t) is directed to the first control for adjusting the current value for the first parameter (e.g., 626a1c and/or 626a2c), the computer system changes a second appearance (e.g., color and/or line surrounding 602b) (e.g., g., a color, a size, with a first border (e.g., line (e.g., that is shown in a clockwise and/or counter-clockwise direction) surrounding the second styles-modes user interface object, where in the line surrounds and/or is around a portion (e.g., 0%-100%) of the second styles-mode user interface object)) (e.g., as described above in relation to method 900 and/or FIGS. 6F and 6L) of the second styles-mode user interface object. In some embodiments, as a part of changing the second appearance of the second styles-mode user interface object, the computer system changes display of a fourth visual aspect (e.g., a size, a length, and/or a fill of at least a portion (e.g., a borderline and/or line that is around, adjacent to, and/or surrounds the second styles-mode user interface object) of the second media-processing style) of the second styles-mode user interface object. In some embodiments, the fourth visual aspect (e.g., a border and/or a line (e.g., or vice-versa)) is different from the third visual aspect (e.g., a color (e.g., or vice-versa)). Changing display of a particular visual element of the second styles-mode user interface object based on whether a value of a particular parameter has been changed, provides visual feedback to the user regarding which parameter has been changed for a media-processing style (and which parameter(s) have not been changed), which provides improved visual feedback.

Note that details of the processes described above with respect to method 1000 (e.g., FIGS. 10A-10B) are also applicable in an analogous manner to the methods described herein. For example, method 1000 optionally includes one or more of the characteristics of the various methods described above with reference to method 900. For example, method 900 can be used to select one or more media-processing styles and method 1000 can be used to edit the media that was selected using method 900. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery to users of media-processing styles or any other media editing tools that may be of useful for them. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to media-processing styles that are useful to a user. Accordingly, use of such personal information data enables users to have calculated control of the delivered media-processing styles and/or the media-processing styles that are initially available to the user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of providing media-processing styles to users, the present technology can be configured to allow users to select to “opt in” or “opt out” of participation in the collection of personal information data during registration for services or anytime thereafter. In another example, users can select not to share date regarding their customized media-processing styles, including media that they have captured on their personal devices. In yet another example, users can select to limit the length of captured media that is maintained or entirely prohibit the accessing of captured media. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, media-processing styles can be generated and made available based on non-personal information data or a bare minimum amount of personal information, such as the content being requested by the device associated with a user, other non-personal information available to the media editing and/or capturing, or publicly available information.

What is claimed is:

1. A computer system configured to communicate with a display generation component and one or more input devices, comprising:
one or more processors; and
memory storing one or more programs configured to be executed by the one or more processors, the one or more programs including instructions for:
displaying, via the display generation component, a style-selection user interface that includes a representation of media, wherein a first portion of the representation and a second portion of the representation are displayed using a first media-processing style that is applied to visual content of the media, and wherein before detecting an input directed to the representation, the style-selection user interface includes at least one selectable user interface object for modifying a respective parameter of the first media-processing style;
while the first portion of the representation and the second portion of the representation are displayed using the first media-processing style, detecting, via the one or more input devices, the input directed to the representation; and
in response to detecting the input directed to the representation and in accordance with a determination that the input is in a first direction, displaying, via the display generation component, the first portion of the representation using a second media-processing style while continuing to display the second portion of the representation using the first media-processing style, including:
in response to detecting a first portion of the input directed to the representation, wherein the first portion of the input has a first input magnitude, displaying the first portion of the representation using the second media-processing style while the second portion of the representation and a third portion of the representation that is between the first portion of the representation and the second portion of the representation are displayed using the first media-processing style; and
after displaying the first portion of the representation using the second media-processing style while the second portion of the representation and the third portion of the representation are displayed using the first media-processing style and in response to detecting a second portion of the input directed to the representation, wherein the second portion of the input has a second input magnitude that is greater than the first input magnitude, displaying the first portion of the representation and the third portion of the representation using the second media-processing style while the second portion of the representation is displayed using the first media-processing style.

2. The computer system of claim 1, wherein, before detecting the input directed to the representation, the first portion of the representation and the second portion of the representation are not displayed using the second media-processing style.

3. The computer system of claim 1, wherein the first media-processing style is different from the second media-processing style.

4. The computer system of claim 1, wherein, in response to detecting the first portion of the input directed to the representation, the second portion of the representation and the third portion of the representation are not displayed using the second media-processing style.

5. The computer system of claim 1, wherein an amount of the representation to which the second media-processing style is applied is based on an amount of movement of the input directed to the representation.

6. The computer system of claim 1, the one or more programs further including instructions for:
in response to detecting an end of the input directed to the representation:
in accordance with a determination that more than a predetermined portion of the representation was displayed using the first media-processing style when the end of the input directed to the representation was detected, displaying the first portion of the representation using the first media-processing style; and
in accordance with a determination that less than the predetermined portion of the representation was displayed using the first media-processing style when the end of the input directed to the representation was detected, displaying the first portion of the representation using the second media-processing style.

7. The computer system of claim 1, the one or more programs further including instructions for:
in response to detecting the input directed to the representation and in accordance with a determination that the input is in a second direction that is different from the first direction, displaying the second portion of the representation using a third media-processing style while continuing to display the first portion of the representation using the first media-processing style, wherein the third media-processing style is different from the first media-processing style and the second media-processing style.

8. The computer system of claim 1, the one or more programs further including instructions for:
in response to detecting the input directed to the representation:
in accordance with a determination that the input is in the first direction, displaying a visual element corresponding to a fourth media-processing style; and
in accordance with a determination that the input is in a third direction that is different from the first direction, displaying a visual element corresponding to a fifth media-processing style that is different from the fourth media-processing style.

9. The computer system of claim 1, wherein, before detecting the input directed to the representation, the style-selection user interface includes a visual element corresponding to the second media-processing style and a visual element corresponding to a sixth media-processing style, the one or more programs further including instructions for:
in response to detecting the input directed to the representation:
in accordance with a determination that the input is in the first direction, ceasing to display the visual element corresponding to the second media-processing style without displaying the representation using the second media-processing style; and
in accordance with a determination that the input is in a fourth direction that is different from the first direction, ceasing to display the visual element corresponding to the sixth media-processing style without displaying the representation using the sixth media-processing style.

10. The computer system of claim 1, wherein the input directed to the representation is not detected at an indication of the second media-processing style.

11. The computer system of claim 1, wherein the representation of the media is a representation of previously captured media.

12. The computer system of claim 11, the one or more programs further including instructions for:
after detecting the input directed to the representation, displaying an option to use a seventh media-processing style for media captured in response to future media capture requests;
while displaying the option to use the seventh media-processing style, detecting an input directed to the option to use the seventh media-processing style;
in response to detecting the input directed to the option to use the seventh media-processing style, configuring the computer system to use the seventh media-processing style; and
while the computer system is configured to use the seventh media-processing style, detecting a request to capture media;
in response to detecting the request to capture media while the computer system is configured to use the seventh media-processing style, capturing respective media; and
after capturing the respective media, displaying a first user interface that includes a representation of the respective media, wherein the representation of the respective media is displayed in the first user interface using the seventh media-processing style.

13. The computer system of claim 1, wherein:
the computer system is in communication with one or more cameras that includes a first camera; and
the representation of the media includes a representation of at least a portion of a current field-of-view of at least the first camera.

14. The computer system of claim 13, the one or more programs further including instructions for:
after detecting the input directed to the representation, displaying an option to use an eighth media-processing style for media captured in response to future media capture requests;
while displaying the option to use the eighth media-processing style, detecting an input directed to the option to use the eighth media-processing style;
in response to detecting the input directed to the option to use the eighth media-processing style, configuring the computer system to use the eighth media-processing style;
while the computer system is configured to use the eighth media-processing style, detecting a second request to capture media;
in response to detecting the second request to capture media while the computer system is configured to use the eighth media-processing style, capturing second respective media; and
after capturing the second respective media, displaying a second user interface that includes a representation of the second respective media, wherein the representation of the second respective media is displayed in the second user interface using the eighth media-processing style.

15. The computer system of claim 1, wherein applying a respective media-processing style to captured media includes applying a first set of operations to the captured media and applying the respective media-processing style to a live preview of a portion of a field-of-view of one or more cameras includes applying a second set of operations to the live preview.

16. The computer system of claim 1, wherein, while the first portion of the representation and the second portion of the representation are displayed using the first media-processing style, an identifier that corresponds to the first media-processing style is displayed.

17. The computer system of claim 1, wherein displaying the first portion of the representation using the second media-processing style while continuing to display the second portion of the representation using the first media-processing style includes displaying a divider between the first portion of the representation and the second portion of the representation.

18. The computer system of claim 1, wherein the input directed to the representation is a movement input.

19. The computer system of claim 1, wherein the computer system is in a first capture mode, the one or more programs further including instructions for:
while displaying the style-selection user interface and while the computer system is in the first capture mode, detecting an input directed to the style-selection user interface; and
in response to detecting the input directed to the style-selection user interface, transitioning the computer system from being in the first capture mode to being in a different capture mode.

20. The computer system of claim 19, the one or more programs further including instructions for:
after transitioning the computer system from being in the first capture mode to being in the different capture mode, detecting a request to capture media; and
in response to detecting the request to capture media, capturing media with the different capture mode based on a currently selected media-processing style, including:
in accordance with a determination that the currently selected media-processing style is the first media-processing style, capturing the media in the different capture mode with the first media-processing style; and
in accordance with a determination that the currently selected media-processing style is the second media-processing style, capturing the media in the different capture mode with the second media-processing style.

21. The computer system of claim 1, wherein the computer system is in a third capture mode, the one or more programs further including instructions for:
after detecting the input directed to the representation, detecting a request to display a second user interface that includes a second representation of media;
in response to detecting the request to the display the second user interface that includes the second representation of media, displaying the second user interface that includes the second representation of media;
while displaying the second user interface, detecting an input directed to the second representation; and
in response to detecting the input directed to the second representation and in accordance with a determination that the computer system is not in a first media-processing style selection mode, transitioning the computer system from being in the third capture mode to being in a fourth capture mode.

22. The computer system of claim 21, the one or more programs further including instructions for:
in response to detecting the input directed to the second representation and in accordance with a determination that the computer system is in the first media-processing style selection mode, maintaining the computer system in the third capture mode.

23. The computer system of claim 1, the one or more programs further including instructions for:
in response to detecting the input directed to the representation and in accordance with the determination that the input directed to the representation is in the first direction:
in accordance with a determination that the second media-processing style is being applied to a fourth portion of the representation of the media, displaying a plurality of selectable user interface objects for the second media-processing style and ceasing to display the at least one selectable user interface object for modifying the respective parameter of the first media-processing style; and
in accordance with a determination that the second media-processing style is not being applied to the fourth portion of the representation of the media, continuing to display the at least one selectable user interface object for modifying the respective parameter of the first media-processing style without displaying the plurality of selectable user interface objects for the second media-processing style.

24. The computer system of claim 1, wherein the at least one selectable user interface object for modifying the respective parameter of the first media-processing style is displayed at one or more locations on the representation of the media.

25. The computer system of claim 1, the one or more programs further including instructions for:
while the first media-processing style is selected for use, detecting a first request to capture media;
in response to detecting the first request to capture media, capturing media with the first media-processing style applied;
after capturing media with the first media-processing style applied, and while the second media-processing style is selected for use, detecting a second request to capture media; and
in response to detecting the second request to capture media, capturing media with the second media-processing style applied.

26. The computer system of claim 1, the one or more programs further including instructions for:
in response to detecting the input directed to the representation and in accordance with a determination that an end of the input has been detected:
in accordance with a determination that the input directed to the representation satisfies one or more movement criteria, displaying the first portion of the representation and the second portion of the representation using the second media-processing style; and
in accordance with a determination that the input directed to the representation does not satisfy one or more movement criteria, displaying the first portion of the representation and the second portion of the representation using the first media-processing style.

27. The computer system of claim 1, the one or more programs further including instructions for:
after detecting the input directed to the representation, displaying the first portion of the representation and the second portion of the representation using the second media-processing style;
while displaying the representation and the second portion of the representation are displayed using the second media-processing style, detecting a second input directed to the representation; and
in response to detecting the second input directed to the representation, in accordance with a determination that the second input directed to the representation is in the first direction, displaying the first portion of the representation using a ninth media-processing style while continuing to display the second portion of the representation using the second media-processing style.

28. The computer system of claim 27, wherein displaying the first portion of the representation using the ninth media-processing style while continuing to display the second portion of the representation using the second media-processing style includes:
in response to detecting a first portion of the second input directed to the representation, displaying the first portion of the representation using the ninth media-processing style while the second portion of the representation and the third portion of the representation are displayed using the second media-processing style.

29. The computer system of claim 27, the one or more programs further including instructions for:
in response to detecting the second input directed to the representation and in accordance with a determination that an end of the second input has been detected:
in accordance with a determination that the second input directed to the representation satisfies one or more movement criteria, displaying the first portion of the representation and the second portion of the representation using the ninth media-processing style; and
in accordance with a determination that the input directed to the representation does not satisfy one or more movement criteria, displaying the first portion of the representation and the second portion of the representation using the second media-processing style.

30. The computer system of claim 1, the one or more programs further including instructions for:
before displaying the style-selection user interface that includes the representation of the media that is displayed using the first media-processing style, displaying a user interface that includes a user interface object for displaying the style-selection user interface that is displayed at a first respective location in the user interface that includes a fourth representation of the media;
while displaying the user interface object for displaying the style-selection user interface, detecting an input directed to the user interface object for displaying the style-selection user interface; and
in response to detecting the input directed to the user interface object for displaying the style-selection user interface, displaying style-selection user interface.

31. The computer system of claim 1, wherein the style-selection user interface includes a user interface object for controlling a setting at a second respective location in the style-selection user interface, the one or more programs further including instructions for:
while displaying the style-selection user interface and the user interface object for controlling the setting at the second respective location, detecting an input directed to the second respective location in the style-selection user interface; and
in response to detecting the input directed to the second respective location in the style-selection user interface, ceasing to display the style-selection user interface.

32. The computer system of claim 1, the one or more programs further including instructions for, after displaying the style-selection user interface:
receiving a request to displaying a camera user interface; and
in response to receiving the request to display the camera user interface, displaying a camera user interface that includes concurrently displaying, in the camera user interface:
a representation of a field of view of one or more cameras; and
a respective user interface object that, when selected, causes the style-selection user interface to be displayed, including:
in accordance with a determination that the first media-processing style is currently selected as a media-processing style, displaying the respective user interface object with a first appearance; and
in accordance with a determination that the second media-processing style is currently selected as a media-processing style, displaying the respective user interface object with a second appearance that is different from the first appearance.

33. The computer system of claim 1, wherein the user interface includes a first user interface object that is concurrently displayed with the first portion of the representation and the second portion of the representation that is displayed using the first media-processing style, the one or more programs further including instructions for:
while displaying the first user interface object that is concurrently displayed with the first portion of the representation and the second portion of the representation that is displayed using the first media-processing style, detecting, via the one or more input devices, an input directed to the first user interface object; and
in response to detecting the input directed to the first user interface object, displaying the first portion of the representation and the second portion of the representation without using the first media-processing style.

34. The computer system of claim 1, wherein the style-selection user interface includes a selectable user interface object for capturing media, the one or more programs further including instructions for:
while displaying the representation of the media using the first media-processing style and the selectable user interface object for capturing media, detecting an input directed to the selectable user interface object for capturing media; and
in response to detecting the input directed to the selectable user interface object for capturing media, capturing media that has the first media-processing style applied.

35. The computer system of claim 1, wherein displaying the first portion of the representation using the first media-processing style includes applying the first media-processing style differently to one or more objects in the first portion of the representation than to a subset of the first portion that does not include the one or more objects.

36. The computer system of claim 1, wherein the first media-processing style is applied to the representation of the media based one or more parameters selected from the group consisting of contrast, vibrancy, warmth, and a combination thereof.

37. The computer system of claim 1, the one or more programs further including instructions for:
while the first portion of the representation and the third portion of the representation is displayed using the second media-processing style while the second portion of the representation is displayed using the first media-processing style, detecting an end of the input directed to the representation; and
in response to detecting the end of the input directed to the representation, ceasing to display the second portion of the representation using the first media-processing style and decreasing a visual prominence of a subset of the second portion of the representation.

38. The computer system of claim 37, the one or more programs further including instructions for:
while the subset of the second portion of the representation is displayed with the decreased visual prominence, detecting a third input directed to the representation; and
in response to detecting the third input directed to the representation, increasing the visual prominence of the subset of the second portion of the representation.

39. The computer system of claim 1, wherein displaying the representation of the media includes:
in accordance with a determination that the representation of the media would be displayed using a tenth media-processing style in response to detecting a fourth input directed to the representation, a fourth portion of the representation is displayed with a first visual appearance; and
in accordance with a determination that the representation of the media would not be displayed using the tenth media-processing style in response to detecting the fourth input directed to the representation, the fourth portion of the representation is displayed with a second visual appearance that is different from the first visual appearance.

40. The computer system of claim 1, wherein, before detecting the input directed to the representation and while displaying the first portion of the representation and the second portion of the representation using the first media-processing style, a sixth portion of the representation of the media is displayed using the first media-processing style.

41. The computer system of claim 1, wherein, before detecting the input directed to the representation and while displaying the first portion of the representation and the second portion of the representation using the first media-processing style, a seventh portion of the representation of the media is not displayed using the first media-processing style.

42. The computer system of claim 41, the one or more programs further including instructions for:
in response to detecting the input directed to the representation, displaying an animation of the seventh portion of the representation of the media transitioning from not being displayed using the first media-processing style to being displayed using the first media-processing style.

43. The computer system of claim 1, the one or more programs further including instructions for:
before displaying the style-selection user interface, wherein the first portion of the representation and the second portion of the representation are displayed using the first media-processing style that is applied to visual content of the media, displaying a user interface object for enabling a second media-processing style selection mode;
while displaying the user interface object for enabling the second media-processing style selection mode, detecting an input directed to the user interface object for enabling the second media-processing style selection mode; and
in response to detecting the input directed to the user interface object for enabling the second media-processing style selection mode, displaying a respective user interface that includes concurrently displaying a representation of previously captured media that has the first media-processing style applied and a representation of previously captured media that has the second media-processing style applied.

44. A non-transitory computer-readable storage medium storing one or more programs configured to be executed by one or more processors of a computer system that is in communication with a display generation component and one or more input devices, the one or more programs including instructions for:
displaying, via the display generation component, a style-selection user interface that includes a representation of media, wherein a first portion of the representation and a second portion of the representation are displayed using a first media-processing style that is applied to visual content of the media, and wherein before detecting an input directed to the representation, the style-selection user interface includes at least one selectable user interface object for modifying a respective parameter of the first media-processing style;
while the first portion of the representation and the second portion of the representation are displayed using the first media-processing style, detecting, via the one or more input devices, the input directed to the representation; and
in response to detecting the input directed to the representation and in accordance with a determination that the input is in a first direction, displaying, via the display generation component, the first portion of the representation using a second media-processing style while continuing to display the second portion of the representation using the first media-processing style, including:
in response to detecting a first portion of the input directed to the representation, wherein the first portion of the input has a first input magnitude, displaying the first portion of the representation using the second media-processing style while the second portion of the representation and a third portion of the representation that is between the first portion of the representation and the second portion of the representation are displayed using the first media-processing style; and
after displaying the first portion of the representation using the second media-processing style while the second portion of the representation and the third portion of the representation are displayed using the first media-processing style and in response to detecting a second portion of the input directed to the representation, wherein the second portion of the input has a second input magnitude that is greater than the first input magnitude, displaying the first portion of the representation and the third portion of the representation using the second media-processing style while the second portion of the representation is displayed using the first media-processing style.

45. A method, comprising:
at a computer system that is in communication with a display generation component and one or more input devices:
displaying, via the display generation component, a style-selection user interface that includes a representation of media, wherein a first portion of the representation and a second portion of the representation are displayed using a first media-processing style that is applied to visual content of the media, and wherein before detecting an input directed to the representation, the style-selection user interface includes at least one selectable user interface object for modifying a respective parameter of the first media-processing style;
while the first portion of the representation and the second portion of the representation are displayed using the first media-processing style, detecting, via the one or more input devices, the input directed to the representation; and
in response to detecting the input directed to the representation and in accordance with a determination that the input is in a first direction, displaying, via the display generation component, the first portion of the representation using a second media-processing style while continuing to display the second portion of the representation using the first media-processing style, including:
in response to detecting a first portion of the input directed to the representation, wherein the first portion of the input has a first input magnitude, displaying the first portion of the representation using the second media-processing style while the second portion of the representation and a third portion of the representation that is between the first portion of the representation and the second portion of the representation are displayed using the first media-processing style; and
after displaying the first portion of the representation using the second media-processing style while the second portion of the representation and the third portion of the representation are displayed using the first media-processing style and in response to detecting a second portion of the input directed to the representation, wherein the second portion of the input has a second input magnitude that is greater than the first input magnitude, displaying the first portion of the representation and the third portion of the representation using the second media-processing style while the second portion of the representation is displayed using the first media-processing style.
